(19) United States
(12) Patent Application Publication
(10) Pub. No.: US 2026/0261611 A1
(43) Pub. Date: Sep. 3, 2026

(54) FOLDABLE ELECTRONIC DEVICE INCLUDING A PLURALITY OF ELECTRONIC COMPONENTS

(71) Applicant: Samsung Electronics Co., Ltd., Suwon-si (KR)

(72) Inventors: Jinsook AHN, Suwon-si (KR); Cheolyoon CHUNG, Suwon-si (KR); Jongik WON, Suwon-si (KR); Youngjae KIM, Suwon-si (KR)

(21) Appl. No.: 19/394,232

(22) Filed: Nov. 19, 2025

Related U.S. Application Data
(63) Continuation of application No. PCT/KR2025/018306, filed on Nov. 7, 2025.

(30) Foreign Application Priority Data
Feb. 28, 2025 (KR) 10-2025-0026511
Apr. 3, 2025 (KR) 10-2025-0043587

(51) Int. Cl. H04M 1/02

(52) U.S. Cl. CPC H04M 1/0277; H04M 1/0216; H04M 1/0268; H04M 1/0274

(57) ABSTRACT

A foldable electronic device is provided. The foldable electronic device includes a first housing part, a second housing part, a hinge housing part that is disposed at least partially between the first housing part and the second housing part, a hinge assembly, a flexible display, a processor, a first aggregator circuit that converts a first control signal input from the processor through a first number of ports into a second control signal that is output through a second number of ports smaller than the first number of ports, a second aggregator circuit that receives the second control signal through the second number of ports and that converts the second control signal into a third control signal that is output through a third number of ports greater than the second number of ports, and a flexible printed circuit board (FPCB) that is connected to the first aggregator circuit and the second aggregator circuit.

### CROSS-REFERENCE TO RELATED APPLICATION(S)

This application is a continuation application, claiming priority under 35 U.S.C. § 365(c), of an International application No. PCT/KR2025/018306, filed on Nov. 7, 2025, which is based on and claims the benefit of a Korean patent application number 10-2025-0026511, filed on Feb. 28, 2025, in the Korean Intellectual Property Office, and of a Korean patent application number 10-2025-0043587, filed on Apr. 3, 2025, in the Korean Intellectual Property Office, the disclosure of each of which is incorporated by reference herein in its entirety.

### BACKGROUND

### 1. Field

The disclosure relates to a foldable electronic device that includes a plurality of electronic components.

### 2. Description of Related Art

A portable electronic device, such as a smartphone, may support call functions and content search functions based on various types of applications. The portable electronic device may output a screen corresponding to each function in a process of providing various functions. When the user uses the above-described various functions, the user may want to use a wider screen. In a general portable electronic device, when it is intended to expand a display device for displaying a wide screen, an overall size thereof increases, so that portability may deteriorate. Accordingly, a foldable electronic device has been provided so that the size of the screen may be increased while maintaining portability. Such a foldable electronic device includes a plurality of housings, and the plurality of housings may have a folded state and an unfolded state. Various electronic components may be disposed in each of the plurality of housings of the foldable electronic device. Electronic components disposed in the plurality of housings may be connected to each other through electric lines.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to provide at least the advantages described below. Accordingly, an aspect of the disclosure is to provide a foldable electronic device that includes a plurality of electronic components.

Additional aspects will be set forth in part in the description which follows and, in part, will be apparent from the description, or may be learned by practice of the presented embodiments.

In accordance with an aspect of the disclosure, a foldable electronic device is provided. The foldable electronic device includes a housing including a first housing part, a second housing part, and a hinge housing part disposed at least partially between the first housing part and the second housing part, a hinge assembly accommodated at least partially in the hinge housing part and rotatably connecting the first housing part and the second housing part, a flexible display accommodated in the first housing part and the second housing part and configured to be folded or unfolded in response to folding or unfolding of the housing, a processor accommodated in the first housing part, a first aggregator circuit accommodated in the first housing part and configured to convert a first control signal input from the processor through a first number of ports into a second control signal output through a second number of ports smaller than the first number of ports, a second aggregator circuit accommodated in the second housing part and configured to receive the second control signal through the second number of ports and convert the second control signal into a third control signal output through a third number of ports greater than the second number of ports, and a flexible printed circuit board (FPCB) connected to the first aggregator circuit and the second aggregator circuit, wherein a portion of the FPCB is coupled at least partially to the hinge assembly or accommodated at least partially in the hinge housing part and configured to transmit the second control signal.

In accordance with another aspect of the disclosure, a foldable electronic device is provided. The foldable electronic device includes a housing including a first housing part, a second housing part, a third housing part, a first hinge housing part disposed at least partially between the first housing part and the second housing part, and a second hinge housing part disposed at least partially between the second housing part and the third housing part, a first hinge assembly accommodated at least partially in the first hinge housing part and rotatably connecting the first housing part and the second housing part, a second hinge assembly accommodated at least partially in the second hinge housing part and rotatably connecting the second housing part and the third housing part, a flexible display accommodated in the first housing part, the second housing part, and the third housing part and configured to be folded or unfolded in response to folding or unfolding of the housing, a processor accommodated in the first housing part, a first aggregator circuit accommodated in the first housing part and configured to convert a first control signal input from the processor through a first number of ports into a second control signal output through a second number of ports smaller than the first number of ports, a second aggregator circuit accommodated in the third housing part and configured to receive the second control signal through a third number of ports and convert the second control signal into a third control signal output through a fourth number of ports greater than the third number of ports, and a connection structure connected to the first aggregator circuit and the second aggregator circuit, wherein the connection structure includes a first flexible printed circuit board (FPCB) part coupled at least partially to the first hinge assembly or accommodated at least partially in the first hinge housing part, and a second FPCB part coupled at least partially to the second hinge assembly or accommodated at least partially in the second hinge housing part and configured to transmit the second control signal.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a front perspective view of an electronic device according to an embodiment of the disclosure;

FIG. 2 is a plan view illustrating a rear surface of an electronic device according to an embodiment of the disclosure;

FIG. 3 is a partial exploded perspective view of an electronic device of FIGS. 1 and 2 including a hinge according to an embodiment of the disclosure;

FIG. 4 is a view illustrating an example of a disposition form of internal components of a foldable electronic device according to an embodiment of the disclosure;

FIG. 5 is a view illustrating an example of a structure including a processor, aggregator circuits, a flexible board, and a plurality of electronic components, among components of a foldable electronic device according to an embodiment of the disclosure;

FIG. 6 is a view illustrating another example of a structure including a processor, aggregator circuits, a flexible board, and a plurality of electronic components, among components of a foldable electronic device according to an embodiment of the disclosure;

FIG. 7 is a view illustrating another example of a disposition form of internal components of a foldable electronic device according to an embodiment of the disclosure;

FIG. 8 is a view illustrating a first example of a disposition form of internal components of a foldable electronic device according to an embodiment of the disclosure;

FIG. 9 is a view illustrating at least a portion of a cross section taken along cutting line A0-A0′ of FIG. 8 according to an embodiment of the disclosure;

FIG. 10 is a view illustrating a second example of a disposition form of internal components of a foldable electronic device according to an embodiment of the disclosure;

FIG. 11 is a view illustrating a third example of a disposition form of internal components of a foldable electronic device according to an embodiment of the disclosure;

FIG. 12 is a view illustrating a fourth example of a disposition form of internal components of a foldable electronic device according to an embodiment of the disclosure;

FIG. 13 is a view illustrating a fifth example of a disposition form of internal components of a foldable electronic device according to an embodiment of the disclosure;

FIG. 14 is a view illustrating at least a portion of a cross section taken along cutting line A1-A1′ of FIG. 13 according to an embodiment of the disclosure;

FIG. 15 is a view illustrating a sixth example of a disposition form of internal components of a foldable electronic device according to an embodiment of the disclosure;

FIG. 16 is a view illustrating a seventh example of a disposition form of internal components of a foldable electronic device according to an embodiment of the disclosure;

FIG. 17 is a view illustrating an example of a bus connection between electronic components of a foldable electronic device according to an embodiment of the disclosure;

FIG. 18 is a view illustrating an eighth example of a disposition form of internal components of a foldable electronic device according to an embodiment of the disclosure;

FIG. 19 is a view illustrating an example of a connection relationship of a processor, an aggregator circuit part, and aggregator circuits of a foldable electronic device according to an embodiment of the disclosure;

FIG. 20 is a view illustrating an example of a printed circuit board of an interposer structure, to which aggregator circuits are applied, according to an embodiment of the disclosure;

FIG. 21 is a view illustrating an example of a rollable electronic device structure, to which aggregator circuits are applied, according to an embodiment of the disclosure;

FIG. 22 is a view illustrating an example of a structure, which is improved according to application of an aggregator circuit, according to an embodiment of the disclosure; and

FIG. 23 illustrates a block diagram of an electronic device 2300 capable of performing the operations described herein according to an embodiment of the disclosure.

The same reference numerals are used to represent the same elements throughout the drawings.

### DETAILED DESCRIPTION

The following description with reference to accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Hereinafter, various embodiments of the disclosure may provide a structure, which may reduce the number of lines that electrically connect electronic components disposed in a plurality of housings and may be efficiently operated. As an example, according to an embodiment of the disclosure, by reducing (decreasing) the number of lines for transmitting and receiving signals between a first electronic component that is disposed in a first housing and a plurality of electronic components that are disposed in a second housing, a line structure disposed between the first electronic component and the plurality of electronic components may be simplified more. Based on this, according to an embodiment of the disclosure, a more physically robust feature for stress generated during a folding or unfolding operation process of a foldable electronic device may be maintained, and efficient transmission of signals between electronic components may be supported as well. Furthermore, through an embodiment of the disclosure, a reduction in material cost may be achieved in manufacturing of a foldable electronic device or in manufacturing of a flexible board.

The objects according to various embodiments of the disclosure will be described as necessary in a process of describing the embodiments. For example, various objects and effects through a foldable electronic device including a plurality of electronic components according to various embodiments may be mentioned according to embodiments of the detailed description.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

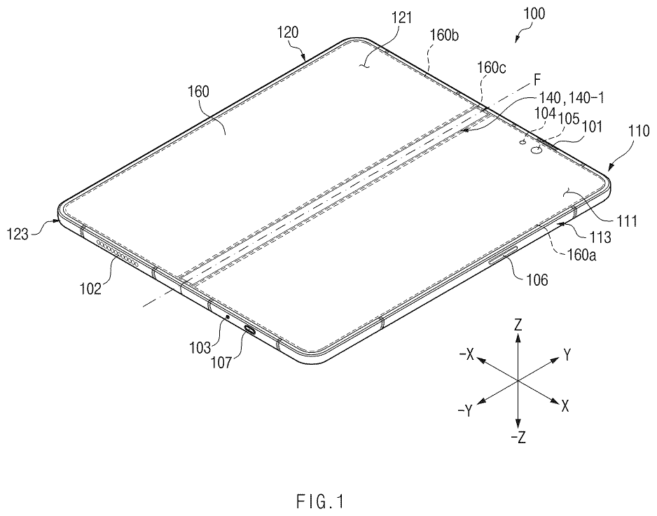

FIG. 1 is a front perspective view of an electronic device according to an embodiment of the disclosure.

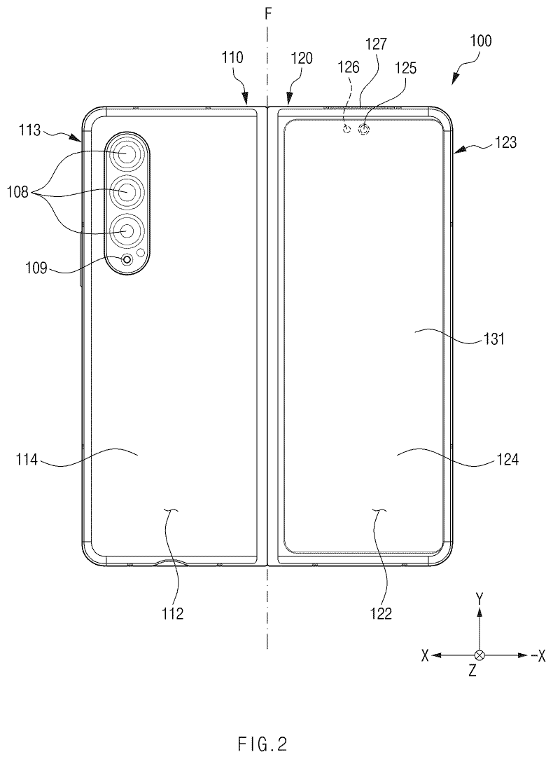

FIG. 2 is a plan view illustrating a rear surface of an electronic device according to an embodiment of the disclosure.

Referring to FIGS. 1 and 2, an electronic device 100 (or a foldable electronic device (or a foldable electronic device, a portable electronic device, a portable communication device, a foldable electronic device, or a foldable electronic device having a communication function) may include a first housing 110 (e.g., a first housing structure) including a first side member 113 (e.g., a side bezel), and a second housing 120 (e.g., a second housing structure) including a second side member 123 (e.g., a side bezel), which are coupled to be foldable with respect to each other by means of at least one hinge device 140 and/or 140-1 (e.g., a hinge module or a hinge structure), with respect to a folding axis F. For example, the first housing 110 and the second housing 120 may be configured as a foldable housing (e.g., a housing structure). For example, the electronic device 100 may include a first display 130 (e.g., a flexible display, a foldable display, or a main display) arranged to be supported by the first housing 110 and the second housing 120. For example, the first housing 110 may include a first surface 111 and a second surface 112 facing away from the first surface 111 (e.g., in the −z axis direction). For example, the second housing 120 may include a third surface 121 and a fourth surface 122 facing away from the third surface 121 (e.g., in the −z-axis direction). For example, the first housing 110 may include a first rear cover 114 coupled to the first side member 113. For example, the second housing 120 may include a second rear cover 124 coupled to a second side member 123. For example, when the electronic device 100 is in a fully unfolded first state (e.g., an unfolded state or an unfolding state), the electronic device 100 may operate such that the first surface 111 and the third surface 121 face substantially the same direction (e.g., the z-axis direction). For example, when the electronic device 100 is in a fully folded second state (e.g., a folded state or a folding state), the electronic device 100 may operate such that the first surface 111 and the third surface 121 face each other or face the opposite directions. For example, the electronic device 100 may be operated to maintain a third state (e.g., an intermediate state) between the first state and the second state.

According to an embodiment, the electronic device 100 may include a first receiver 101 disposed through the first surface 111 of the first housing 110, at least one first sensor module 104 (e.g., an illuminance sensor), and/or at least one first camera module 105 (e.g., an under display camera (UDC)). For example, the electronic device 100 may include at least one key 106 disposed on the first side member 113. For example, the electronic device 100 may include at least one second camera module 108 and/or a flash 109 disposed through the second surface 112 (e.g., the first rear cover 114) of the first housing 110. For example, the electronic device 100 may include a second display 131 disposed on the fourth surface 122 of the second housing 120, at least one third camera module 125 (e.g., an under display camera (UDC)), at least one second sensor module 126, and/or a second receiver 127. For example, the second display 131 may be disposed to be visible from the outside through at least a portion of the second rear cover 124. For example, the electronic device 100 may include a speaker 102 disposed through the second side member 123, a microphone 103 disposed through the first side member 113, and/or a connector port 107. At least some of the above-described components may be disposed in the first housing 110 and/or the second housing 120.

According to an embodiment, the first display 130 (e.g., a flexible display) may include a first area 130a (e.g., a first flat portion) corresponding to at least a portion of the first surface 111, a second area 130b (e.g., a second flat portion) corresponding to at least a portion of the third surface 121, and a third area 130c (e.g., a flexible portion) that connects the first area 130a and the second area 130b, in which the electronic device 100 is deformed from the second state (e.g., a folding state) and/or the third state. For example, the third area 130c may be disposed at a position at least partially overlapping the at least one hinge device 140 or 140-1, when the first display 130 is viewed from above (e.g., in the z-axis direction). For example, in the second state, the first display 130 may be disposed such that the first surface 111 and the third surface 121 face each other and are not visible from the outside (e.g., an in-folding type). For example, in the second state, the first display 130 may be disposed such that the first surface 111 and the third surface 121 face the directions opposite to each other, thereby being visible from the outside (e.g., an out-folding type).

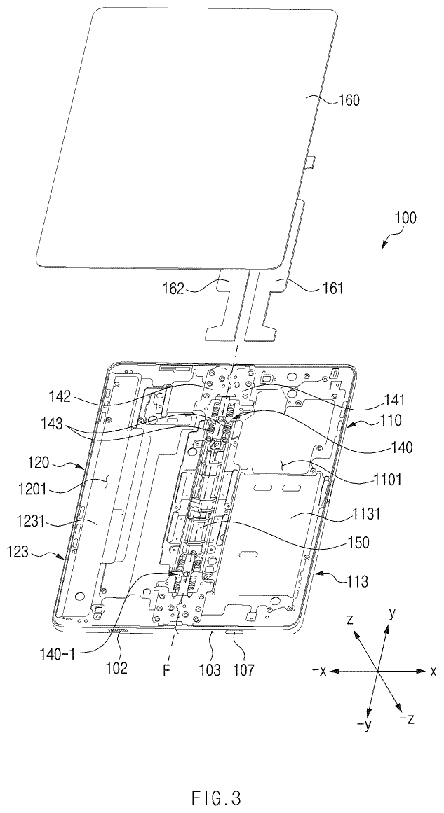

FIG. 3 is a partial exploded perspective view of an electronic device of FIGS. 1 and 2 including a hinge device according to an embodiment of the disclosure.

Referring to FIG. 3, the electronic device 100 may include at least one hinge device 140 and 140-1 (e.g., a hinge module or a hinge structure) connecting the first housing 110 and the second housing 120 underneath the first display 130 (e.g., in the −z axis direction). For example, the at least one hinge device 140 and 140-1 may include a first hinge device 140 and a second hinge device 140-1 spaced apart from the first hinge device 140 along a direction (e.g., ±y-axis direction) parallel to the folding axis F. For example, the at least one hinge device 140 and/or 140-1 may be supported by a first support member 1131 extending from the first side member 113 to a first space 1101 of the first housing 110 and a second support member 1231 extending from the second side member 123 to a second space 1201 of the second housing 120. For example, the at least one hinge device 140 and/or 140-1 may be disposed between the first housing 110 and the second housing 120 so as not to be visible from the outside through the hinge housing 150 (e.g., a hinge cover).

According to an embodiment, the first hinge device 140 may include a first rotation member 141 (e.g., a first arm or a first rotator) disposed on the first support member 1131 of the first housing 110, a second rotation member 142 (e.g., a second arm or a second rotator) disposed on the second support member 1231 of the second housing 120, and a gear assembly 143 connecting the first rotation member 141 and the second rotation member 142 and coupling the first housing 110 and the second housing 120 to rotate symmetrically with respect to each other. For example, the gear assembly 143 may include a plurality of gears (e.g., spur gears and/or worm gears) meshed with respect to each other. For example, the gear assembly 143 may include a cam coupling structure configured to pressurize the first housing 110 and the second housing 120 in a direction to be shifted from the first state (e.g., an unfolded state or an unfolding state) to the second state (e.g., a folded state or a folding state) or a direction to be shifted from the second state to the first state, relative to a certain angle to each other, and to provide a sense of stopping at various folding angles. For example, the second hinge device 140-1 may have substantially the same configuration as the first hinge device 140.

According to an embodiment, the electronic device 100 may include a first hinge plate 161 connected to a first support member 1131 and/or a first rotation member 141. The electronic device 100 may include a second hinge plate 162 connected to a second support member 1231 and/or a second rotation member 142. For example, the at least one hinge device 140 and/or 140-1, the first rotation member 141, the second rotation member 142, the first hinge plate 161, and the second hinge plate 162 may form substantially the same plane as the first support member 1131 and the second support member 1231, when the electronic device 100 is in the first state. For example, the second hinge device 140-1 may be substantially symmetrical to the first hinge device 140 or may have substantially the same configuration.

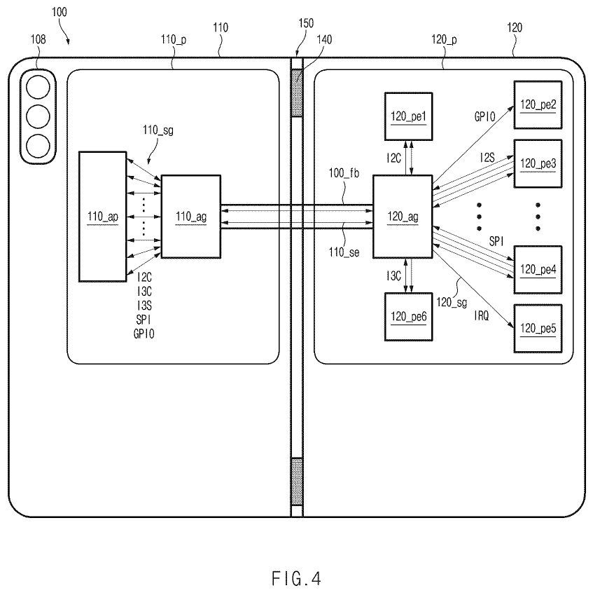

FIG. 4 is a view illustrating an example of a disposition form of internal components of a foldable electronic device according to an embodiment of the disclosure.

In the foldable electronic device 100 illustrated in FIG. 4, to illustrate a connection relationship between a plurality of electronic components (or components, elements, or electric elements) according to an embodiment of the disclosure, other components of the foldable electronic device 100 are omitted or schematically represented, but the foldable electronic device 100 of the disclosure is not limited thereto. For example, the foldable electronic device 100 illustrated in FIG. 4 may include at least some of the components of the foldable electronic device 100 described in FIGS. 1 to 3 above. Accordingly, only some components of the foldable electronic device described in FIG. 4 and other drawings are illustrated and described, the disclosure is not limited thereto, and structures for various structures and functions that may be included in the foldable electronic device 100 may be further disposed.

Referring to FIGS. 1 to 4, a foldable electronic device 100 according to an embodiment may include a first housing 110 (or a first housing part), in which the second camera module 108 is disposed, the second housing 120 (or a second housing part), the hinge housing 150 (or a hinge housing part), the first hinge device 140 (or a hinge assembly), the first printed circuit board (PCB) 110_p, the second printed circuit board 120_p, and a flexible board 100_fb (or a circuit board, a flexible printed circuit board, or an FPCB). At least a portion of the hinge housing 150 may be disposed between the first housing 110 and the second housing 120. At least a portion of the first hinge device 140 may be accommodated in the hinge housing 150, and the first housing 110 and the second housing 120 may be rotatably connected to each other. Additionally or alternatively, the foldable electronic device 100 may include a flexible display (e.g., the first display 160 of FIG. 3 or a flexible display) as illustrated in FIGS. 1 to 3 above. The flexible display may be accommodated in the first housing 110 and the second housing 120, and may be configured to be folded or unfolded in response to folding or unfolding (an unfolding state or a flat state) of the housings (e.g., the first housing 110 and the second housing 120). The flexible display may include a first display area 160a accommodated in the first housing 110, a second display area 160b accommodated in the second housing 120, and a third display area 160c disposed between the first display area 160a and the second display area 160b.

The first housing 110 may include the same or similar configuration as that of the first housing 110 described in FIGS. 1 to 3 above. For example, at least a portion of the first housing 110 may be formed of a metal material. Alternatively, at least a portion of the first housing 110 may be formed of a non-metal material (or an injection-molded material). The first housing 110 may include, for example, an inner bottom having a rectangular shape (or a polygonal shape or a polygonal shape, at least a portion of which includes a curved surface), and sides that are formed at a periphery of the bottom and are formed higher than the bottom. The inner bottom may include a front surface, on which a portion of a first display (e.g., the first display 160 of FIG. 1) is disposed, and a rear surface, on which the first printed circuit board (PCB) 110_p is disposed. As an example, the foldable electronic device 100 may further include a structure (e.g., a boss, an adhesive member, or an adhesive) for fixing the first printed circuit board (PCB) 110_p to a bottom (e.g., a rear surface bottom) of the first housing 110. A second camera module (e.g., the second camera module 108 of FIG. 2) may be disposed on one side of the first housing 110, but the foldable electronic device 100 of the disclosure is not limited thereto. For example, the second camera module 108 may also be disposed in the second housing 120. A battery may also be disposed in the first housing 110.

According to an embodiment, the processor 110_ap (or a processing circuit, a chip, on which the processing circuit is disposed, or at least one processor), the first aggregator circuit 110_ag (or a first aggregator, a first aggregator circuit chip, a first circuit, or a first signal adjusting circuit), and a first signal line 110_sg may be disposed on the first printed circuit board 110_p. Meanwhile, in an embodiment of the disclosure, only the processor 110_ap, the first aggregator circuit 110_ag, and the first signal line 110_sg disposed on the first printed circuit board 110_p are illustrated, but the disclosure is not limited thereto, and various other electronic components may be further disposed.

The processor 110_ap may, for example, perform at least one of processing, transferring, transmitting, receiving, and deleting various signals related to execution of various user functions or a system operation of the foldable electronic device 100. Such the processor 110_ap may, for example, include at least one of an application processor, a communication processor, and an artificial intelligence (AI) processor. As an example, the processor 110_ap may include a processor that includes a communication interface capable of transmitting and receiving input/output (IO) signals (or control signals) with the first aggregator circuit 110_ag. Alternatively, the processor 110_ap may include a processor that includes a communication interface capable of transmitting and receiving signals (I/O signals or control signals) with the first aggregator circuit 110_ag at a first designated speed (e.g., MHz) or less. For example, at least a portion of the processor 110_ap may be configured to transmit and receive designated signals (e.g., IO signals or control signals) with the first aggregator circuit 110_ag based on at least one communication method, among an inter-integrated circuit (I2C) corresponding to a bidirectional two-wire serial bus that provides a communication link between integrated chips (ICs), an improved inter-integrated circuit (I3C) that is compatible with I2C and performs two-wire communication, an integrated inter-chip sound (I2S) (or an inter-IC sound), a serial peripheral interface (SPI), an interrupt request (IRQ), a general-purpose input/output (GPIO), a single wire interface (SWI), and a 1-wire. Additionally or alternatively, the processor 110_ap and the first aggregator circuit 110_ag may include a communication interface capable of transmitting and receiving signals at a second designated speed (e.g., more than MHz and GHz or less) in response to at least one of an increase of a tolerance of a size of an aggregator circuit, an increase in a power consumption tolerance of the aggregator circuit, and an increase in a bandwidth of a serial interface of the aggregator circuit.

Additionally or alternatively, the processor 110_ap may generate control signals related to driving at least some of a plurality of electronic components 120_pe1, 120_pe2, 120_pe3, 120_pe4, 120_pe5, and 120_pe6 that are disposed on the second printed circuit board 120_p, and transmit them to at least some of the plurality of electronic components 120_pe1, 120_pe2, 120_pe3, 120_pe4, 120_pe5, and 120_pe6, or may receive signals from the plurality of electronic components 120_pe1, 120_pe2, 120_pe3, 120_pe4, 120_pe5, and 120_pe6. According to an embodiment, the processor 110_ap may include a housing (e.g., an epoxy structure) that is disposed on the first printed circuit board 110_p.

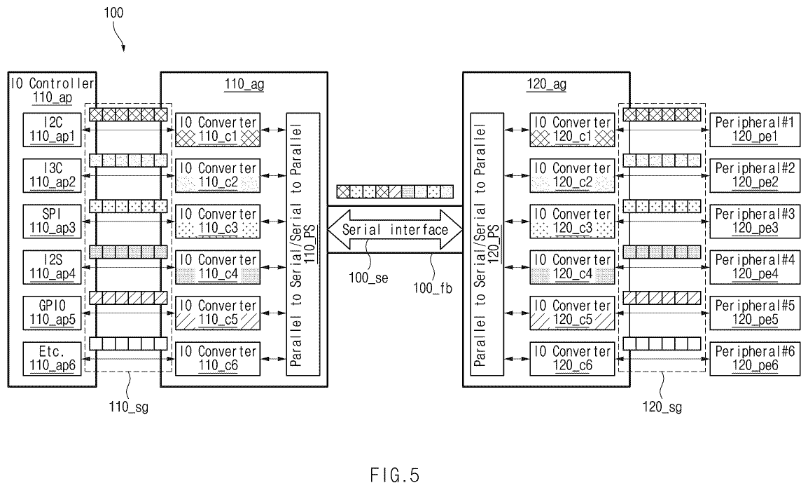

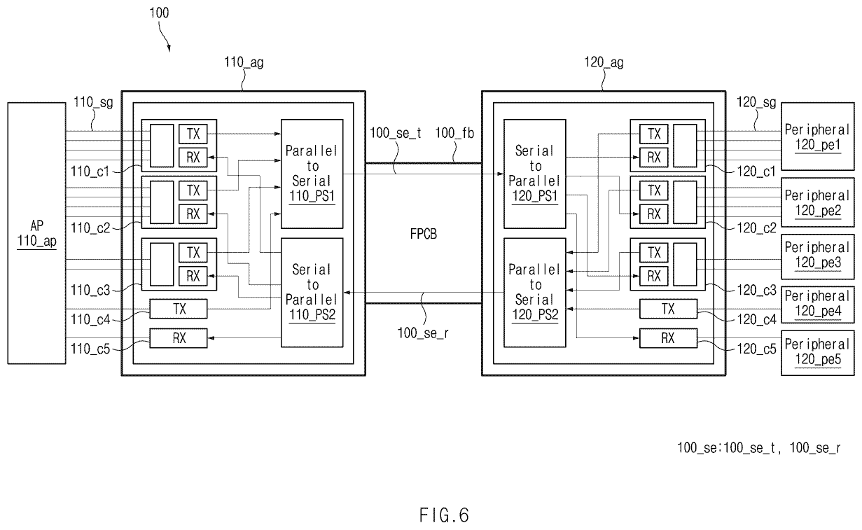

According to an embodiment, the processor 110_ap may be configured, in a state in which the housings 110 and 120 are fully folded, to disable, at least temporarily, a portion of the second aggregator circuit 120_ag (or a second aggregator, a second aggregator circuit chip, a second circuit, or a second signal adjusting circuit), which is connected to a touch control module that processes a touch input to the foldable display (e.g., the first display 160). For example, in a condition, in which a touch function of the foldable display (or the first display 160 of FIG. 3) is disabled (e.g., when the housings 110 and 120 are in a fully folded state), the processor 110_ap may control input/output converters related to the touch function, among internal blocks (e.g., the second aggregator circuit 120_ag) that process input/output (I/O) related to the touch, to be disabled. In this regard, the second aggregator circuit 120_ag (or a third aggregator circuit 130_ag described below) may support automatic mode and manual mode setting options. According to an embodiment, in an automatic mode, internal blocks (e.g., at least some of internal converters or conversion circuits and transmission/reception circuits of the aggregator circuit described in FIGS. 5 and 6) of the second aggregator circuit 120_ag may be automatically enabled by an internal scheduler. As an example, an I2C block included in the second aggregator circuit 120_ag may be automatically enabled when I2C data is input, and may be automatically disabled when no I2C data is input (or when the I2C data is not received for a set time). According to an embodiment, in a manual mode, at least some of internal blocks (e.g., at least some of internal converters or conversion circuits and transmission/reception circuits of the aggregator circuit described in FIGS. 5 and 6) of the second aggregator circuit 120_ag may be enabled or disabled in response to control of the processor 110_ap. In this regard, the processor 110_ap may control an automatic setting or a manual setting of an aggregator circuit (e.g., the second aggregator circuit 120_ag), and, in the manual setting, may transmit a signal for waking up a block required for signal transmission or a signal for disabling a block, among internal blocks included in the aggregator circuit, to the aggregator circuit.

The first aggregator circuit 110_ag may be accommodated in the first housing 110 (or accommodated in the first housing 110 in a state of being disposed on the first printed circuit board 110_p). The first aggregator circuit 110_ag may include N first ports (e.g., physical ports or terminals for transmitting or receiving signals to or from a circuit) and M second ports (e.g., physical ports or terminals for transmitting or receiving signals to or from a circuit), where M is a natural number that is smaller than N. For example, the first ports may include ports, to which lines that are disposed between the first aggregator circuit 110_ag and the processor 110_ap are connected. The second ports may include ports, to which lines that are disposed between the first aggregator circuit 110_ag and the flexible board 100_fb (or a connector on the first printed circuit board 110_p, to which a connector of the flexible board 100_fb is connected) are connected. According to an embodiment, the first aggregator circuit 110_ag may be configured to convert a first control signal, which is input from the processor 110_ap through a first number of ports, into a second control signal that may be output through a second number of ports that is smaller than the first number.

According to an embodiment, the first aggregator circuit 110_ag may be configured to transmit and receive multi-IO signals (or control signals) to and from the processor 110_ap. In this regard, the first aggregator circuit 110_ag may include input ports that may be connected to at least one communication port of the processor 110_ap, among I2C, I3C, I2S, SPI, IRQ, or GPIO. The first aggregator circuit 110_ag, when receiving multi-IO signals from ports that transmit the multi-IO input/output signals, may perform serialization on at least some of the received multi-IO signals and transmit the serialized signals to the second aggregator circuit 120_ag disposed on the second printed circuit board 120_p through a number of lines that is smaller than the number of the multi-IO signals. In this regard, the first aggregator circuit 110_ag may include a buffer that may store N signals transmitted from the processor 110_ap, converters (or a microcontroller) that may convert the received signals, a parallel-to-serial converter that may serialize the N signals into M signals (M is a natural number, M<N), and a serial-to-parallel converter that may parallelize the received signals. As an example, the first aggregator circuit 110_ag may be configured to convert at least some of a plurality of control signals or multi-IO signals of the processor 110_ap into two serial signals and transmit them to the second aggregator circuit 120_ag, and may convert serial signals received from the second aggregator circuit 120_ag into multi-IO signals and transmit them to the processor 110_ap. The first aggregator circuit 110_ag may be disposed at one point of the first printed circuit board 110_p.

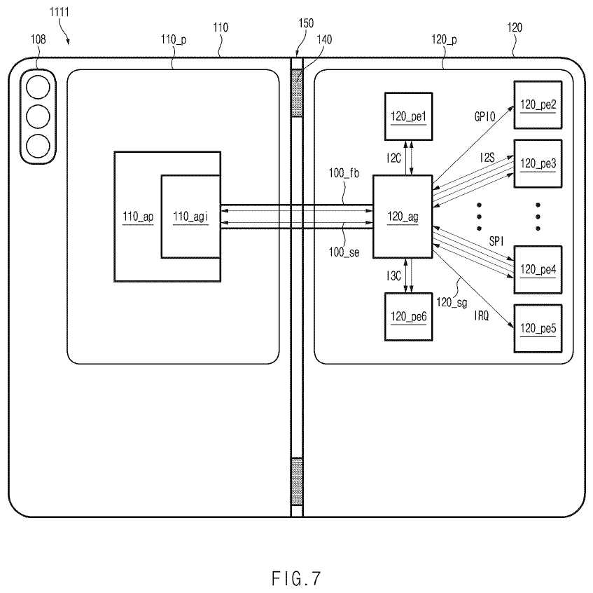

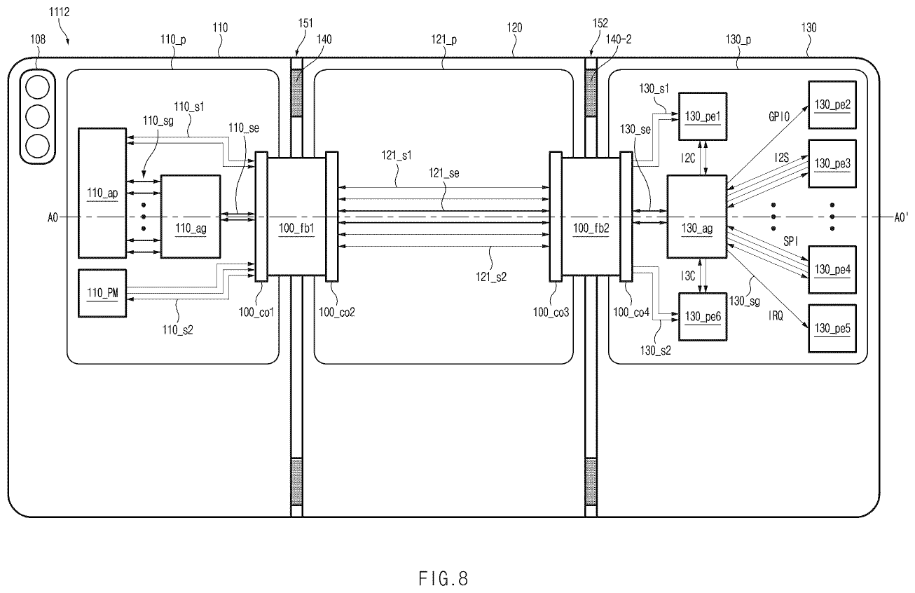

According to an embodiment, the first aggregator circuit 110_ag may include a serial interface that may transmit a smaller number of signals than multi-IO signals input from the processor 110_ap to the second aggregator circuit 120_ag. The serial interface of the first aggregator circuit 110_ag may be one IO according to a bandwidth (BW) selected through design or setting, or may be designed to output two to three IO signals (differential interface 1 lane or 2 lanes, I3C+I3C, SPI+I3C, . . . ). As an example, in the embodiment described in FIG. 4 or FIG. 8 below, the first aggregator circuit 110_ag may be configured to output a total of eight signals, which include transmission (TX) and reception (RX), each including differential data and a clock (CLK). As an example, in the embodiment described in FIG. 7 below, the first aggregator circuit 110_ag (e.g., a processor-embedded aggregator circuit) may be configured to output a total of four signals of I3C SDR (single data rate) (DATA, CLK)+I3C HDR (DATA, CLK), or may be configured to output a total of six signals of SPI (DI, DO, BCLK, LRCLK)+I3C HDR (high dynamic range) (DATA, CLK). The second aggregator circuit 120_ag or the third aggregator circuit 130_ag (or a third aggregator, a third aggregator circuit chip, a third circuit, or a third signal adjustment circuit) may include an input part including signal lines that receive at least some of signals that are output through a serial interface of the first aggregator circuit 110_ag.

The second housing 120 may include the same or similar configuration as that of the second housing 120 described in FIGS. 1 to 3 above. For example, at least a portion of the second housing 120 may be formed of a metal material. Alternatively, at least a portion of the second housing 120 may be formed of a non-metal material (or an injection-molded material). The second housing 120 may include, for example, an inner bottom having a rectangular shape (or a polygonal shape or a polygonal shape, at least a portion of which includes a curved surface), and sides that are formed at a periphery of the bottom and are formed higher than the bottom. The inner bottom may include a front surface, on which another portion of a first display (e.g., the first display 160 of FIG. 1) is disposed, and a rear surface, on which the second printed circuit board (PCB) 120_p is disposed. As an example, the foldable electronic device 100 may further include a structure (e.g., a boss, an adhesive member, or an adhesive) for fixing the second printed circuit board (PCB) 120_p to a bottom (e.g., a rear surface bottom) of the second housing 120. A battery may also be disposed in the second housing 120. The second housing 120 may be formed in the same or a similar manner as the first housing 110, may be connected to the first housing 110 through the first hinge device 140, and may be disposed while forming a specific angle with the first housing 110 in response to a folding or unfolding operation.

The second aggregator circuit 120_ag may be accommodated in the second housing 120 (or accommodated in the second housing 120 in a state of being disposed on the second printed circuit board 120_p). The second aggregator circuit 120_ag may include K third ports and L fourth ports (L is a natural number that is greater than K). For example, the third ports may include ports, to which lines that are disposed between the first aggregator circuit 110_ag and the second aggregator circuit 120_ag (or a connector on the second printed circuit board 120_p, to which a connector of the flexible board 100_fb is connected) are connected. The fourth ports of the second aggregator circuit 120_ag may be connected to at least some of a plurality of electronic components 120_pe1, 120_pe2, 120_pe3, 120_pe4, 120_pe5, and 120_pe6 that are disposed on the second printed circuit board 120_p. The K third ports may include the same number as the M second ports of the first aggregator circuit 110_ag. Alternatively, the number of the K third ports may be different from the number of the M second ports of the first aggregator circuit 110_ag. The L fourth ports may include the same number as the N first ports of the first aggregator circuit 110_ag. Alternatively, the number of the L fourth ports may be different from the number of the N first ports of the first aggregator circuit 110_ag.

According to an embodiment, the processor 110_ap may transmit a first number of first control signals to the first aggregator circuit 110_ag, and the first aggregator circuit 110_ag may convert the first number of first control signals (e.g., N or L) into a second number of second control signals (e.g., M or K) and transmit them to the second aggregator circuit 120_ag. As an example, the first aggregator circuit 110_ag may include first ports (e.g., N ports) for receiving a first number of first control signals, and second ports (e.g., M ports) for transmitting a second number of second control signals to the second aggregator circuit 120_ag.

The second aggregator circuit 120_ag may be configured to receive second control signals through the second number of ports (e.g., K or M), and convert the second control signals into third control signals that may be output through a third number of ports (e.g., L or N) that is greater than the second number. As an example, the second aggregator circuit 120_ag may include third ports (e.g., K ports) for receiving a second number of second control signals, and fourth ports (e.g., L ports) for outputting a third number of third control signals.

According to an embodiment, the first control signal may include a first control signal part corresponding to a first serial communication having a first speed and a second control signal part corresponding to a second serial communication having a second speed different from the first speed, The third control signal may include a third control signal part corresponding to the first serial communication and a fourth control signal part corresponding to the second serial communication. The first aggregator circuit 110_ag or the second aggregator circuit 120_ag may be configured to transmit the second control signals through the flexible board 100_fb at a third speed that is faster than the first speed and the second speed.

According to an embodiment, a plurality of electronic components 120_pe1, 120_pe2, 120_pe3, 120_pe4, 120_pe5, and 120_pe6 may be disposed on the second printed circuit board 120_p. Alternatively, at least some of a plurality of electronic components 120_pe1, 120_pe2, 120_pe3, 120_pe4, 120_pe5, and 120_pe6 may be disposed on the second printed circuit board 120_p. Alternatively, at least some of a plurality of electronic components 120_pe1, 120_pe2, 120_pe3, 120_pe4, 120_pe5, and 120_pe6 may be accommodated in the second housing 120. The plurality of electronic components 120_pe1, 120_pe2, 120_pe3, 120_pe4, 120_pe5, and 120_pe6 may be configured to be electrically connected to the second aggregator circuit 120_ag to receive third control signals transmitted by the second aggregator circuit 120_ag. At least one of the plurality of electronic components may be connected to the processor 110_ap through a second flexible board that is different from the flexible board 100_fb. The different second flexible board may be configured to be at least partially coupled to the first hinge device 140 or at least partially accommodated in the hinge housing 150 to transmit a payload related to at least one electronic component (e.g., the plurality of electronic components 120_pe1, 120_pe2, 120_pe3, 120_pe4, 120_pe5, and 120_pe6) transmitted by the processor 110_ap to at least one electronic component. According to an embodiment, the processor 110_ap may transmit control signals through the flexible board 100_fb, and may transmit a payload through the different second flexible board. For example, among driving-related signals of the flexible display (e.g., the first display 160 of FIG. 3), an SPI control signal may be aggregated and transmitted through the flexible board 100_fb, and, among the driving-related signals of the flexible display, mobile industry processor interface (MIPI) signals and power signals may be transmitted through the different second flexible board. Alternatively, one flexible board may include a line part, to which, among display driving-related signals, an SPI control signal is aggregated and transmitted, and a line part, to which MIPI signals and power signals are transmitted.

According to an embodiment, at least one of the first aggregator circuit 110_ag and the second aggregator circuit 120_ag (or a second aggregator or a second aggregator circuit chip) may be formed of a structure (e.g., an epoxy structure), in which internal circuits and lines are disposed, and may be disposed on each printed circuit board (e.g., the first printed circuit board 110_p or the second printed circuit board 120_p).

According to an embodiment, the plurality of electronic components 120_pe1, 120_pe2, 120_pe3, 120_pe4, 120_pe5, and 120_pe6 may include at least one of a sensor module, a power management IC (PMIC), an audio module, a display control circuit, or a touch control module. Alternatively, the plurality of electronic components 120_pe1, 120_pe2, 120_pe3, 120_pe4, 120_pe5, and 120_pe6 may include at least one of a digitizer, a display (or a display driving circuit), a touch panel (or a touch control circuit), a camera, a sub power management IC (sub PMIC), a speaker amplifier (speaker AMP), a subscriber identity module (SIM) card (or a SIM socket), sensors, or an audio module. Referring to the illustrated drawings, the second printed circuit board 120_p may include at least one of a first electronic component 120_pe1 (or a first peripheral electronic component) that transmits and receives control signals (or IO signals) in an I2C manner, a second electronic component 120_pe2 (or a second peripheral electronic component) that receives control signals (or IO signals) in a GPIO manner, a third electronic component 120_pe3 (or a third peripheral electronic component) that transmits and receives control signals (or IO signals) in an I2S manner, a fourth electronic component 120_pe4 (or a fourth peripheral electronic component) that transmits and receives control signals (or IO signals) in an SPI manner, a fifth electronic component 120_pe5 (or a fifth peripheral electronic component) that transmits control signals (or IO signals) in an IRQ manner, and a sixth electronic component 120_pe6 (or a sixth peripheral electronic component) that transmits and receives control signals (or IO signals) in an I3C manner. The plurality of electronic components 120_pe1, 120_pe2, 120_pe3, 120_pe4, 120_pe5, and 120_pe6 may be configured to receive a specific signal from the second aggregator circuit 120_ag or transmit a specific signal to the second aggregator circuit 120_ag, based on any one of the above-described various IO communication methods. In this regard, the second printed circuit board 120_p may include a second signal line 120_sg that connects the second aggregator circuit 120_ag and the plurality of electronic components 120_pe1, 120_pe2, 120_pe3, 120_pe4, 120_pe5, and 120_pe6. At least a portion of the second signal line 120_sg may be disposed on at least one of the plurality of layers of the second printed circuit board 120_p. Meanwhile, depending on a disposition form of the first to sixth electronic components 120_pe1, 120_pe2, 120_pe3, 120_pe4, 120_pe5, and 120_pe6 described in FIG. 4, types of the respective electronic components 120_pe1, 120_pe2, 120_pe3, 120_pe4, 120_pe5, and 120_pe6 may be changed. When a disposition position of the first to sixth electronic components 120_pe1, 120_pe2, 120_pe3, 120_pe4, 120_pe5, and 120_pe6 described in FIG. 4 is changed, the number and types of signal lines included in the second signal line 120_sg that connects the respective electronic components 120_pe1, 120_pe2, 120_pe3, 120_pe4, 120_pe5, and 120_pe6 and the second aggregator circuit 120_ag also may be changed.

The flexible board 100_fb may be disposed to connect the first aggregator circuit 110_ag and the second aggregator circuit 120_ag. A portion of the flexible board 100_fb may be at least partially coupled to the first hinge device 140, may be at least partially accommodated in the hinge housing 150, and may be configured to transmit, deliver, propagate, or output the second control signal. According to an embodiment, a portion (e.g., a left portion with reference to the illustrated drawings) of the flexible board 100_fb may be disposed to overlap the first housing 110 (or the first printed circuit board 110_p), when viewed in a direction from a rear surface toward a front surface of the first display 160 (or in a direction from a rear surface of the first housing 110 toward a front direction). Another portion (e.g., a right portion with reference to the illustrated drawings) of the flexible board 100_fb may be disposed to overlap the second housing 120 (or the second printed circuit board 120_p), when viewed in a direction from a rear surface toward a front surface of the first display 160 (or in a direction from a rear surface of the second housing 120 toward a front direction). A central portion disposed between a portion of the flexible board 100_fb and another portion of the flexible board 100_fb may be disposed to overlap a portion of the first housing 110 and the second housing 120 or at least a portion of the hinge housing 150. As an example, a central portion of the flexible board 100_fb may be disposed in a bent form inside the hinge housing 150. The flexible board 100_fb may include a flexible board line 100_se that transmits serial signals serialized by the first aggregator circuit 110_ag to the second aggregator circuit 120_ag (or transmits serial signals serialized by the second aggregator circuit 120_ag to the first aggregator circuit 110_ag). The flexible board line 100_se may include lines, through which serialized signals are transmitted and received. As an example, the flexible board 100_fb may further include other lines in addition to the flexible board line 100_se.

FIG. 5 is a view illustrating an example of a structure including a processor, aggregator circuits, a flexible board, and a plurality of electronic components, among components of a foldable electronic device according to an embodiment of the disclosure.

Referring to FIGS. 1 to 5, a foldable electronic device 100 according to an embodiment may include the processor 110_ap, the first aggregator circuit 110_ag, a flexible board 100_fb, a second aggregator circuit 120_ag, and a plurality of electronic components 120_pe1, 120_pe2, 120_pe3, 120_pe4, 120_pe5, and 120_pe6. Additionally, the foldable electronic device 100 may include the first signal line 110_sg that connects the processor 110_ap and the first aggregator circuit 110_ag, and a second signal line 120_sg that connects the second aggregator circuit 120_ag and the plurality of electronic components 120_pe1, 120_pe2, 120_pe3, 120_pe4, 120_pe5, and 120_pe6.

The processor 110_ap may include a configuration that is substantially the same as or similar to the processor 110_ap described above with reference to FIG. 4. The processor 110_ap may include interfaces for various input/output control or input/output control ports 110_ap1, 110_ap2, 110_ap3, 110_ap4, 110_ap5, and 110_ap6. The input/output control ports 110_ap1, 110_ap2, 110_ap3, 110_ap4, 110_ap5, and 110_ap6 may include a first input/output control port 110_ap1 corresponding to I2C, a second input/output control port 110_ap2 corresponding to I3C, a third input/output control port 110_ap3 corresponding to SPI, a fourth input/output control port 110_ap4 corresponding to I2S, a fifth input/output control port 110_ap5 corresponding to GPIO, and a sixth input/output control port 110_ap6 that supports other input/output interfaces. The first signal line 110_sg may include signal lines that are connected to the plurality of input/output control ports 110_ap1, 110_ap2, 110_ap3, 110_ap4, 110_ap5, and 110_ap6. The first signal line 110_sg described in FIG. 5 may include a configuration that is the same as or similar to the first signal line 110_sg described above with reference to FIG. 4. Furthermore, a disposition of signal lines included in the first signal line 110_sg may vary depending on types of the input/output control ports. As an example, the first signal line 110_sg may include a certain number of signal lines (e.g., 50 lines including I2C six groups and 12 pins (e.g., pins for an operation of a sensor, a PMIC, a camera, and a sub-touch screen (e.g., a touch screen disposed on the second display 131 of FIG. 2)), I2S one group and four pins (e.g., pins for an audio AMP), SPI two groups and nine pins (e.g., pins for a main touch screen disposed on the first display 160 of FIG. 1 and for display information), I3C one group and two pins (e.g., pins for a sensor), and GPIO 23 groups and 23 pins (e.g., pins for signals such as enable, reset, and interrupt)), or a number of lines, the number of which depends on an input/output function supported by the processor 110_ap).

The first aggregator circuit 110_ag may include a configuration that is the same as or similar to the first aggregator circuit 110_ag described above with reference to FIG. 4. The first aggregator circuit 110_ag may include a plurality of first input/output converters 110_c1, 110_c2, 110_c3, 110_c4, 110_c5, and 110_c6 that are connected to multi-IO ports (or the plurality of input/output control ports 110_ap1, 110_ap2, 110_ap3, 110_ap4, 110_ap5, and 110_ap6) of the processor 110_ap, respectively. Each of the first input/output converters may convert each multi-IO block data into a serial interface IO type and transmit it to a signal converter, or may convert a signal of a serial interface IO type received from the signal converter into a multi-IO block data type. As an example, the plurality of first input/output converters 110_c1, 110_c2, 110_c3, 110_c4, 110_c5, and 110_c6 may include a first input/output converter 110_c1 that is connected to a first input/output control port 110_ap1 of the processor 110_ap, a second input/output converter 110_c2 that is connected to a second input/output control port 110_ap2 of the processor 110_ap, a third input/output converter 110_c3 that is connected to a third input/output control port 110_ap3 of the processor 110_ap, a fourth input/output converter 110_c4 that is connected to a fourth input/output control port 110_ap4 of the processor 110_ap, a fifth input/output converter 110_c5 that is connected to a fifth input/output control port 110_ap5 of the processor 110_ap, and a sixth input/output converter 110_c6 that is connected to a sixth input/output control port 110_ap6 of the processor 110_ap. The first to sixth input/output converters 110_c1, 110_c2, 110_c3, 110_c4, 110_c5, and 110_c6 may be connected to a first signal converter 110_PS (serialize/de-serialize block). The first signal converter 110_PS may include a parallel-to-serial converter and a serial-to-parallel converter. The first signal converter 110_PS may schedule data transmitted, delivered, propagated, or output by the input/output converters 110_c1, 110_c2, 110_c3, 110_c4, 110_c5, and 110_c6 by using a scheduler, and may transmit them to another aggregator circuit (e.g., the second aggregator circuit 120_ag).

According to an embodiment, a parallel-to-serial converter of the first signal converter 110_PS may receive N signals (e.g., control signals) from the plurality of first input/output converters 110_c1, 110_c2, 110_c3, 110_c4, 110_c5, and 110_c6 and convert them into M signals (M is a natural number that is smaller than N), and then, may transmit them to the second aggregator circuit 120_ag through the flexible board line 100_se of the flexible board 100_fb. A serial-to-parallel converter of the first signal converter 110_PS may divide K signals received from the second aggregator circuit 120_ag (or a second signal converter 120_PS of the second aggregator circuit 120_ag) into L signals, and may transmit the divided signals to the plurality of first input/output converters 110_c1, 110_c2, 110_c3, 110_c4, 110_c5, and 110_c6. Alternatively, a serial-to-parallel converter of the first signal converter 110_PS may divide M signals received from the second aggregator circuit 120_aginto N signals, and may transmit the divided signals to each of the plurality of first input/output converters 110_c1, 110_c2, 110_c3, 110_c4, 110_c5, and 110_c6.

According to an embodiment, the first aggregator circuit 110_ag may aggregate/de-aggregate signals (e.g., signals that are transmitted through the above-described 50 lines) having a transmission speed that is lower than a set reference, among the signals output from the processor 110_ap. According to an embodiment, the first aggregator circuit 110_ag may include an internal SerDes circuit in relation to serialization or parallelization of signals. Device information of an electronic component connected to the processor 110_ap and data type information may be transmitted by adding related information to a header of serial packet data. In this process (operation), the processor 110_ap may use a predefined standard protocol. A serialized signal may be selected depending on a total bandwidth, and the processor 110_ap and the aggregator circuit may transmit and receive the serialized signal in a manner, such as I2C, I3C, or low-voltage differential signaling (LVDS).

According to an embodiment, the foldable electronic device 100 may require a bandwidth of a certain size or more, or may include a plurality of serial interfaces, in relation to a specific interface performance. In this case, a plurality of aggregator circuits may be disposed on one printed circuit board. Correspondingly, the foldable electronic device 100 may include a plurality of flexible boards that connect a plurality of aggregator circuits disposed on printed circuit boards. As an example, in FIG. 4, it is illustrated that one aggregator circuit (e.g., 110_ag) is disposed on the first printed circuit board 110_p and one aggregator circuit (e.g., 120_ag) is disposed on the second printed circuit board 120_p, but the foldable electronic device 100 may include a plurality of aggregator circuits disposed on the first printed circuit board 110_p, a plurality of aggregator circuits disposed on the second printed circuit board 120_p, and a plurality of flexible boards that connect the plurality of aggregator circuits disposed on the printed circuit boards 110_p and 120_p.

The second aggregator circuit 120_ag may have a structure that is the same as or similar to the first aggregator circuit 110_ag. For example, the second aggregator circuit 120_ag may include a second signal converter 120_PS and a plurality of second input/output converters 120_c1, 120_c2, 120_c3, 120_c4, 120_c5, and 120_c6. The second signal converter 120_PS may be connected to the first signal converter 110_PS through a line of the flexible board 100_fb, and may transmit and receive serialized signals. In this regard, the second signal converter 120_PS may include a serial-to-parallel converter and a parallel-to-serial converter. As an example, the second signal converter 120_PS may serialize parallelized signals received from the plurality of second input/output converters 120_c1, 120_c2, 120_c3, 120_c4, 120_c5, and 120_c6, and transmit them to the first signal converter 110_PS of the first aggregator circuit 110_ag through at least some lines of the flexible board 100_fb. The second signal converter 120_PS may parallelize serialized signals received from the first signal converter 110_PS, and then, may transmit them to the plurality of second input/output converters 120_c1, 120_c2, 120_c3, 120_c4, 120_c5, and 120_c6. The second signal converter 120_PS may identify a header of serialized signals transmitted by the first signal converter 110_PS to determine an input/output converter, to which at least some of the received control signals are transmitted. The second signal converter 120_PS may perform header writing for signals transmitted by the plurality of second input/output converters 120_c1, 120_c2, 120_c3, 120_c4, 120_c5, and 120_c6, convert them into serialized signals, and transmit them to the first signal converter 110_PS.

The second signal converter 120_PS may have the same or a similar structure as the first signal converter 110_PS, and may perform the same or a similar operation (e.g., a transmission/reception operation (e.g., transmission, reception, or an operation that is necessary for transmission and reception)). As an example, a parallel-to-serial converter of the second signal converter 120_PS may receive L signals (e.g., signals transmitted by the plurality of electronic components 120_pe1, 120_pe2, 120_pe3, 120_pe4, 120_pe5, and 120_pe6) from the plurality of second input/output converters 120_c1, 120_c2, 120_c3, 120_c4, 120_c5, and 120_c6, convert them into K signals where K is a natural number smaller than L, and then, may transmit them to the first aggregator circuit 110_ag through the flexible board line 100_se of the flexible board 100_fb. A serial-to-parallel converter of the second signal converter 120_PS may divide M signals received from the first aggregator circuit 110_ag into N signals, and may transmit the divided signals to the plurality of electronic components 120_pe1, 120_pe2, 120_pe3, 120_pe4, 120_pe5, and 120_pe6 through the plurality of second input/output converters 120_c1, 120_c2, 120_c3, 120_c4, 120_c5, and 120_c6. Alternatively, a serial-to-parallel converter of the second signal converter 120_PS may divide L signals received from the first aggregator circuit 110_ag into K signals, and may transmit the divided signals to each of the plurality of electronic components 120_pe1, 120_pe2, 120_pe3, 120_pe4, 120_pe5, and 120_pe6 through the plurality of second input/output converters 120_c1, 120_c2, 120_c3, 120_c4, 120_c5, and 120_c6.

According to an embodiment, the plurality of second input/output converters 120_c1, 120_c2, 120_c3, 120_c4, 120_c5, and 120_c6 may be disposed between the second signal converter 120_PS and the plurality of electronic components 120_pe1, 120_pe2, 120_pe3, 120_pe4, 120_pe5, and 120_pe6. For example, the plurality of second input/output converters 120_c1, 120_c2, 120_c3, 120_c4, 120_c5, and 120_c6 may include a seventh input/output converter 120_c1 that is disposed between the second signal converter 120_PS and the first electronic component 120_pe1, an eighth input/output converter 120_c2 that is disposed between the second signal converter 120_PS and the second electronic component 120_pe2, a ninth input/output converter 120_c3 that is disposed between the second signal converter 120_PS and the third electronic component 120_pe3, a tenth input/output converter 120_c4 that is disposed between the second signal converter 120_PS and the fourth electronic component 120_pe4, an eleventh input/output converter 120_c5 that is disposed between the second signal converter 120_PS and the fifth electronic component 120_pe5, and a twelfth input/output converter 120_c6 that is disposed between the second signal converter 120_PS and the sixth electronic component 120_pe6. The plurality of electronic components 120_pe1, 120_pe2, 120_pe3, 120_pe4, 120_pe5, and 120_pe6 and the plurality of second input/output converters 120_c1, 120_c2, 120_c3, 120_c4, 120_c5, and 120_c6 may be connected to each other through a second signal line 120_sg that transmits multi-IO signals.

FIG. 6 is a view illustrating another example of a structure including a processor, aggregator circuits, a flexible board, and a plurality of electronic components, among components of a foldable electronic device according to an embodiment of the disclosure.

Referring to FIGS. 1 to 6, a foldable electronic device 100 according to an embodiment may include the processor 110_ap, the first aggregator circuit 110_ag, a flexible board 100_fb, a second aggregator circuit 120_ag, and a plurality of electronic components 120_pe1, 120_pe2, 120_pe3, 120_pe4, and 120_pe5. Additionally, the foldable electronic device 100 may include the first signal line 110_sg that connects the processor 110_ap and the first aggregator circuit 110_ag, and a second signal line 120_sg that connects the second aggregator circuit 120_ag and the plurality of electronic components 120_pe1, 120_pe2, 120_pe3, 120_pe4, and 120_pe5. The first signal line 110_sg may be disposed on a first printed circuit board (e.g., the first printed circuit board 110_p of FIG. 4), on which the processor 110_ap is mounted, and the second signal line 120_sg may be disposed on a second printed circuit board (e.g., the second printed circuit board 120_p of FIG. 4), on which the plurality of electronic components 120_pe1, 120_pe2, 120_pe3, 120_pe4, and 120_pe5 are mounted.

The processor 110_ap may include a plurality of input/output control ports, as described above with reference to FIG. 5. As an example, the processor 110_ap illustrated in FIG. 6 may include a form, in which five input/output control ports are exemplified. The processor 110_ap may generate control signals related to control of the plurality of electronic components 120_pe1, 120_pe2, 120_pe3, 120_pe4, and 120_pe5, transmit them to the plurality of electronic components 120_pe1, 120_pe2, 120_pe3, 120_pe4, and 120_pe5, and receive at least some of signals generated during operations of the plurality of electronic components 120_pe1, 120_pe2, 120_pe3, 120_pe4, and 120_pe5. As an example, the processor 110_apmay generate input/output control signals related to input/output control of the plurality of electronic components 120_pe1, 120_pe2, 120_pe3, 120_pe4, and 120_pe5, and transmit at least some of the generated input/output control signals to the plurality of electronic components 120_pe1, 120_pe2, 120_pe3, 120_pe4, and 120_pe5 through the aggregator circuits 110_ag and 120_ag.

The first aggregator circuit 110_ag may include first input/output converters 110_c1, 110_c2, 110_c3, 110_c4, and 110_c5 (or transceiver circuits, or signal transceiving interfaces) that are connected to respective input/output control ports of the processor 110_ap, and a first signal converter (e.g., a first parallel-to-serial converter 110_PS1 and a first serial-to-parallel converter 110_PS2).

Among the first input/output converters 110_c1, 110_c2, 110_c3, 110_c4, and 110_c5, the first input/output converter 110_c1 may transmit a signal transmitted from the processor 110_ap to the first parallel-to-serial converter 110_PS1, and transmit a signal transmitted from the first serial-to-parallel converter 110_PS2 to the processor 110_ap. Alternatively, the first input/output converter 110_c1 may be disposed between the processor 110_ap and the first parallel-to-serial converter 110_PS1, or between the first serial-to-parallel converter 110_PS2 and the processor 110_ap. In this regard, the first input/output converter 110_c1 may include an interface circuit for transmitting and receiving signals to and from the processor 110_ap, a transmission circuit TX that transmits a signal received from the processor 110_ap to the first parallel-to-serial converter 110_PS1, and a reception circuit RX that receives a signal from the first serial-to-parallel converter 110_PS2. The first input/output converter 110_c1 may be configured to transmit and receive signals to and from a first type input/output control port (e.g., a port that transmits and receives signals in an I2S scheme) of the processor 110_ap through a portion of the first signal line 110_sg.

Among the first input/output converters 110_c1, 110_c2, 110_c3, 110_c4, and 110_c5, the second input/output converter 110_c2 may have a structure that is the same as or similar to the first input/output converter 110_c1. The second input/output converter 110_c2 may be configured to transmit and receive signals to and from a second type input/output control port (e.g., a port that transmits and receives signals in an SPI scheme) of the processor 110_ap. Among the first input/output converters 110_c1, 110_c2, 110_c3, 110_c4, and 110_c5, the third input/output converter 110_c3 may have a structure that is similar to the first input/output converter 110_c1. The third input/output converter 110_c3 may be configured to transmit and receive signals to and from a third type input/output control port (e.g., a port that transmits and receives signals in an I2C or I3C scheme) of the processor 110_ap. Among the first input/output converters 110_c1, 110_c2, 110_c3, 110_c4, and 110_c5, the fourth input/output converter 110_c4 (or an output converter) may include a transmission circuit TX that is configured to transmit a signal received from the processor 110_ap to the first parallel-to-serial converter 110_PS1. The fourth input/output converter 110_c4 may be configured to transmit and receive signals to and from a fourth type input/output control port (or an output control port) (e.g., a port that transmits signals in a GPIO scheme) of the processor 110_ap. Among the first input/output converters 110_c1, 110_c2, 110_c3, 110_c4, and 110_c5, the fifth input/output converter 110_c5 (or an input converter) may include a reception circuit RX that is configured to transmit a signal received from the first serial-to-parallel converter 110_PS2 to the processor 110_ap. The fifth input/output converter 110_c5 may be configured to transmit a signal to a fifth type input/output control port (or an input control port) (e.g., a port that receives signals in an IRQ scheme) of the processor 110_ap.

The first parallel-to-serial converter 110_PS1 may serialize signals (e.g., multi-IO control signals) that are transmitted from the first input/output converter 110_c1, the second input/output converter 110_c2, the third input/output converter 110_c3, and the fourth input/output converter 110_c4, and transmit the serialized signal to the second aggregator circuit 120_ag through the flexible board line 100_se of the flexible board 100_fb. The first serial-to-parallel converter 110_PS2 may parallelize a serialized signal that is received through the flexible board line 100_se of the flexible board 100_fb, and transmit the parallelized signals to respective input/output converters (e.g., the first input/output converter 110_c1, the second input/output converter 110_c2, the third input/output converter 110_c3, and the fifth input/output converter 110_c5).

The flexible board 100_fb may connect the first aggregator circuit 110_ag and the second aggregator circuit 120_ag, and at least a portion of the flexible board 100_fb may be coupled to or received in at least one of a hinge housing (e.g., the hinge housing 150 of FIG. 4) or the first hinge device 140. As an example, the flexible board line 100_se of the flexible board 100_fb may include a first line 100_se_t that connects the first parallel-to-serial converter 110_PS1 of the first aggregator circuit 110_ag and the second serial-to-parallel converter 120_PS1 of the second aggregator circuit 120_ag, and a second line 100_se_r that connects the first serial-to-parallel converter 110_PS2 of the first aggregator circuit 110_ag and the second parallel-to-serial converter 120_PS2 of the second aggregator circuit 120_ag. The first line 100_se_t of the flexible board line 100_se may serve as a transmission line in an aspect of the first aggregator circuit 110_ag, and may serve as a reception line in an aspect of the second aggregator circuit 120_ag. The second line 100_se_r of the flexible board line 100_se may serve as a reception line in an aspect of the first aggregator circuit 110_ag, and may serve as a transmission line in an aspect of the second aggregator circuit 120_ag.

The plurality of electronic components may include, for example, first to fifth electronic components 120_pe1, 120_pe2, 120_pe3, 120_pe4, and 120_pe5. The first to fifth electronic components 120_pe1, 120_pe2, 120_pe3, 120_pe4, and 120_pe5 may include at least some of the plurality of electronic components 120_pe1, 120_pe2, 120_pe3, 120_pe4, 120_pe5, and 120_pe6 described above with reference to FIG. 5. As an example, the first to fifth electronic components 120_pe1, 120_pe2, 120_pe3, 120_pe4, and 120_pe5 may include at least one of a digitizer, a display (or a display driving circuit), a touch panel (or a touch control circuit), an audio module, a camera, a sub-PMIC, a speaker amplifier, a SIM card, or sensors.

The second aggregator circuit 120_ag may include second input/output converters 120_c1, 120_c2, 120_c3, 120_c4, and 120_c5 (or transceiver circuits, or signal transceiving interfaces) that are connected to respective ones of the plurality of electronic components 120_pe1, 120_pe2, 120_pe3, 120_pe4, and 120_pe5, and a second signal converter (e.g., a second parallel-to-serial converter 120_PS2 and a second serial-to-parallel converter 120_PS1).

Among the second input/output converters 120_c1, 120_c2, 120_c3, 120_c4, and 120_c5, the seventh input/output converter 120_c1 may transmit a signal transmitted from the first electronic component 120_pe1 to the second parallel-to-serial converter 120_PS2, and transmit a signal transmitted from the second serial-to-parallel converter 120_PS1 to the first electronic component 120_pe1. Alternatively, the seventh input/output converter 120_c1 may be disposed between the first electronic component 120_pe1 and the second parallel-to-serial converter 120_PS2, or between the second serial-to-parallel converter 120_PS1 and the first electronic component 120_pe1. In this regard, the seventh input/output converter 120_c1 may include an interface circuit for transmitting and receiving signals to and from the first electronic component 120_pe1, a transmission circuit TX that transmits a signal received from the first electronic component 120_pe1 to the second parallel-to-serial converter 120_PS2, and a reception circuit RX that receives a signal from the second serial-to-parallel converter 120_PS1. The seventh input/output converter 120_c1 may be configured to transmit and receive first-type input/output control signals (e.g., control signals according to an I2S scheme) through a portion of the second signal line 120_sg.

Among the second input/output converters 120_c1, 120_c2, 120_c3, 120_c4, and 120_c5, the eighth input/output converter 120_c2 may have a structure that is the same as or similar to the seventh input/output converter 120_c1. The eighth input/output converter 120_c2 may be configured to transmit and receive second-type input/output control signals (e.g., control signals according to an SPI scheme) of the second electronic component 120_pe2. Among the second input/output converters 120_c1, 120_c2, 120_c3, 120_c4, and 120_c5, the ninth input/output converter 120_c3 may have a structure that is similar to the seventh input/output converter 120_c1. The ninth input/output converter 120_c3 may be configured to transmit and receive third-type input/output control signals (e.g., control signals according to an I2C or I3C scheme) of the third electronic component 120_pe3. Among the second input/output converters 120_c1, 120_c2, 120_c3, 120_c4, and 120_c5, the tenth input/output converter 120_c4 (or an output converter) may include a transmission circuit TX that is configured to transmit a signal received from the fourth electronic component 120_pe4 to the second parallel-to-serial converter 120_PS2. The tenth input/output converter 120_c4 may be configured to transmit fourth-type input/output control signals (e.g., control signals according to an IRQ scheme) of the fourth electronic component 120_pe4 to the second parallel-to-serial converter 120_PS2. Among the second input/output converters 120_c1, 120_c2, 120_c3, 120_c4, and 120_c5, the eleventh input/output converter 120_c5 (or an input converter) may include a reception circuit RX that is configured to transmit a signal received from the second serial-to-parallel converter 120_PS1 to the fifth electronic component 120_pe5. The eleventh input/output converter 120_c5 may be configured to transmit fifth-type input/output control signals (e.g., control signals received according to a GPIO scheme) received from the second serial-to-parallel converter 120_PS1 to the fifth electronic component 120_pe5.

The second parallel-to-serial converter 120_PS2 may serialize signals (e.g., multi-IO control signals) that are transmitted from the seventh input/output converter 120_c1, the eighth input/output converter 120_c2, the ninth input/output converter 120_c3, and the tenth input/output converter 120_c4, and transmit the serialized signal to the first aggregator circuit 110_ag through the flexible board line 100_se of the flexible board 100_fb. The second serial-to-parallel converter 120_PS1 may parallelize a serialized signal that is received through the flexible board line 100_se of the flexible board 100_fb, and transmit the parallelized signals to respective input/output converters (e.g., the seventh input/output converter 120_c1, the eighth input/output converter 120_c2, the ninth input/output converter 120_c3, and the eleventh input/output converter 120_c5).

The structures of the aggregator circuits of the foldable electronic device 100 described with reference to FIGS. 5 and 6 may be applied to structures of at least some of various aggregator circuits or aggregator circuit parts described with reference to FIG. 4 or below.

The structure illustrated in FIG. 6 exemplifies a structure, in which transmission TX and reception RX are each implemented with a clock CLK and a data differential pair (or a differential data pair), so that a total of eight serial lines (or serial lines) are applied. The embodiments of the disclosure are not limited thereto, and the foldable electronic device 100 may have a structure including a total of six serial lines including with two I3C ports (CLK and DATA) and one sound-wire port (DATA and CLK). Alternatively, as needed, the foldable electronic device 100 may include an aggregator circuit that includes various signal lines of eight or more or less than six. The above-mentioned fifty signals may be serialized in an aggregator circuit (e.g., the first aggregator circuit 110_ag), and data converted into serialized signals (serial signals) in response thereto may be transmitted to another printed circuit board through an extended board 100_fb, and seven to eight serialized signals (serial signals) that are transmitted (delivered, propagated, or output) may be input to an aggregator circuit (e.g., the second aggregator circuit 120_ag) disposed on another printed circuit board (e.g., the second printed circuit board 120_p), and may be converted into fifty low-speed signals corresponding to a plurality of electronic components (peripheral devices) connected to an output port of the aggregator circuit (e.g., the second aggregator circuit 120_ag). According to an embodiment, low-speed signals may include signals in an MHz band (e.g., 1 MHz to 20 MHz), and an aggregated low-speed signal data rate may be determined depending on a bandwidth of a serial interface by the processor 110_ap or the aggregator circuit 110_ag or 120_ag. According to an embodiment, a bandwidth of a serial interface may be determined depending on a total data rate of aggregated low-speed signals. As described above, when aggregator circuits 110_ag and 120_ag are applied to the foldable electronic device 100, fifty lines, over which signals of less than a reference speed are transmitted, may be reduced to six to eight serial lines, and thus, a size of the flexible board 100_fb may be reduced to less than a certain size (e.g., 12 to 14 mm), and additional components (e.g., a 78-pin connector component) may also be removed.

FIG. 7 is a view illustrating another example of a disposition form of internal components of a foldable electronic device according to an embodiment of the disclosure.

Similar to the foldable electronic device 100 illustrated in FIG. 4, other components of the foldable electronic device 1111 illustrated in FIG. 7 are not illustrated or are briefly expressed to represent a connection relationship between a plurality of electronic components according to an embodiment of the disclosure, but the foldable electronic device 1111 of the disclosure is not limited thereto.

Referring to FIGS. 1 to 7, a foldable electronic device 1111 according to an embodiment may include a first housing 110 (or a first housing part), in which the second camera module 108 is disposed, the second housing 120 (or a second housing part), the hinge housing 150 (or a hinge housing part), the first hinge device 140 (or a hinge assembly), the first printed circuit board 110_p, the second printed circuit board 120_p, and the flexible board 100_fb (or a flexible printed circuit board or an FPCB). At least a portion of the hinge housing 150 may be disposed between the first housing 110 and the second housing 120. At least a portion of the first hinge device 140 may be accommodated in the hinge housing 150, and the first housing 110 and the second housing 120 may be rotatably connected to each other. Additionally or alternatively, the foldable electronic device 1111 may include a flexible display (e.g., the first display 160 of FIG. 3 or a flexible display) as illustrated in FIGS. 1 to 3 above.

The first housing 110 may include the same or similar configuration as that of the first housing 110 described in FIG. 4 above. Accordingly, a description of the first housing 110 may be replaced with or supplemented with the description of the first housing 110 described above with reference to FIG. 4.

According to an embodiment, the first printed circuit board 110_p may include the processor 110_ap (or a processing circuit or at least one processor), in which an aggregator circuit part 110_agi (e.g., an embedded aggregator circuit part configured to be embedded in the processor 110_ap or an aggregator circuit unit) is embedded. Meanwhile, in an embodiment of the disclosure, only the processor 110_ap in which an aggregator circuit part 110_agi is embedded disposed on the first printed circuit board 110_p is illustrated, but the disclosure is not limited thereto, and various other electronic components may be further disposed.

The processor 110_ap may, for example, perform at least one of processing, transferring, transmitting, receiving, and deleting various signals related to execution of various user functions or a system operation of the foldable electronic device 1111. Such the processor 110_ap may, for example, include at least one of an application processor, a communication processor, and an artificial intelligence (AI) processor. As an example, the processor 110_ap may include input/output controllers (I/O controllers) that are capable of transmitting and receiving input/output (I/O) signals (or control signals) to and from the aggregator circuit part 110_agi. For example, at least a portion of the processor 110_ap may include at least one input/output controller among an inter-integrated circuit (I2C) controller, an improved inter-integrated circuit (I3C) controller, an integrated inter-chip sound (I2S) controller or an inter-IC sound (I2S) controller, a serial peripheral interface (SPI) controller, an interrupt request (IRQ) controller, and a general-purpose input/output (GPIO) controller. The embedded aggregator circuit part 110_agi included in the processor 110_ap may include a plurality of input/output converters that are connected to input/output controllers, and a signal converter that is connected to the plurality of input/output converters. The processor 110_ap may include N internal signal lines that connect the input/output controllers and the plurality of input/output converters, N internal signal lines that connect the plurality of input/output converters and the signal converter, and M input/output ports (e.g., a natural number smaller than N) that are connected to the signal converter. Input/output ports of the signal converter embedded in the processor 110_ap may be electrically connected to the flexible board line 100_se of the flexible board 100_fb.

The processor 110_ap including the above-described embedded aggregator circuit part 110_agi may be designed (or configured) such that a signal line (e.g., the first signal line 110_sg of FIGS. 4 to 6) that connects an aggregator circuit (e.g., the first aggregator circuit 110_ag of FIG. 4) and the processor 110_ap is removed, and input/output controllers inside the processor 110_ap are directly connected to input/output converters of the aggregator circuit part 110_agi (e.g., the input/output converters 110_c1, 110_c2, 110_c3, 110_c4, 110_c5, or 110_c6 described in FIG. 5 or FIG. 6) to provide a more simplified foldable electronic device structure. The aggregator circuit part 110_agi may perform a role that is the same as or similar to a role of the first aggregator circuit 110_ag described above with reference to FIGS. 4 to 6. For example, the aggregator circuit part 110_agi may be configured to transmit and receive multiple I/O (multi-I/O) signals (or control signals) to and from input/output controllers of the processor 110_ap. The aggregator circuit part 110_agi may perform serialization on multiple I/O signals generated by the processor 110_ap, and may transmit them to the second aggregator circuit 120_ag disposed on the second printed circuit board 120_p through M input/output ports and signal lines, the number of which is smaller than the number of N multiple I/O signals. In this regard, the aggregator circuit part 110_agi may include a buffer part that may store N signals generated by input/output controllers of the processor 110_ap, a converter part (or a microcontroller or input/output converters) that may convert the received signals, a parallel-to-serial conversion part that may serialize the N signals into M signals (M is a natural number, M<N), and a serial-to-parallel conversion part that may parallelize the received signals.

The second housing 120 may include the same or similar configuration as that of the second housing 120 described in FIG. 4 above. Accordingly, a description of the second housing 120 may be replaced with or supplemented with the description of the second housing 120 of FIGS. 1 to 4 described above.

The second aggregator circuit 120_ag may include a configuration that is the same as or similar to the second aggregator circuit 120_ag described above with reference to FIGS. 1 to 6. Accordingly, a description of the second aggregator circuit 120_ag may be replaced with or supplemented with the description of the second aggregator circuit 120_ag of FIGS. 4 to 6 described above. As an example, the second aggregator circuit 120_ag may include K third ports and L fourth ports (L is a natural number that is greater than K). The number of the K third ports may be formed to be the same as or similar to the number of flexible board lines 100_se of the flexible board 100_fb. The number of the L fourth ports may be formed to be the same as or similar to the number of lines for communication of the plurality of electronic components described with reference to FIGS. 4 to 6. The number of the K third ports may be the same as the number of the M ports of the aggregator circuit part 110_agi, but the disclosure is not limited thereto. The number of the L fourth ports may be the same as the number of the N lines that connect input/output controllers of the processor 110_ap and the aggregator circuit part 110_agi, but the disclosure is not limited thereto.

The second printed circuit board 120_p may include a configuration that is the same as or similar to the second printed circuit board 120_p described above with reference to FIG. 4. Accordingly, a description of the second printed circuit board 120_p may be replaced with or supplemented with the description of the second printed circuit board 120_p of FIG. 4 described above. As an example, at least one of a first electronic component 120_pe1 that communicates through a first-type communication channel (e.g., I2C), a second electronic component 120_pe2 that communicates through a second-type communication channel (e.g., GPIO), a third electronic component 120_pe3 that communicates through a third-type communication channel (e.g., I2S), a fourth electronic component 120_pe4 that communicates through a fourth-type communication channel (e.g., SPI), a fifth electronic component 120_pe5 that communicates through a fifth-type communication channel (e.g., IRQ), and a sixth electronic component 120_pe6 that communicates through a sixth-type communication channel (e.g., I3C) may be disposed on the second printed circuit board 120_p.

According to an embodiment, the plurality of electronic components 120_pe1, 120_pe2, 120_pe3, 120_pe4, 120_pe5, and 120_pe6 may include at least one of a sensor module, a power management IC (PMIC), an audio module, a display, a touch panel, a display control circuit or a touch control module, a camera, a sub-PMIC, a speaker amplifier (speaker AMP), or a SIM card (or SIM socket).

The flexible board 100_fb may be disposed to connect the aggregator circuit part 110_agi of the processor 110_ap and the second aggregator circuit 120_ag. A portion of the flexible board 100_fb may be at least partially coupled to the first hinge device 140 or be at least partially accommodated in the hinge housing 150. The flexible board 100_fb may be configured to be the same as or similar to the flexible board 100_fb described above with reference to FIG. 4 (or at least one of FIGS. 5 and 6), except for connecting the aggregator circuit part 110_agi embedded in the processor 110_ap and the second aggregator circuit 120_ag. Accordingly, a description of the flexible board 100_fb may be replaced with or supplemented with the description of the flexible board 100_fb described in the preceding figures. According to an embodiment, the flexible board 100_fb may include the flexible board line 100_se that transmits serial signals serialized by the aggregator circuit part 110_agi to the second aggregator circuit 120_ag (or transmits serial signals serialized by the second aggregator circuit 120_ag to the aggregator circuit part 110_agi). The flexible board line 100_se may include lines, through which serialized signals are transmitted and received. As an example, the flexible board 100_fb may further include other lines in addition to the flexible board line 100_se.

As described above, a foldable electronic device 1111 according to an embodiment may include a structure, in which an aggregator circuit that is embedded in the processor 110_ap. In this case, by collectively providing a separate aggregator circuit, a space related to a disposition of a separate aggregator circuit may be saved. As an example, according to the foldable electronic device 1111 of the disclosure, a size of the first printed circuit board 110_p may be reduced, and a more stable and better signal transmission/reception performance may be provided through an operation of the aggregator circuit part 110_agi embedded in the processor 110_ap.

The second aggregator circuit 120_ag may include at least a portion of a structure of the aggregator circuit described above with reference to FIG. 5 or FIG. 6. Internal components of the aggregator circuit part 110_agi for aggregation may include at least a portion of a structure of the aggregator circuit described above with reference to FIG. 5 or FIG. 6, except for removal of a separate housing (or an epoxy structure) for chip design, because the aggregator circuit part 110_agi is formed in an interior of the processor 110_ap.

FIG. 8 is a view illustrating a first example of a disposition form of internal components of a foldable electronic device according to an embodiment of the disclosure.

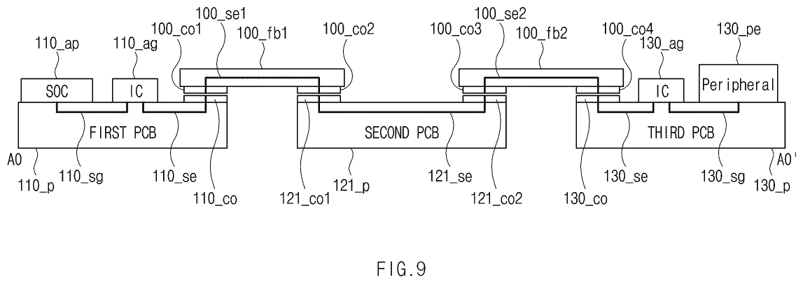

FIG. 9 is a view illustrating at least a portion of a cross section taken along cutting line A0-A0′ of FIG. 8 according to an embodiment of the disclosure.

According to an embodiment, although cutting line A0-A0′ illustrated in FIG. 8 is schematically illustrated in the drawing, it may be disposed to cut specific signal lines in respective components. Furthermore, the electronic component 130_pe illustrated in FIG. 9 indicates a specific electronic component that is located at a position cut by cutting line A0-A0′, and may be any one of a plurality of electronic components 130_pe1, 130_pe2, 130_pe3, 130_pe4, 130_pe5, and 130_pe6 that may be disposed on a third printed circuit board 130_p. According to an embodiment, a structure of at least a portion of a cut surface described with reference to FIG. 9 may also be applied to FIG. 4 described above. For example, the flexible board 100_fb described with reference to FIG. 4 may be formed to be the same as or similar to the first flexible board 100_fb1 described with reference to FIG. 9, and accordingly, the flexible board 100_fb may include a first connector 100_co1 that is coupled to a first board connector 110_co of the first printed circuit board 110_p and a second connector 100_co2 that is coupled to a second board connector 121_co1 of the second printed circuit board 121_p.

Similar to the foldable electronic device 100 illustrated in FIG. 4, other components of the foldable electronic device 1112 (or a second-type foldable electronic device, a foldable electronic device that is folded twice or more) illustrated in FIG. 8 are not illustrated or are briefly expressed to represent a connection relationship between a plurality of electronic components according to an embodiment of the disclosure, but the foldable electronic device 1112 of the disclosure is not limited thereto.

Referring to FIGS. 1 to 8, a foldable electronic device 1112 may include a first housing 110 (or a first housing part), in which the second camera module 108 is disposed, the second housing 120 (or a second housing part), a third housing 130 (or a third housing part), the first hinge housing 151 (or a first hinge housing part), the second hinge housing 152 (or a second hinge housing part), the first hinge device 140 (or a first hinge assembly), the third hinge device 140-2 (or a second hinge assembly), the first printed circuit board 110_p, the second printed circuit board 121_p, the third printed circuit board 130_p, the first flexible board 100_fb1, and the second flexible board 100_fb2.

At least a portion of the first hinge housing 151 may be disposed between the first housing 110 and the second housing 120. At least a portion of the first hinge device 140 may be accommodated in the first hinge housing 151, and the first housing 110 and the second housing 120 may be rotatably connected to each other. At least a portion of the second hinge housing 152 may be disposed between the second housing 120 and the third housing 130. At least a portion of the third hinge device 140-2 may be accommodated in the second hinge housing 152, and the second housing 120 and the third housing 130 may be rotatably connected to each other. In the above description, one hinge device is exemplified as being disposed in one hinge housing, but the foldable electronic device 1112 of the disclosure is not limited thereto, and a plurality of hinge devices (e.g., 140 and 140-1) may be accommodated in one hinge housing (e.g., 151 or 152). Furthermore, the first hinge device 140, in which at least a portion of the first hinge housing 151 is received, and the third hinge device 140-2, in which at least a portion of the second hinge housing 152 is received, may be configured in different types. As an example, the first hinge device 140 may be configured as an in-folding (or inward-fold) type hinge device (or an out-folding (or outward-fold) type hinge device), and the third hinge device 140-2 may be configured as an out-folding type hinge device (or an in-folding type hinge device).

Additionally or alternatively, the foldable electronic device 1112 may include a flexible display (e.g., the first display 160 of FIG. 3 or a flexible display) as illustrated in FIGS. 1 to 4 above. At least a portion of the flexible display may be accommodated in the first to third housings 110 to 130, and may be configured to be folded or unfolded in response to folding or unfolding (an unfolding state or a flat state) of the housings (e.g., the first housing 110, the second housing 120, and the third housing 130).

The first housing 110 may include a configuration that is the same as or similar to at least one of the first housings 110 described above with reference to FIGS. 1 to 4 and FIG. 7. Correspondingly, a detailed description of the first housing 110 may be replaced with or supplemented with the description of the first housing 110 described above. As an example, the first printed circuit board 110_p may be disposed in the first housing 110.

According to an embodiment, the processor 110_ap (or a processing circuit or at least one processor), the first aggregator circuit 110_ag (or a first aggregator), the first signal line 110_sg, a first board line 110_s1, a PMIC 110_PM (or an electronic component (an electric component or a component) of the first housing 110), and a second board line 110_s2 may be disposed on the first printed circuit board 110_p. Meanwhile, in an embodiment of the disclosure, only the processor 110_ap, the first aggregator circuit 110_ag, the first signal line 110_sg, the first circuit line 110_se, the first board line 110_s1, the PMIC 110_PM, and the second board line 110_s2 disposed on the first printed circuit board 110_p are illustrated, but the disclosure is not limited thereto, and various other electronic components may be further disposed. According to an embodiment, a speed of a signal transmitted through the first board line 110_s1 and the second board line 110_s2 may be faster than a speed of a signal transmitted through the first circuit line 110_se. Alternatively, a high-speed signal (e.g., a GHz band signal) may be transmitted through board lines (e.g., the first board line 110_s1 and the second board line 110_s2), and a low-speed signal (e.g., an MHz band signal) may be transmitted through circuit lines (e.g., the first circuit line 110_se). A speed criterion of the high-speed signal and the low-speed signal may vary depending on hardware specifications (or performance) of an applied device.

According to an embodiment, the first printed circuit board 110_p may include a first board connector 110_co that is coupled to a first connector 100_co1 formed on the first flexible board 100_fb1, and a first circuit line 110_se that connects the first aggregator circuit 110_ag and the first board connector 110_co. The first circuit line 110_se may be used to transmit and receive a serialized signal. The first signal line 110_sg may be disposed to connect a first part (or first input/output ports or first input/output leads) of the processor 110_ap and the first aggregator circuit 110_ag, and the first board line 110_s1 may be disposed to connect a second part (or second ports or second leads) of the processor 110_ap and the first board connector 110_co. The second board line 110_s2 may be disposed to connect the PMIC 110_PM and the first board connector 110_co. The first board line 110_s1 and the second board line 110_s2 may connect the first board connector 110_co and a second part of the processor 110_ap or the PMIC 110_PM not via the first aggregator circuit 110_ag. The first printed circuit board 110_p may include a portion (e.g., the first board connector 110_co) that is connected to a first connector 100_co1 disposed at a first end of the first flexible board 100_fb1.

The processor 110_ap may, for example, perform at least one of processing, transferring, transmitting, receiving, and deleting various signals related to execution of various user functions or a system operation of the foldable electronic device 1112. Such the processor 110_ap may be the same as or at least partially similar to the processor 110_ap described in FIGS. 1 to 7 above. Accordingly, a description of the processor 110_ap in FIG. 8 may be replaced with or supplemented with the description of the processor 110_ap described in FIGS. 1 to 7 above. According to an embodiment, at least a portion of the processor 110_ap may be configured to transmit and receive IO signals (input/output signals) or control signals to and from the first aggregator circuit 110_ag, based on at least one communication method, among inter-integrated circuit (I2C), improved inter-integrated circuit (I3C), integrated inter-chip sound or inter IC sound (I2S), serial peripheral interface (SPI), interrupt request (IRQ), and general-purpose input/output (GPIO). In this regard, the first signal line 110_sg may be disposed between the processor 110_ap and the first aggregator circuit 110_ag for transmitting and receiving multiple IO signals. Additionally or alternatively, the processor 110_ap may generate control signals related to driving a plurality of electronic components 130_pe1, 130_pe2, 130_pe3, 130_pe4, 130_pe5, and 130_pe6 disposed on the third printed circuit board 130_p, and transmit them to the plurality of electronic components 130_pe1, 130_pe2, 130_pe3, 130_pe4, 130_pe5, and 130_pe6 or receive signals from the plurality of electronic components 130_pe1, 130_pe2, 130_pe3, 130_pe4, 130_pe5, and 130_pe6. According to an embodiment, the processor 110_ap may include a port that is connected to the first board line 110_s1 for transmitting and receiving signals (e.g., a payload) related to driving the plurality of electronic components 130_pe1, 130_pe2, 130_pe3, 130_pe4, 130_pe5, and 130_pe6.

The first aggregator circuit 110_ag may be accommodated in the first housing 110 (or accommodated in the first housing 110 in a state of being disposed on the first printed circuit board 110_p). The first aggregator circuit 110_ag may have the same or a similar configuration as the first aggregator circuit 110_ag described in FIG. 4 (or FIGS. 5 and 6) above. Accordingly, a description of the first aggregator circuit 110_ag in FIG. 8 may be replaced with or supplemented with the description of the first aggregator circuit 110_ag in the preceding drawings. As an example, the first aggregator circuit 110_ag may include a buffer that may store N signals transmitted from the processor 110_ap, converters (or a microcontroller or input/output converters) that may convert the received signals, a parallel-to-serial converter that may serialize the N signals into M signals (M is a natural number, M<N), and a serial-to-parallel converter that may parallelize the received signals. According to an embodiment, the first aggregator circuit 110_ag may be connected to a first connector 100_co1 (or a connector that connects to the first board connector 110_co disposed on the first printed circuit board 110_p) of the first flexible board 100_fb1 through the first circuit line 110_se.

The second housing 120 may be disposed between the first housing 110 and the third housing 130. At least a portion of the second housing 120 may be formed of a metal material. Alternatively, at least a portion of the second housing 120 may be formed of a non-metal material (or an injection-molded material). The second housing 120 may include, for example, an inner bottom having a rectangular shape (or a polygonal shape or a polygonal shape, at least a portion of which includes a curved surface), and sides that are formed at a periphery of the bottom and are formed higher than the bottom. The inner bottom may include a front surface, on which a portion of the foldable display is disposed, and a rear surface, on which the second printed circuit board 121_p is disposed. As an example, the foldable electronic device 1112 may further include a structure (e.g., a boss, an adhesive member, or an adhesive) for fixing the second printed circuit board 121_p to a bottom (e.g., a rear surface bottom) of the second housing 120. A battery may also be disposed in the second housing 120. The second housing 120 may be connected to the first housing 110 through the first hinge device 140, and may be disposed while forming a specific angle with the first housing 110 in response to a folding or unfolding operation. The second housing 120, for example, may be connected to the third housing 130 through the third hinge device 140-2, and may be disposed while forming a specific angle with the third housing 130 in response to a folding or unfolding operation.

According to an embodiment, the second printed circuit board 121_p may be disposed on one surface of the second housing 120. The second printed circuit board 121_p may include the second board connector 121_co1 (or a first board connector of the second printed circuit board 121_p) that is connected to the second connector 100_co2 formed on the first flexible board 100_fb1, and a third board connector 121_co2 (or a second board connector of the second printed circuit board 121_p) that is connected to a third connector 100_co3 formed on the second flexible board 100_fb2. The second printed circuit board 121_p may include a second circuit line 121_se that connects a first part of the second board connector 121_co1 and a first part of the third board connector 121_co2, a third board line 121_s1 that connects a second part of the second board connector 121_co1 and a second part of the third board connector 121_co2, and a fourth board line 121_s2 that connects a third part of the second board connector 121_co1 and a third part of the third board connector 121_co2. The second circuit line 121_se may be connected to the first circuit line 110_se through a line (e.g., a first flexible board line 100_se1) of the first flexible board 100_fb1. The third board line 121_s1 may be connected to the first board line 110_s1 through a line of the first flexible board 100_fb1, and the fourth board line 121_s2 may be connected to the second board line 110_s2 through a line of the first flexible board 100_fb1.

The third housing 130 may be disposed to be connected to the second housing 120 through the third hinge device 140-2. The third housing 130 may have the same or a similar configuration as that of the second housing 120 described in FIGS. 1 to 4 above. Accordingly, a description of the third housing 130 may be replaced with or supplemented with at least a part of the description of the second housing 120 described above. According to an embodiment, an inner bottom of the third housing 130 may include a front surface, on which a portion of the foldable display is disposed, and a rear surface, on which the third printed circuit board 130_p is disposed. As an example, the foldable electronic device 1112 may further include a structure (e.g., a boss, an adhesive member, or an adhesive) for fixing the third printed circuit board 130_p to a bottom (e.g., a rear surface bottom) of the third housing 130. A battery may also be disposed in the third housing 130. The third housing 130, for example, may be connected to the second housing 120 through the third hinge device 140-2, and may be disposed while forming a specific angle with the second housing 120 in response to a folding or unfolding operation.

According to an embodiment, a plurality of electronic components 130_pe1, 130_pe2, 130_pe3, 130_pe4, 130_pe5, and 130_pe6, the third aggregator circuit 130_ag, a fourth board connector 130_co that is connected to a fourth connector 100_co4 provided at one side of the second flexible board 100_fb2, a third circuit line 130_se, a fifth board line 130_s1, a sixth board line 130_s2, and a third signal line 130_sg may be disposed on the third printed circuit board 130_p. The third printed circuit board 130_p may be accommodated in the third housing 130 (or a third housing part), and may include a portion (e.g., the fourth board connector 130_co) that is connected to a connector (e.g., the fourth connector 100_co4) disposed at a second end of the second flexible board 100_fb2.

According to an embodiment, the plurality of electronic components 130_pe1, 130_pe2, 130_pe3, 130_pe4, 130_pe5, and 130_pe6 may include at least one of a digitizer, a display (or a display driving circuit), a touch panel (or a touch control circuit), a camera, a sub-PMIC, a speaker amplifier, an audio module, a SIM card, or sensors. Referring to the illustrated drawings, the third printed circuit board 130_p may include at least one of a seventh electronic component 130_pe1 (or a first peripheral electronic component) that transmits and receives control signals (or IO signals) in an I2C manner, an eighth electronic component 130_pe2 (or a second peripheral electronic component) that receives control signals (or IO signals) in a GPIO manner, a ninth electronic component 130_pe3 (or a third peripheral electronic component) that transmits and receives control signals (or IO signals) in an I2S manner, a tenth electronic component 130_pe4 (or a fourth peripheral electronic component) that transmits and receives control signals (or IO signals) in an SPI manner, an eleventh electronic component 130_pe5 (or a fifth peripheral electronic component) that transmits control signals (or IO signals) in an IRQ manner, and a twelfth electronic component 130_pe6 (or a sixth peripheral electronic component) that transmits and receives control signals (or IO signals) in an I3C manner. The plurality of electronic components 130_pe1, 130_pe2, 130_pe3, 130_pe4, 130_pe5, and 130_pe6 may be configured to receive a signal from the third aggregator circuit 130_ag or transmit a signal to the third aggregator circuit 130_ag, based on any one of the above-described various IO communication methods.

According to an embodiment, the third printed circuit board 130_p may include the third signal line 130_sg that connects the third aggregator circuit 130_ag and the plurality of electronic components 130_pe1, 130_pe2, 130_pe3, 130_pe4, 130_pe5, and 130_pe6. At least a portion of the third signal line 130_sg may be disposed on at least one of the plurality of layers of the third printed circuit board 130_p. The fifth board line 130_s1 may connect the fourth board connector 130_co and at least some (e.g., a seventh electronic component 130_pe1 or a first peripheral electronic component) of the plurality of electronic components 130_pe1, 130_pe2, 130_pe3, 130_pe4, 130_pe5, and 130_pe6, and the sixth board line 130_s2 may connect the fourth board connector 130_co and at least some (e.g., a twelfth electronic component 130_pe6 or a sixth peripheral electronic component) of the plurality of electronic components 130_pe1, 130_pe2, 130_pe3, 130_pe4, 130_pe5, and 130_pe6. The fifth board line 130_s1 and the sixth board line 130_s2 may connect different electronic components and the fourth board connector 130_co, or may connect the same electronic component and the fourth board connector 130_co. For example, electronic components that are connected to the fourth board connector 130_co by the fifth board line 130_s1 and the sixth board line 130_s2 may overlap each other. The fifth board line 130_s1 may be connected to the third board line 121_s1 through the second flexible board 100_fb2, and the sixth board line 130_s2 may be connected to the fourth board line 121_s2 through the second flexible board 100_fb2.

According to an embodiment, through the first board line 110_s1, some lines of the first flexible board 100_fb1, the third board line 121_s1, some lines of the second flexible board 100_fb2, and the fifth board line 130_s1, data (e.g., a payload) of a first electronic component 130_pe1, 130_pe2, 130_pe3, 130_pe4, 130_pe5, or 130_pe6 may be transmitted to the processor 110_ap, or data (e.g., signals other than IO control signals) of the processor 110_ap may be transmitted to the first electronic component 130_pe1. According to an embodiment, the first electronic component 130_pe1 and the processor 110_ap may transmit and receive input/output control signals (I/O control signals) through the first signal line 110_sg, a signal line of the first flexible board 100_fb1, the second signal line 121_se, a signal line of the second flexible board 100_fb2, and the third signal line 130_sg. According to various embodiments, the first electronic component 130_pe1 and the processor 110_ap may also transmit and receive a payload, input/output control signals (I/O control signals), and other signals through the first board line 110_s1, some lines of the first flexible board 100_fb1, the third board line 121_s1, some lines of the second flexible board 100_fb2, and the fifth board line 130_s1.

According to an embodiment, payloads of the plurality of electronic components 130_pe1, 130_pe2, 130_pe3, 130_pe4, 130_pe5, and 130_pe6 may be transmitted and received to and from the processor 110_ap through the first board line 110_s1, some lines of the first flexible board 100_fb1, the third board line 121_s1, some lines of the second flexible board 100_fb2, and the fifth board line 130_s1. According to an embodiment, I/O control signals of the plurality of electronic components 130_pe1, 130_pe2, 130_pe3, 130_pe4, 130_pe5, and 130_pe6 may be transmitted and received to and from the processor 110_ap through the first signal line 110_sg, the first circuit line 110_se, a signal line of the first flexible board 100_fb1, the second circuit line 121_se, a signal line of the second flexible board 100_fb2, the third circuit line 130_se, and the third signal line 130_sg.

As an example, electric power of the PMIC 110_PM may be supplied to the sixth electronic component 130_pe6 through the second board line 110_s2, other lines of the first flexible board 100_fb1, the fourth board line 121_s2, other lines of the second flexible board 100_fb2, and the sixth board line 130_s2.

According to an embodiment, although not illustrated, power of the PMIC 110_PM may also be supplied to the plurality of electronic components 130_pe1, 130_pe2, 130_pe3, 130_pe4, 130_pe5, and 130_pe6 through the second board line 110_s2, other lines of the first flexible board 100_fb1, the fourth board line 121_s2, other lines of the second flexible board 100_fb2, and the sixth board line 130_s2.

According to an embodiment, electric power of the PMIC 110_PM may be supplied to some electronic components (e.g., 130_pe2, 130_pe3, 130_pe4, and 130_pe5) through the second signal line 110_s2, other lines (or a signal line) of the first flexible board 110_fb1, the fourth board line 121_s2, other lines (or a signal line) of the second flexible board 110_fb2, the third circuit line 130_se, and the third signal line 130_sg.

According to an embodiment, electric power of the PMIC 110_PM may be supplied to a first electronic component (e.g., 130_pe1) through a portion of a line of the first flexible board 110_fb1, the second signal line 110_s2, the second board line 121_s1 (or the second signal line 121_se or the fourth board line 121_s2), a portion of a line of the second flexible board 110_fb2, and the fifth board line 130_s1 (or the third circuit line 130_se and the third signal line 130_sg).

According to an embodiment, electric power of the PMIC 110_PM may be transmitted to the third aggregator circuit 130_ag through the second signal line 110_s2, a portion of a line of the first flexible board 110_fb1, the second board line 121_s1 (or the second signal line 121_se or the fourth board line 121_s2), a portion of a line of the second flexible board 110_fb2, the sixth board line 130_s2, the sixth electronic component 130_pe6, and the third signal line 130_sg (e.g., a signal line disposed between the third aggregator circuit 130_ag and the sixth electronic component 130_pe6), and may be supplied to the first to fifth electronic components 130_pe1, 130_pe2, 130_pe3, 130_pe4, and 130_pe5 through the third aggregator circuit 130_ag.

According to an embodiment, the first flexible board 100_fb1 may be separated into a plurality of flexible boards. For example, the first flexible board 100_fb1 may include a first flexible board part that connects the first board line 110_s1 and the third board line 121_s1, a second flexible board part that connects the first circuit line 110_se and the second circuit line 121_se, and a third flexible board part that connects the second board line 110_s2 and the fourth board line 121_s2. Alternatively, the first flexible board 100_fb1 may include a first flexible board part that is connected to an output part of the first aggregator circuit 110_ag, and a second flexible board part that is connected to the first board line 110_s1 and the second board line 110_s2. The distinguishing of flexible board parts may also be applied to the second flexible board 100_fb2, and may also be applied to the flexible board 100_fb described in FIG. 4 above. For example, at least one of the flexible board 100_fb and the second flexible board 100_fb2 may be divided into a plurality of flexible board parts.

The third aggregator circuit 130_ag may be accommodated in the third housing 130 (or accommodated in the third housing 130 in a state of being disposed on the third printed circuit board 130_p). The third aggregator circuit 130_ag may have the same or similar configuration as the second aggregator circuit 120_ag described in the preceding figures. Correspondingly, a description of the third aggregator circuit 130_ag may be replaced with or supplemented with at least a part of the description of the second aggregator circuit 120_ag described above. According to an embodiment, the third aggregator circuit 130_ag may include K third ports that are connected to the second flexible board 100_fb2, and L fourth ports (L is a natural number that is greater than K) that are connected to the plurality of electronic components 130_pe1, 130_pe2, 130_pe3, 130_pe4, 130_pe5, and 130_pe6.

The first flexible board 100_fb1 may be disposed to electrically connect the first aggregator circuit 110_ag and the second printed circuit board 121_p. In this regard, the first flexible board 100_fb1 may include a first connector 100_co1 that is coupled to a first board connector 110_co disposed on the first printed circuit board 110_p, the second connector 100_co2 that is coupled to the second board connector 121_co1 disposed on the second printed circuit board 121_p, and a flexible body, in which a circuit line that transmits a serialized signal while connecting the first connector 100_co1 and the second connector 100_co2 is disposed (or formed). Lines that are connected to the first board line 110_s1 and the second board line 110_s2 (or lines that are connected to the third board line 121_s1 and the fourth board line 121_s2) may also be disposed in a flexible body area. At least a portion of the first flexible board 100_fb1 may be fixed to the first hinge housing 151 or may be disposed inside the first hinge housing 151.

The second flexible board 100_fb2 may be disposed to electrically connect the third aggregator circuit 130_ag and the second printed circuit board 121_p. In this regard, the second flexible board 100_fb2 may include the fourth connector 100_co4 that is coupled to the fourth board connector 130_co disposed on the third printed circuit board 130_p, the third connector 100_co3 that is coupled to the third board connector 121_co2 disposed on the second printed circuit board 121_p, and a flexible body, in which a circuit line that transmits a serialized signal while connecting the third connector 100_co3 and the fourth connector 100_co4 is disposed (or formed). Lines that are connected to the fifth board line 130_s1 and the sixth board line 130_s2 (or lines that are connected to the third board line 121_s1 and the fourth board line 121_s2) may also be disposed in a flexible body area. At least a portion of the second flexible board 100_fb2 may be fixed to the second hinge housing 152 or may be disposed inside the second hinge housing 152.

As described above, in a structure of the multi-foldable electronic device 1112 according to an embodiment, by serializing ports or lines related to input/output control of the processor 110_ap or the plurality of electronic components 130_pe1, 130_pe2, 130_pe3, 130_pe4, 130_pe5, and 130_pe6, the number of lines disposed on the flexible boards 100_fb1 and 100_fb2 may be reduced, and thus, a more stable operation of the flexible boards may be supported in the structure of the multi-foldable electronic device 1112.

As an example, the foldable electronic device 1112 may include the first flexible board 100_fb1 and the second flexible board 100_fb2 that connect the first printed circuit board 110_p disposed in the first housing 110 and the second printed circuit board 121_p disposed in the second housing 120 (or the third printed circuit board 130_p disposed in the third housing 130), and at least one of the first flexible board 100_fb1 and the second flexible board 100_fb2 may include 78-pin and 60-pin connectors (board-to-board connectors). For example, through a flexible board (e.g., at least one of the first flexible board 100_fb1 and the second flexible board 100_fb2), data and power may be transmitted from the first printed circuit board 110_p having the processor 110_ap to a plurality of electronic components 130_pe1, 130_pe2, 130_pe3, 130_pe4, 130_pe5, and 130_pe6 disposed on the second printed circuit board 121_p (or the third printed circuit board 130_p) (for example, to various peripheral ICs or devices (or electronic components), such as a digitizer, a display (e.g., a liquid crystal display (LCD), an organic light-emitting diode (OLED), or a touch screen panel (TSP)), a camera, power management integrated chips (PMICs), a SIM card, sensors, and a speaker amplifier (SPK AMP). Because the flexible board passes through hinge components (e.g., at least one of a hinge device and a hinge housing) related to folding, the size of the flexible board in design may be limited, even though various signal line and power line designs are required. Furthermore, an issue of internal line cracks of the flexible board may occur due to repetitive hinge operations. In this regard, the foldable electronic device 1112 of the disclosure may provide a structure, in which an aggregator circuit (e.g., an input/output (I/O) aggregator related to signals that are transmitted and received at a low speed less than a first reference speed in relation to speeds of signals transmitted and received through output ports of the processor 110_ap) is respectively applied to the first printed circuit board 110_p and the second printed circuit board 121_p (or the third printed circuit board), so that the number of flexible board lines may be effectively reduced or decreased. The first reference speed may be, for example, in MHz, and the low speed signal may include a signal that is transmitted and received at a speed of MHz or less.

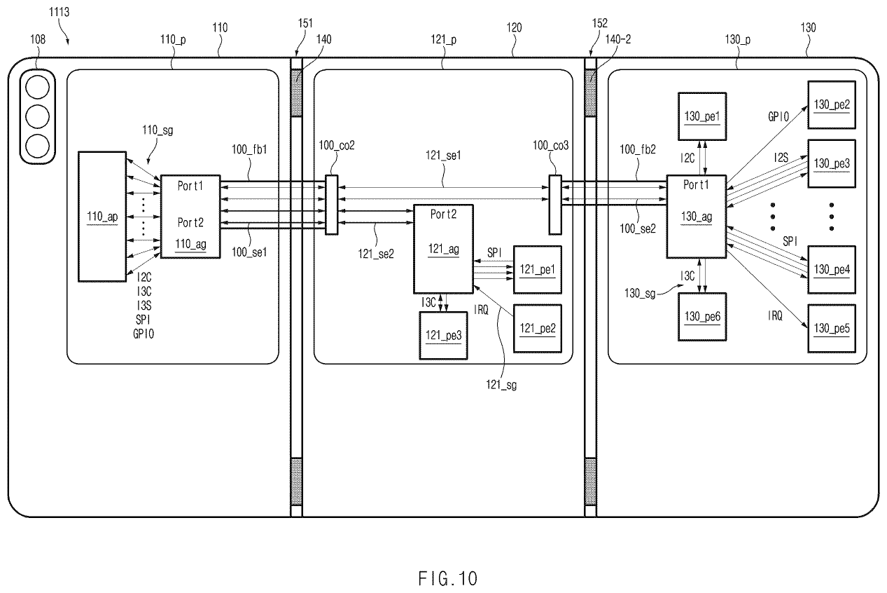

According to an embodiment, about 50 low speed signals output from the processor 110_ap may be input to the first aggregator circuit 110_ag, and then be converted into serial signals through an internal circuit, and signals, such as device information of the connected electronic component and a data type may be transmitted by adding related information to a header of serial packet data. The serial signal (or serialized signal) may be selected depending on a total bandwidth, and may be a signal according to I2C, I3C, or low voltage differential signaling (LVDS) formats. According to various embodiments, a plurality of serial interfaces may be provided to satisfy a bandwidth required in the foldable electronic device 1112 or for a specific interface performance. As an example, serial signal lines disposed on a flexible board that connects aggregator circuits may include a total of six serial lines including two ports of I3C (CLK and DATA) and one port of sound-wire (DATA and CLK), or may include eight serial lines by implementing transmission (TX) and reception (RX) with differential pairs of a clock (CLK) and data (DATA). The data converted into a serial signal may pass through the flexible board and be transmitted to the second printed circuit board 121_p (or the third printed circuit board 130_p), and may be input to an aggregator circuit (e.g., the second aggregator circuit 121_ag or the third aggregator circuit 130_ag illustrated in FIG. 10) of the second printed circuit board 121_p (or the third printed circuit board 130_p). An aggregator circuit (e.g., the second aggregator circuit 121_ag or the third aggregator circuit 130_ag illustrated in FIG. 10) that receives seven to eight transmitted serial signals may convert them into 50 low speed signals that correspond to peripherals (e.g., a plurality of electronic components 130_pe1, 130_pe2, 130_pe3, 130_pe4, 130_pe5, and 130_pe6) connected to output ports. In this way, because 50 low speed signal lines may be reduced to six to eight serial lines by applying the aggregator circuit, a size of the flexible board may be reduced to a certain size or less (e.g., 12 to 14 mm), and additional components (e.g., a 78-pin connector component) may be deleted.

The first aggregator circuit 110_ag and the third aggregator circuit 130_ag may include at least a portion of a structure of the aggregator circuit described above with reference to FIG. 5 or FIG. 6.

Additionally or alternatively, at least some of a separate signal line (e.g., a first board line 110_s1) that is connected to the processor 110_ap described in FIG. 8, a signal line (e.g., a second board line 110_s2) that is connected to the PMIC 110_PM, a third board line 121_s1 and a fourth board line 121_s2 that is disposed on the second printed circuit board 121_p, a fifth board line 130_s1 and a sixth board line 130_s2 that are disposed on the third printed circuit board 130_p, a line part that is disposed in the first flexible board 100_fb1 and connects the first board line 110_s1 and the third board line 121_s1, a line part that is disposed in the first flexible board 100_fb1 and connects the second board line 110_s2 and the fourth board line 121_s2, a line part that is disposed in the second flexible board 100_fb2 and connects the third board line 121_s1 and the fifth board line 130_s1, and a line part that is disposed in the second flexible board 100_fb2 and connects the fourth board line 121_s2 and the sixth board line 130_s2 may be identically or similarly applied to at least some of the above-described electronic devices 100, 1111, and 1112, or at least some of the electronic devices (e.g., 1113, 1114, 1115, 1116, 1117, 1118, and 1119) described below. According to an embodiment, a first transmission speed of a signal transmitted through at least one of a first board line 110_s1, a third board line 121_s1, and a fifth board line 130_s1 may be faster than a second transmission speed of a signal transmitted through at least one of a first circuit line 110_se, a second circuit line 120_se, and a third circuit line 130_se.

According to an embodiment, the first flexible board 100_fb1 and the second flexible board 100_fb2 may include a first line part that is connected to at least one of board lines (e.g., 110_s1, 110_s2, 121_s1, 121_s2, 130_s1, and 130_s2), and a second line part that is connected to at least one of circuit lines 110_se, 120_se, and 130_se, respectively. A first transmission speed of a signal transmitted through the first line part may be faster than a second transmission speed of a signal transmitted through the second line part. Alternatively, a transmission speed of a signal transmitted through the second line part may be slower than a transmission speed of a signal transmitted through the first line part.

According to an embodiment, the foldable electronic device 1112 may include a connection structure that connects the first aggregator circuit 110_ag and the third aggregator circuit 130_ag (or the second aggregator circuit disposed in the third housing 130), and the connection structure may include the first flexible board 100_fb1 (or a first flexible printed circuit board (FPCB) part) that is at least partially coupled to the first hinge device 140 (or a first hinge assembly) or at least partially accommodated in the first hinge housing 151 (or a first hinge housing part), and a second flexible board 110_fb2 (or a second FPCB part) that is at least partially coupled to the third hinge device 140-2 (or a hinge device that connects the second housing 120 and the third housing 130, or a second hinge assembly) or at least partially accommodated in the second hinge housing 152 (or a second hinge housing part), and that is configured to transmit a second control signal (e.g., an output signal of the first aggregator circuit 110_ag).

FIG. 10 is a view illustrating a second example of a disposition form of internal components of a foldable electronic device according to an embodiment of the disclosure.

Similar to the foldable electronic device 1112 illustrated in FIG. 8, other components of the foldable electronic device 1113 (or a modified form of a second-type foldable electronic device, another example of a foldable electronic device that is folded twice or more) illustrated in FIG. 10 are not illustrated or are briefly expressed to represent a connection relationship between a plurality of electronic components according to an embodiment of the disclosure, but the foldable electronic device 1113 of the disclosure is not limited thereto. As an example, in the foldable electronic device 1113 illustrated in FIG. 10, separate board lines (e.g., board lines 110_s1, 110_s2, 121_s1, 121_s2, 130_s1, and 130_s2 of FIG. 8) are not illustrated, but at least some of the board lines 110_s1, 110_s2, 121_s1, 121_s2, and 130_s1, and 130_s2 described in FIG. 8 may be added to the foldable electronic device 1113.

Referring to FIGS. 1 to 10, a foldable electronic device 1113 may include a first housing 110 (or a first housing part), in which the second camera module 108 is disposed, the second housing 120 (or a second housing part), the third housing 130, the first hinge housing 151 (or a first hinge housing part), the second hinge housing 152 (or a second hinge housing part), the first hinge device 140 (or a first hinge assembly), the third hinge device 140-2 (or a second hinge assembly), the first printed circuit board 110_p, the second printed circuit board 121_p, the third printed circuit board 130_p, the first flexible board 100_fb1, and the second flexible board 100_fb2.

The first housing 110, the second housing 120, the third housing 130, the first hinge housing 151, and the second hinge housing 152 may each have the same or similar configuration as the first housing 110, the second housing 120, the third housing 130, the first hinge housing 151, and the second hinge housing 152 described above with reference to FIG. 8. Accordingly, a detailed description of the first housing 110, the second housing 120, the third housing 130, the first hinge housing 151, and the second hinge housing 152 may be replaced with or supplemented with at least a portion of the description of FIG. 8. Additionally or alternatively, the foldable electronic device 1113 may include a flexible display (e.g., the first display 160 of FIG. 3 or a flexible display) as illustrated in FIGS. 1 to 4 above. At least one or more or two portions (e.g., a portion of the flexible display applied to FIG. 10, which is positioned on the first hinge housing 151, and a portion of the flexible display, which is positioned on the second hinge housing 152) may be folded due to folding of the first to third housings 110, 120, and 130.

According to an embodiment, the processor 110_ap (or a processing circuit or at least one processor), the first aggregator circuit 110_ag (or a first aggregator), and the first signal line 110_sg may be disposed on the first printed circuit board 110_p. According to an embodiment, the first printed circuit board 110_p may include a first board connector that is coupled to a connector formed on the first flexible board 100_fb1. According to an embodiment, the first aggregator circuit 110_ag may be provided in a form, in which it is integrated with a portion of the first flexible board 100_fb1. In this case, the first connector 100_co1 of the first flexible board 100_fb1 described above with reference to FIG. 8 may be disposed in the first aggregator circuit 110_ag, and the first printed circuit board 110_p may be formed not to include a separate board connector. Furthermore, when a first connector (e.g., the first connector 100_co1 of FIG. 8) of the first flexible board 100_fb1 is integrated with the first aggregator circuit 110_ag (or is disposed in the first aggregator circuit 110_ag ore removed), a first circuit line (e.g., the first circuit line 110_se of FIG. 8) that connects the first connector 100_co1 and the first board connector 110_co may be omitted.

The processor 110_ap may, for example, perform at least one of processing, transferring, transmitting, receiving, and deleting various signals related to execution of various user functions or a system operation of the foldable electronic device 1113. Such the processor 110_ap may be the same as or at least partially similar to the processor 110_ap described in FIGS. 1 to 9 above. Accordingly, a description of the processor 110_ap in FIG. 10 may be replaced with or supplemented with the description of the processor 110_ap described in FIGS. 1 to 9 above. According to an embodiment, the processor 110_ap may include a multi I/O controller and multi I/O ports, and the first signal line 110_sg may be disposed to connect the multi I/O ports of the processor 110_ap and the first aggregator circuit 110_ag. Additionally or alternatively, the processor 110_ap may generate control signals related to driving of a first plurality of electronic components 121_pe1, 121_pe2, and 121_pe3 (or at least one electronic component) disposed on the second printed circuit board 121_p and a second plurality of electronic components 130_pe1, 130_pe2, 130_pe3, 130_pe4, 130_pe5, and 130_pe6 (or at least one electronic component) disposed on the third printed circuit board 130_p, and may transmit them to the first plurality of electronic components 121_pe1, 121_pe2, and 121_pe3 and the second plurality of electronic components 130_pe1, 130_pe2, 130_pe3, 130_pe4, 130_pe5, and 130_pe6, or may receive signals from at least one of the first and second pluralities of electronic components 121_pe1, 121_pe2, 121_pe3, 130_pe1, 130_pe2, 130_pe3, 130_pe4, 130_pe5, and 130_pe6. According to an embodiment, the processor 110_ap may include a port that is connected to a board line (e.g., the first board line 110_s1 of FIG. 8) for transmitting and receiving signals (e.g., a payload) related to driving the plurality of electronic components 121_pe1, 121_pe2, 121_pe3, 130_pe1, 130_pe2, 130_pe3, 130_pe4, 130_pe5, and 130_pe6.

The first aggregator circuit 110_ag may be accommodated in the first housing 110 (or accommodated in the first housing 110 in a state of being disposed on the first printed circuit board 110_p). According to an embodiment, the first aggregator circuit 110_ag may have the same or similar configuration as the first aggregator circuit 110_ag described above with reference to the drawings (e.g., FIG. 8). Accordingly, a description of the first aggregator circuit 110_ag in FIG. 10 may be replaced with or supplemented with the description of the first aggregator circuit 110_ag in the preceding figures. As an example, the first aggregator circuit 110_ag may include a buffer that may store N signals transmitted from the processor 110_ap, converters (or a microcontroller or input/output converters) that may convert the received signals, a parallel-to-serial converter that may serialize the N signals into M signals (M is a natural number, M<N), and a serial-to-parallel converter that may parallelize the received signals. The first aggregator circuit 110_ag may include a plurality of port groups. For example, the first aggregator circuit 110_ag may include a first port (port 1) that may transmit and receive serialized signals to and from the plurality of second electronic components 130_pe1, 130_pe2, 130_pe3, 130_pe4, 130_pe5, and 130_pe6 disposed on the third printed circuit board 130_p, and a second port (port 2) that may transmit and receive serialized signals to and from the plurality of first electronic components 121_pe1, 121_pe2, and 121_pe3 disposed on the second printed circuit board 121_p.

According to an embodiment, the first aggregator circuit 110_ag may be designed such that a serial interface output port supports multiple ports (e.g., port1 and port2). Multiple ports (port 1 and port 2) of the first aggregator circuit 110_ag may be physically separated for each serial signal to be transmitted, or an output direction of multi I/O inputs (e.g., port1 or port2) may be determined through software register settings. As described above, the first aggregator circuit 110_ag may support a plurality of aggregator circuits 121_ag and 130_ag by using multiple ports.

According to an embodiment, the first flexible board 100_fb1 may be configured to connect the first printed circuit board 110_p and the second printed circuit board 121_p. As an example, one side of the first flexible board 100_fb1 may be electrically connected to input/output ports of the first aggregator circuit 110_ag, and the other side of the first flexible board 100_fb1 may include a connector (e.g., a connector 100_co2) that is coupled to a second board connector formed on the second printed circuit board 121_p. The first flexible board 100_fb1 may include a first flexible board line 100_se1 that is connected to a first port (port 1) and a second port (port 2) of the first aggregator circuit 110_ag described above. The first flexible board line 100_se1 may include at least one signal line for transmitting a serialized signal through the first port (port 1) and at least one signal line for transmitting a serialized signal through the second port (port 2).

According to an embodiment, the second printed circuit board 121_p may be disposed on one surface of the second housing 120. The second printed circuit board 121_p may include a second board connector (e.g., the second board connector 121_co1 of FIG. 9) (or a first board connector of the second printed circuit board 121_p) that is connected to the second connector 100_co2 formed on the first flexible board 100_fb1, and a third board connector (e.g., the third board connector 121_co2 of FIG. 9) (or a second board connector of the second printed circuit board 121_p) that is connected to the third connector 100_co3 formed on the second flexible board 100_fb2. The second printed circuit board 121_p may include a (2-1)-th circuit line 121_se1 (or a first circuit line of the second printed circuit board 121_p) that connects at least one of a second aggregator circuit 121_ag and the plurality of first electronic components 121_pe1, 121_pe2, and 121_pe3, the second connector 100_co2 (or a first board connector of the second printed circuit board 121_p that is connected to the second connector 100_co2) of the first flexible board 100_fb1, and the third connector 100_co3 (or a second board connector of the second printed circuit board 121_p that is connected to the third connector 100_co3) of the second flexible board 100_fb2, and a (2-2)-th circuit line 121_se2 (or a second circuit line of the second printed circuit board 121_p) that connects the second connector 100_co2 (or the first board connector of the second printed circuit board 121_p that is connected to the second connector 100_co2) of the first flexible board 100_fb1 and the second aggregator circuit 121_ag. The (2-1)-th circuit line 121_se1 and the (2-2)-th circuit line 121_se2 may be formed on at least one layer, among a plurality of layers of the second printed circuit board 121_p. The (2-2)-th circuit line 121_se2 may connect a second port (port 2) of the second aggregator circuit 121_ag and a portion of the first flexible board 100_fb1. The (2-1)-th circuit line 121_se1 and the (2-2)-th circuit line 121_se2 may be used for transmitting and receiving serialized signals. The second printed circuit board 121_p may be accommodated in the second housing 120 (or a second housing part), and may include parts (e.g., the second board connector 121_co1 and the third board connector 121_co2) that are connected to a connector (e.g., the second connector 100_co2) that is disposed at a third end that is opposite to a first end of the first flexible board 100_fb1, and a connector (e.g., the third connector 100_co3) that is disposed at a fourth end that is opposite to a second end of the second flexible board 100_fb2.

The second aggregator circuit 121_ag may be connected to the plurality of first electronic components 121_pe1, 121_pe2, and 121_pe3 through a second signal line 121_sg. As an example, the plurality of first electronic components 121_pe1, 121_pe2, and 121_pe3 may include the first electronic component 121_pe1 that is connected to the second aggregator circuit 121_ag in an SPI scheme, the second electronic component 121_pe2 that is connected to the second aggregator circuit 121_ag in an IRQ scheme, and the third electronic component 121_pe3 that is connected to the second aggregator circuit 121_ag in an I3C scheme. At least one of the plurality of first electronic components 121_pe1, 121_pe2, and 121_pe3 may be disposed on the second printed circuit board 121_p or may be disposed in the second housing 120. The second aggregator circuit 121_ag may be accommodated in the second housing 120 (or a second housing part), and may be configured to receive at least a portion of a second control signal transmitted by the first aggregator circuit 110_ag through a fifth number of ports, and convert the at least portion of the second control signal into a fourth control signal that may be output through a sixth number of ports that is greater than the fifth number of ports. The second aggregator circuit 121_ag may be electrically connected to at least one component (or electronic component) accommodated in the second housing 120, and may be configured to transmit the fourth control signal. The at least one component may include a sensor module, a PMIC, an audio module, a display control circuit, or a touch control module.

According to an embodiment, the second flexible board 100_fb2 may connect the second printed circuit board 121_p and the third printed circuit board 130_p. As an example, the second flexible board 100_fb2 may include the third connector 100_co3 that is coupled to a second board connector of the second printed circuit board 121_p. The second flexible board 100_fb2 may include an additional connector that may be connected to the third printed circuit board 130_p. As an example, when one side of the second flexible board 100_fb2 is integrated with the third aggregator circuit 130_ag (or is absorbed into a portion of the third aggregator circuit 130_ag), the one side of the second flexible board 100_fb2 may be directly connected to the third aggregator circuit 130_ag without an additional connector. The second flexible board 100_fb2 may include a second flexible board line 100_se2 that connects the third connector 100_co3 and the third aggregator circuit 130_ag. The number of lines of the second flexible board line 100_se2 may be smaller than the number of lines of the first flexible board line 100_se1. As an example, the number of lines that transmit and receive serialized signals, among the second flexible board lines 100_se2, may be half of the number of lines that transmit and receive serialized signals among the first flexible board lines 100_se1.

According to an embodiment, the third printed circuit board 130_p that is disposed in the third housing 130 may include the third aggregator circuit 130_ag, the plurality of second electronic components 130_pe1, 130_pe2, 130_pe3, 130_pe4, 130_pe5, and 130_pe6, and the third signal line 130_sg. Such the third printed circuit board 130_p may include a configuration that is the same as or similar to the third printed circuit board 130_p described above with reference to FIG. 8. Accordingly, a detailed description of the third printed circuit board 130_p may be replaced with or supplemented with at least a part of the description of the third printed circuit board 130_p described with reference to FIG. 8.

According to an embodiment, at least one of the plurality of first electronic components 121_pe1, 121_pe2, and 121_pe3 or the plurality of second electronic components 130_pe1, 130_pe2, 130_pe3, 130_pe4, 130_pe5, and 130_pe6 may include at least one of a digitizer, a sensor module, a power management IC (PMIC), an audio module, a display (or a display control circuit), a touch panel (or a touch control module), a camera, a sub power management IC (PMIC), a speaker amplifier (speaker) (AMP), a SIM card (or a SIM socket), or sensors. The plurality of second electronic components 130_pe1, 130_pe2, 130_pe3, 130_pe4, 130_pe5, and 130_pe6 may include at least some of the plurality of electronic components (e.g., the seventh to twelfth electronic components 130_pe1, 130_pe2, 130_pe3, 130_pe4, 130_pe5, and 130_pe6) described above with reference to FIG. 8.

The third aggregator circuit 130_ag may include a configuration that is the same as or similar to the third aggregator circuit 130_ag described above with reference to FIG. 8. Accordingly, a detailed description of the third aggregator circuit 130_ag may be replaced with or supplemented with at least a part of the description of the third aggregator circuit 130_ag described above with reference to FIG. 8. According to an embodiment, the third aggregator circuit 130_ag may include K third ports that are connected to the second flexible board 100_fb2, and L fourth ports (L is a natural number that is greater than K) that are connected to the plurality of second electronic components 130_pe1, 130_pe2, 130_pe3, 130_pe4, 130_pe5, and 130_pe6.

The second aggregator circuit 121_ag and the third aggregator circuit 130_ag may include at least a portion of a structure of the aggregator circuit described above with reference to FIG. 5 or FIG. 6. The first aggregator circuit 110_ag may include at least a portion of a structure of the aggregator circuit described above with reference to FIG. 5 or FIG. 6, except that the ports are distinguished.

As described above, the foldable electronic device 1113 according to an embodiment may, through the second aggregator circuit 121_ag that is disposed in the second housing 120, support transmission and reception (or transmission or reception) of a control signal between at least some of the plurality of first electronic components 121_pe1, 121_pe2, and 121_pe3 that are disposed in the second housing 120 and the processor 110_ap through a simplified line in relation to transmission and reception of the control signal, and may also support transmission and reception (or transmission or reception) of a control signal between at least some of the plurality of second electronic components 130_pe1, 130_pe2, 130_pe3, 130_pe4, 130_pe5, and 130_pe6 that are disposed in the third housing 130 and the processor 110_ap through a simplified line in relation to transmission and reception of the control signal.

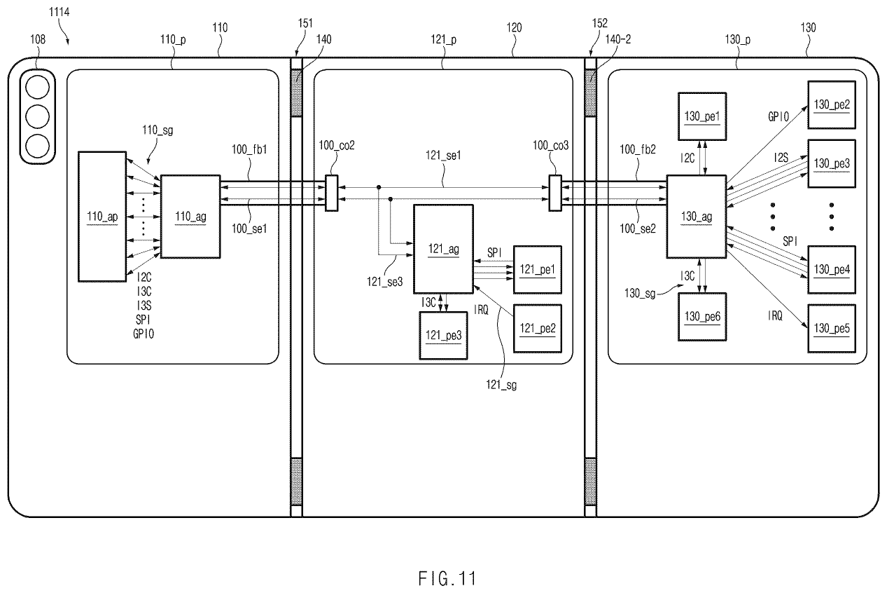

FIG. 11 is a view illustrating a third example of a disposition form of internal components of a foldable electronic device according to an embodiment of the disclosure.

Prior to a description, except for the first flexible board 100_fb1 and lines of the second printed circuit board 121_p, the remaining configurations of the foldable electronic device 1114 illustrated in FIG. 11 may include the same or similar configurations as those of the foldable electronic device 1113 described above with reference to FIG. 10. For example, a first housing 110, the second housing 120, the third housing 130, the first hinge housing 151, the second hinge housing 152, the first hinge device 140, the third hinge device 140-2, the first printed circuit board 110_p, and the third printed circuit board 130_p of the foldable electronic device 1114 may have the same or similar configurations as those of the first housing 110, the second housing 120, the third housing 130, the first hinge housing 151, the second hinge housing 152, the first hinge device 140, the third hinge device 140-2, the first printed circuit board 110_p, and the third printed circuit board 130_p of the foldable electronic device 1113 described above with reference to FIG. 10. Accordingly, a description of at least some of the first housing 110, the second housing 120, the third housing 130, the first hinge housing 151, the second hinge housing 152, the first hinge device 140, the third hinge device 140-2, the first printed circuit board 110_p, and the third printed circuit board 130_p of the foldable electronic device 1114 may be replaced with or supplemented with at least a part of the description described above with reference to FIG. 10. As an example, the foldable electronic device 1114 may include a first housing 110, in which the second camera module 108 is disposed, the first printed circuit board 110_p that is disposed in the first housing 110, the processor 110_ap that is positioned on the first printed circuit board 110_p, the first aggregator circuit 110_ag, and the first signal line 110_sg. As an example, the foldable electronic device 1114 may include the third housing 130, the third printed circuit board 130_p that is disposed in the third housing 130, the third aggregator circuit 130_ag that is disposed on the third printed circuit board 130_p, the plurality of second electronic components 130_pe1, 130_pe2, 130_pe3, 130_pe4, 130_pe5, and 130_pe6, and the third signal line 130_sg. A detailed description of the configurations disposed in the first housing 110 and the configurations disposed in the third housing 130 described above may be replaced with or supplemented with at least a part of the description of the configurations related to the first housing 110 and the configurations related to the third housing 130 described with reference to FIG. 10.

Referring to FIGS. 1 to 11, the foldable electronic device 1114 may include the first flexible board 100_fb1 that connects the first aggregator circuit 110_ag (or the first printed circuit board 110_p) disposed in the first housing 110 and a second aggregator circuit 121_ag (or the second printed circuit board 121_p) disposed in the second housing 120, the second printed circuit board 121_p, and the second flexible board 100_fb2 that connects the second printed circuit board 121_p and the third aggregator circuit 130_ag (or the third printed circuit board 130_p) disposed in the third housing 130.

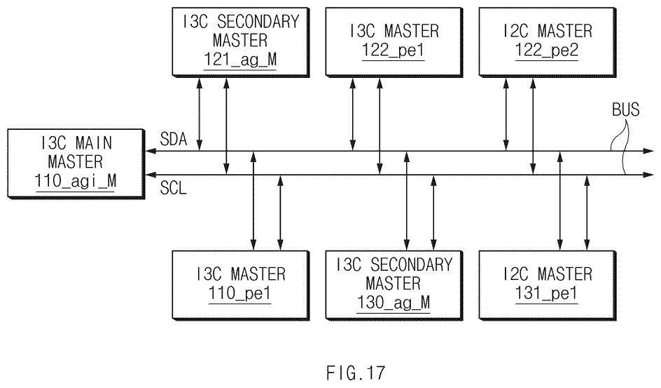

According to an embodiment, the foldable electronic device 1114 of FIG. 11 may support two or more aggregator circuits with a single output port. The foldable electronic device 1114 may have a smaller number of signal lines of a serial interface than the foldable electronic device 1113 described with reference to FIG. 10. The foldable electronic device 1114 of FIG. 11 may be a structure, in which a plurality of secondaries (e.g., a second aggregator circuit 121_ag and the third aggregator circuit 130_ag) are connected to one main (e.g., the first aggregator circuit 110_ag), and the aggregator circuits 110_ag, 121_ag, and 130_ag may transmit and receive serialized signals in a main-secondary scheme based on I3C described with reference to FIG. 17. For example, the aggregator circuits 110_ag, 121_ag, and 130_ag may assign bit values for selecting the aggregator circuits and bit values for distinguishing electronic components to a serial data header or address, and then transmit them.

According to an embodiment, the first flexible board 100_fb1 may be configured to connect the first printed circuit board 110_p and the second printed circuit board 121_p. As an example, when the first flexible board 100_fb1 has a connector connection structure, the first flexible board 100_fb1 may include a first connector (e.g., a first connector 100_co1 of FIG. 9), to which input/output ports of the first aggregator circuit 110_ag are connected, and that is electrically connected to a first board connector (e.g., a first board connector 110_co of FIG. 9) disposed on the first printed circuit board 110_p, and a second connector (e.g., a connector 100_co2 of FIG. 8) that is coupled to a second board connector (e.g., the second board connector 121_co1 of FIG. 9) formed on the second printed circuit board 121_p. Alternatively, a first connector of the first flexible board 100_fb1 may be integrated with the first aggregator circuit 110_ag. The first flexible board 100_fb1 may include a first flexible board line 100_se1 that transmits serialized signals output through the first aggregator circuit 110_ag. First control signals for input/output control of the plurality of first electronic components 121_pe1, 121_pe2, and 121_pe3, and second control signals for input/output control of the plurality of second electronic components 130_pe1, 130_pe2, 130_pe3, 130_pe4, 130_pe5, and 130_pe6 may be serialized in the first flexible board line 100_se1 to be transmitted. Control signals (e.g., first control signals for input/output control of the plurality of first electronic components 121_pe1, 121_pe2, and 121_pe3, and second control signals for input/output control of the plurality of second electronic components 130_pe1, 130_pe2, 130_pe3, 130_pe4, 130_pe5, and 130_pe6) transmitted through the first flexible board line 100_se1 may be distinguished through a header value.

According to an embodiment, the second printed circuit board 121_p may include a second board connector (e.g., the second board connector 121_co1 of FIG. 9) (or a first board connector of the second printed circuit board 121_p) that is connected to the second connector 100_co2 formed on the first flexible board 100_fb1, and a third board connector (e.g., the third board connector 121_co2 of FIG. 9) (or a second board connector of the second printed circuit board 121_p) that is connected to the third connector 100_co3 formed on the second flexible board 100_fb2. The second printed circuit board 121_p may include the (2-1)-th circuit line 121_se1 (or a first circuit line of the second printed circuit board 121_p) that connects at least one of a second aggregator circuit 121_ag and the plurality of first electronic components 121_pe1, 121_pe2, and 121_pe3, the second connector 100_co2 (or a first board connector of the second printed circuit board 121_p that is connected to the second connector 100_co2) of the first flexible board 100_fb1, and the third connector 100_co3 (or a second board connector of the second printed circuit board 121_p that is connected to the third connector 100_co3) of the second flexible board 100_fb2, and a (2-3)-th circuit line 121_se3 (or a third circuit line of the second printed circuit board 121_p) that connects the first board connector (e.g., the second board connector 121_co1 of FIG. 9) of the second printed circuit board 121_p or one point of the (2-1)-th circuit line 121_se1 and the second aggregator circuit 121_ag. According to an embodiment, a (2-3)-th circuit line 121_se3 may receive serialized signals that are transmitted through the (2-1)-th circuit line 121_se1 that connects a first board connector (e.g., the second board connector 121_co1 of FIG. 9) of the second printed circuit board 121_p and a second board connector (e.g., the third board connector 121_co2 of FIG. 9) of the second printed circuit board 121_p, and transmit them to the second aggregator circuit 121_ag.

The second aggregator circuit 121_ag may parallelize serialized signals that are received through a (2-3)-th circuit line 121_se3, extract first control signals related to the plurality of first electronic components 121_pe1, 121_pe2, and 121_pe3 by identifying a header value, and transmit the extracted first control signals to the plurality of first electronic components 121_pe1, 121_pe2, and 121_pe3.

The second flexible board 100_fb2 may be electrically connected to the (2-1)-th circuit line 121_se1, and may transmit serialized signals that are transmitted through the (2-1)-th circuit line 121_se1 to the third aggregator circuit 130_ag. Serialized signals transmitted through the second flexible board 100_fb2 may include first signals (e.g., first control signals for input/output control) related to an operation of the plurality of first electronic components 121_pe1, 121_pe2, and 121_pe3, and second signals (e.g., second control signals for input/output control) related to an operation of the plurality of second electronic components 130_pe1, 130_pe2, 130_pe3, 130_pe4, 130_pe5, and 130_pe6. The number of lines of a second flexible board line 100_se2 disposed on the second flexible board 100_fb2 may be the same as the number of lines of a first flexible board line 100_se1 disposed on the first flexible board 100_fb1.

The third aggregator circuit 130_ag may receive signals (e.g., signals related to an operation of the plurality of first electronic components 121_pe1, 121_pe2, and 121_pe3, and signals related to an operation of the plurality of second electronic components 130_pe1, 130_pe2, 130_pe3, 130_pe4, 130_pe5, and 130_pe6) received through the second flexible board 100_fb2. The third aggregator circuit 130_ag may extract signals related to an operation of the plurality of second electronic components 130_pe1, 130_pe2, 130_pe3, 130_pe4, 130_pe5, and 130_pe6 from received signals through identification of a header value, and may transmit the extracted signals to the plurality of second electronic components 130_pe1, 130_pe2, 130_pe3, 130_pe4, 130_pe5, and 130_pe6.

According to an embodiment, the second aggregator circuit 121_ag and the third aggregator circuit 130_ag may distinguish transmission periods in a process of transmitting signals to the processor 110_ap, and may control transmission of signals related to an operation of the plurality of electronic components. For example, the second aggregator circuit 121_ag may be configured to transmit signals generated in an operation of the plurality of first electronic components 121_pe1, 121_pe2, and 121_pe3 to the first aggregator circuit 110_ag during a prior first half transmission period of a first transmission period, and the third aggregator circuit 130_ag may be configured to transmit signals generated in an operation of the plurality of second electronic components 130_pe1, 130_pe2, 130_pe3, 130_pe4, 130_pe5, and 130_pe6 to the first aggregator circuit 110_ag during a later second half transmission period of the first transmission period. As described above, by distinguishing transmission periods, collision of a signal transmitted to the processor 110_ap by the plurality of first electronic components 121_pe1, 121_pe2, and 121_pe3 and a signal transmitted to the processor 110_ap by the plurality of second electronic components 130_pe1, 130_pe2, 130_pe3, 130_pe4, 130_pe5, and 130_pe6 may be prevented. According to an embodiment, designated transmission sections may be allocated to the second aggregator circuit 121_ag and the third aggregator circuit 130_ag by the processor 110_ap, and they may transmit signals generated in an operation of the plurality of electronic components to the processor 110_ap during the allocated sections.

The first aggregator circuit 110_ag, the second aggregator circuit 121_ag, and the third aggregator circuit 130_ag may include at least a portion of a structure of the aggregator circuit described above with reference to FIG. 5 or FIG. 6.

As described above, the foldable electronic device 1114 according to an embodiment may be configured to share the (2-1)-th circuit line 121_se1 that transmits serialized signals, and may configure the number of lines of the first flexible board 100_fb1 that transmits serialized signals and the number of lines of the second flexible board 100_fb2 to be the same so that lifetimes and quality control of the flexible boards 100_fb1 and 100_fb2 may be equalized.

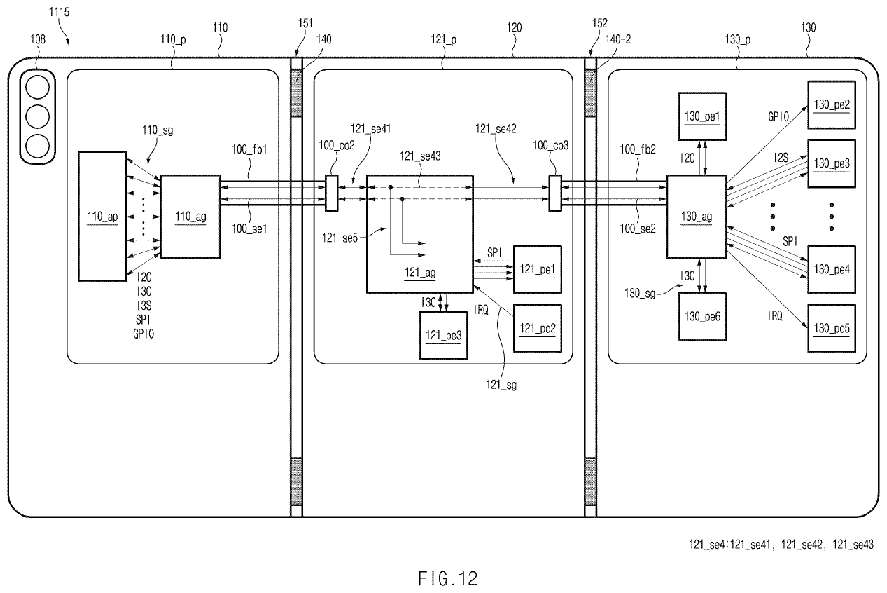

FIG. 12 is a view illustrating a fourth example of a disposition form of internal components of a foldable electronic device according to an embodiment of the disclosure.

Prior to a description, except for a structure of the second printed circuit board 121_p, the remaining configurations of the foldable electronic device 1115 illustrated in FIG. 12 may include the same or similar configurations as those of the foldable electronic device 1114 described above with reference to FIG. 11. For example, a first housing 110, the second housing 120, the third housing 130, the first hinge housing 151, the second hinge housing 152, the first hinge device 140, the third hinge device 140-2, the first printed circuit board 110_p, and the third printed circuit board 130_p of the foldable electronic device 1115 may have the same or similar configurations as those of the first housing 110, the second housing 120, the third housing 130, the first hinge housing 151, the second hinge housing 152, the first hinge device 140, the third hinge device 140-2, the first printed circuit board 110_p, and the third printed circuit board 130_p of the foldable electronic device 1114 described above with reference to FIG. 11. According to an embodiment, a description of at least some of the first housing 110, the second housing 120, the third housing 130, the first hinge housing 151, the second hinge housing 152, the first hinge device 140, the third hinge device 140-2, the first printed circuit board 110_p, and the third printed circuit board 130_p of the foldable electronic device 1115 may be replaced with or supplemented with at least a part of the description described above with reference to FIG. 10 or FIG. 11.

As an example, the foldable electronic device 1115 may include a first housing 110, in which the second camera module 108 is disposed, the first printed circuit board 110_p that is disposed in the first housing 110, the processor 110_ap that is positioned on the first printed circuit board 110_p, and the first aggregator circuit 110_ag that is connected to the processor 110_ap through the first signal line 110_sg. As an example, the foldable electronic device 1115 may include the third housing 130, the third printed circuit board 130_p that is disposed in the third housing 130, the third aggregator circuit 130_ag that is disposed on the third printed circuit board 130_p, and the plurality of second electronic components 130_pe1, 130_pe2, 130_pe3, 130_pe4, 130_pe5, and 130_pe6 that are connected to the third aggregator circuit 130_ag through the third signal line 130_sg. A detailed description of the configurations disposed in the first housing 110 and the configurations disposed in the third housing 130 described above may be replaced with or supplemented with at least a part of the description of the configurations related to the first housing 110 and the configurations related to the third housing 130 described with reference to FIG. 11 (or the description of the configurations related to the first housing 110 and the configurations related to the third housing 130 described with reference to FIG. 10).

Referring to FIGS. 1 to 12, the foldable electronic device 1115 may include the first flexible board 100_fb1 that connects the first aggregator circuit 110_ag (or the first printed circuit board 110_p) disposed in the first housing 110 and a second aggregator circuit 121_ag (or the second printed circuit board 121_p) disposed in the second housing 120, the second printed circuit board 121_p, and the second flexible board 100_fb2 that connects the second printed circuit board 121_p and the third aggregator circuit 130_ag (or the third printed circuit board 130_p) disposed in the third housing 130. According to an embodiment, the first flexible board 100_fb1 and the second flexible board 100_fb2 may include the same or similar configurations as those of the first flexible board 100_fb1 and the second flexible board 100_fb2 described above with reference to FIG. 11, respectively. Accordingly, a description of the first flexible board 100_fb1 and the second flexible board 100_fb2 may be replaced with or supplemented with at least a part of the description of the first flexible board 100_fb1 described above with reference to FIG. 11.

According to an embodiment, the second printed circuit board 121_p may include a second board connector (e.g., the second board connector 121_co1 of FIG. 9) (or a first board connector of the second printed circuit board 121_p) that is connected to the second connector 100_co2 formed on the first flexible board 100_fb1, and a third board connector (e.g., the third board connector 121_co2 of FIG. 9) (or a second board connector of the second printed circuit board 121_p) that is connected to the third connector 100_co3 formed on the second flexible board 100_fb2. The second printed circuit board 121_p may include a (2-4)-th circuit line 121_se4 that is disposed to pass through an interior of the second aggregator circuit 121_ag while connecting the second connector 100_co2 (or a first board connector of the second printed circuit board 121_p that is connected to the second connector 100_co2) of the first flexible board 100_fb1 and the third connector 100_co3 (or a second board connector of the second printed circuit board 121_p that is connected to the third connector 100_co3) of the second flexible board 100_fb2. The (2-4)-th circuit line 121_se4 may include a first line part 121_se41 that is disposed to connect the second connector 100_co2 (or the second board connector 121_co1 of FIG. 9) and one side of the second aggregator circuit 121_ag, a second line part 121_se42 that is disposed to connect one side of the second aggregator circuit 121_ag and the third connector 100_co3 (or the third board connector 121_co2 of FIG. 9), and a third line part 121_se43 that is disposed in an interior of the second aggregator circuit 121_ag. At least a portion of the (2-4)-th circuit line 121_se4 described above may be disposed to pass through an interior of the second aggregator circuit 121_ag in a bypass form.

The second aggregator circuit 121_ag may include a (2-5)-th circuit line 121_se5 (or an internal line of the aggregator circuit, or an internal circuit line) that is electrically connected to the (2-4)-th circuit line 121_se4 (e.g., a third line part 121_se43 of the (2-4)-th circuit line 121_se4). The (2-5)-th circuit line 121_se5 may electrically connect the bypass circuit line (e.g., the (2-4)-th circuit line 121_se4 (or a third line part 121_se43 of the (2-4)-th circuit line 121_se4)) and a signal converter (e.g., at least one of a serial-to-parallel converter and a parallel-to-serial converter) that is disposed in the second aggregator circuit 121_ag. The second aggregator circuit 121_ag may extract a signal (e.g., a control signal or an input/output control signal) related to the plurality of first electronic components 121_pe1, 121_pe2, and 121_pe3 by identifying a header of a signal (or a signal transmitted through the (2-4)-th circuit line 121_se4) transmitted through the (2-5)-th circuit line 121_se5, and transmit the extracted signal to at least one of the plurality of first electronic components 121_pe1, 121_pe2, and 121_pe3.

According to an embodiment, the second aggregator circuit 121_ag may collect signals transmitted to the processor 110_ap by the plurality of first electronic components 121_pe1, 121_pe2, and 121_pe3, serialize the collected signals, and transmit them to the processor 110_ap through the (2-5)-th circuit line 121_se5, the (2-4)-th circuit line 121_se4, the first flexible board 100_fb1, the first aggregator circuit 110_ag, and the first signal line 110_sg. The third aggregator circuit 130_ag may collect signals transmitted to the processor 110_ap by the plurality of second electronic components 130_pe1, 130_pe2, 130_pe3, 130_pe4, 130_pe5, and 130_pe6 through at least a portion of the third signal line 130_sg, serialize the collected signals, and transmit them to the processor 110_ap through the second flexible board 100_fb2, the (2-4)-th circuit line 121_se4, the first flexible board 100_fb1, the first aggregator circuit 110_ag, and the first signal line 110_sg.

As an example, in relation to preventing collisions between signals transmitted to the processor 110_ap by the plurality of first electronic components 121_pe1, 121_pe2, and 121_pe3 and the plurality of second electronic components 130_pe1, 130_pe2, 130_pe3, 130_pe4, 130_pe5, and 130_pe6, separate CS (chip select) pins may be allocated to aggregator circuits (e.g., the second and third aggregator circuits 121_ag and 130_ag), and remote aggregators (e.g., the second and third aggregator circuits 121_ag and 130_ag) that occupy a serial interface may be set to a state of the allocated pins. As an example, when the processor 110_ap sets a CS value to 0, the second aggregator circuit 121_ag may perform communication with the first aggregator circuit 110_ag, and when the processor 110_ap sets the CS value to 1, the third aggregator circuit 130_ag may perform communication with the first aggregator circuit 110_ag.

According to an embodiment, a synchronization (sync) pin may be disposed between the second aggregator circuit 121_ag and the third aggregator circuit 130_ag. The second aggregator circuit 121_ag and the third aggregator circuit 130_ag may determine a main (or primary) and a secondary, and may determine a communication order based on them and perform communication with the first aggregator circuit 110_ag.

According to an embodiment, interiors of the aggregator circuits 121_ag and 130_ag may be configured to monitor a state of a serial interface. The aggregator circuits 121_ag and 130_ag may monitor a signal line (e.g., a bus) connected to the first aggregator circuit 110_ag, and may hold data transmission to the first aggregator circuit 110_ag when the signal line is used, and may perform data transmission to the first aggregator circuit 110_ag when the signal line is not used.

According to an embodiment, the second aggregator circuit 121_ag and the third aggregator circuit 130_ag may transmit signals by using parts of a preset transmission signal delivery period, respectively. For example, in relation to signal transmission of the aggregator circuits, the second aggregator circuit 121_ag (or the third aggregator circuit 130_ag) may be configured to transmit a signal to the processor 110_ap during at least a partial section of a prior half period of a preset first transmission period, and the third aggregator circuit 130_ag (or the second aggregator circuit 121_ag) may be configured to transmit a signal to the processor 110_ap during at least a partial section of a later half period of the first transmission period. Alternatively, the processor 110_ap may designate a transmission period of the second aggregator circuit 121_ag and a transmission period of the third aggregator circuit 130_ag, respectively, and may transmit signals through a reception line of the second aggregator circuit 121_ag and a reception line of the third aggregator circuit 130_ag. Designated transmission sections may be allocated to the second aggregator circuit 121_ag and the third aggregator circuit 130_ag by the processor 110_ap, and they may transmit signals generated in an operation of the plurality of electronic components to the processor 110_ap during the allocated sections.

The first aggregator circuit 110_ag and the third aggregator circuit 130_ag may include at least a portion of a structure of the aggregator circuit described above with reference to FIG. 5 or FIG. 6. Except for a structure, in which a (2-4)-th circuit line 121_se4 for bypassing and an internal line (e.g., a (2-5)-th circuit line 121_se5) connected to the (2-4)-th circuit line 121_se4 are disposed in an interior of the second aggregator circuit 121_ag, the remaining configurations of the second aggregator circuit 121_ag may include at least a portion of a structure of the aggregator circuit described above with reference to FIG. 5 or FIG. 6.

As described above, in the foldable electronic device 1115 according to an embodiment, a (2-4)-th circuit line 121_se4 may be formed in an interior of the second aggregator circuit 121_ag and signals may be transmitted and received through a (2-5)-th circuit line 121_se5 that is connected to the (2-4)-th circuit line 121_se4, so that the second printed circuit board 121_p that is more compact and less prone to damage may be configured.

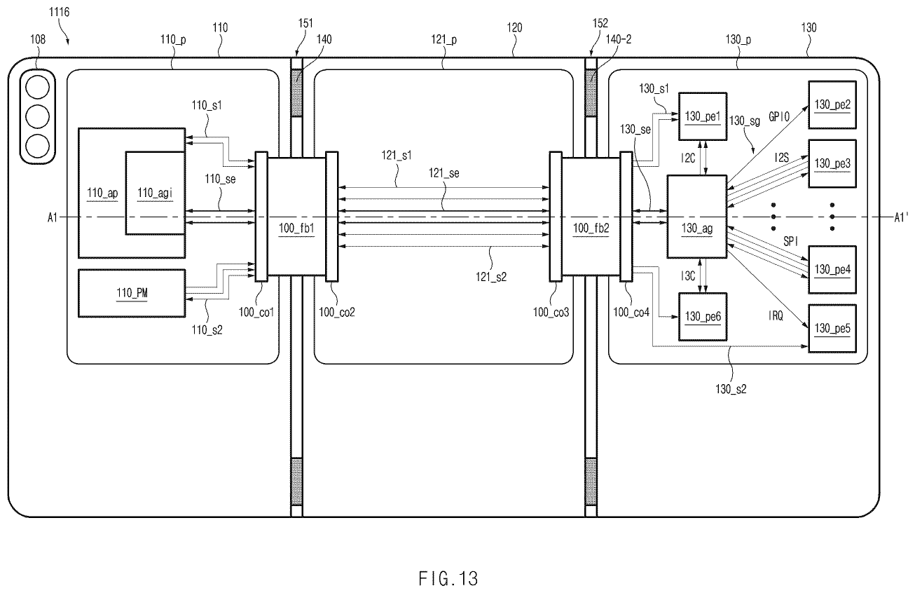

FIG. 13 is a view illustrating a fifth example of a disposition form of internal components of a foldable electronic device according to an embodiment of the disclosure.

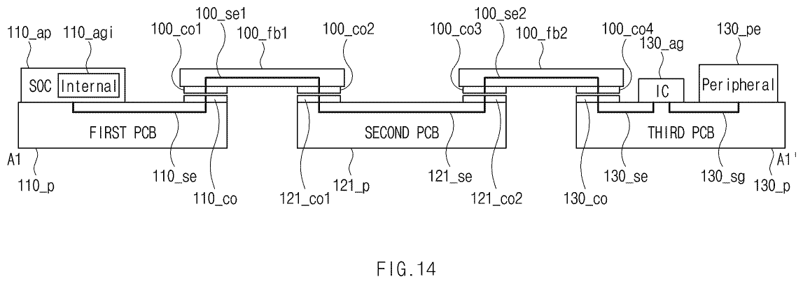

FIG. 14 is a view illustrating at least a portion of a cross section taken along cutting line A1-A1′ of FIG. 13 according to an embodiment of the disclosure.

According to an embodiment, although cutting line A1-A1′ illustrated in FIG. 13 is schematically illustrated in the drawing, it may be disposed to cut specific signal lines in respective components. Furthermore, the electronic component 130_pe illustrated in FIG. 14 indicates a specific electronic component that is located at a position cut by cutting line A1-A1′, and may be any one of a plurality of electronic components 130_pe1, 130_pe2, 130_pe3, 130_pe4, 130_pe5, and 130_pe6 that may be disposed on the third printed circuit board 130_p.

Similar to the foldable electronic device 1112 illustrated in FIG. 8, other components of the foldable electronic device 1116 (or a second-type foldable electronic device, a foldable electronic device that is folded twice or more) illustrated in FIG. 13 are not illustrated or are briefly expressed to represent a connection relationship between a plurality of electronic components according to an embodiment of the disclosure, but the foldable electronic device 1116 of the disclosure is not limited thereto.

Referring to FIGS. 1 to 14, a foldable electronic device 1116 may include a first housing 110 (or a first housing part), in which the second camera module 108 is disposed, the second housing 120 (or a second housing part), the third housing 130 (or a third housing part), the first hinge housing 151 (or a first hinge housing part), the second hinge housing 152 (or a second hinge housing part), the first hinge device 140 (or a first hinge assembly), the third hinge device 140-2 (or a second hinge assembly), the first printed circuit board 110_p, the second printed circuit board 121_p, the third printed circuit board 130_p, the first flexible board 100_fb1, and the second flexible board 100_fb2. Among the components of the foldable electronic device 1116, a first housing 110, the second housing 120, the third housing 130, the first hinge housing 151, the second hinge housing 152, the first hinge device 140, and the third hinge device 140-2 may have the same or similar configurations as those of the first housing 110, the second housing 120, the third housing 130, the first hinge housing 151, the second hinge housing 152, the first hinge device 140, and the third hinge device 140-2 described above with reference to FIG. 8. Accordingly, a description of the first housing 110, the second housing 120, the third housing 130, the first hinge housing 151, the second hinge housing 152, the first hinge device 140, and the third hinge device 140-2, among the components of the foldable electronic device 1116, may be replaced with or supplemented with at least a part of the description of the configurations described above with reference to FIG. 8 and other drawings. Additionally or alternatively, the foldable electronic device 1118 may include a flexible display (e.g., the first display 160 of FIG. 3 or a flexible display) as illustrated in FIGS. 1 to 4 above.

According to an embodiment, the processor 110_ap (or a processing circuit), in which an aggregator circuit part 110_agi is embedded, a first board line 110_s1, a PMIC 110_PM (or an electronic component (component) of the first housing 110), a first circuit line 110_se, and a second board line 110_s2 may be disposed on the first printed circuit board 110_p. Additionally or alternatively, a first board connector 110_co that is coupled to a first connector 100_co1 of the first flexible board 100_fb1 may be disposed on the first printed circuit board 110_p. The aggregator circuit part 110_agi embedded in the processor 110_ap and the first board connector 110_co may be electrically connected by the first circuit line 110_se. The first circuit line 110_se may be used to transmit and receive a serialized signal.

Meanwhile, in an embodiment of the disclosure, only the processor 110_ap in which an aggregator circuit part 110_agi is embedded, a first board line 110_s1, a PMIC 110_PM, a second board line 110_s2, a first circuit line 110_se, and a first board connector 110_co disposed on the first printed circuit board 110_p are illustrated, but the disclosure is not limited thereto, and various other electronic components may be further disposed.

According to an embodiment, the first board line 110_s1 may be disposed to connect a first part of the processor 110_ap (or a part, in which ports other than the aggregator circuit part 110_agi are disposed) and the first board connector 110_co. The second board line 110_s2 may be disposed to connect the PMIC 110_PM and the first board connector 110_co. The first board line 110_s1 and the second board line 110_s2 may connect the first board connector 110_co and a first part of the processor 110_ap or the PMIC 110_PM not via the aggregator circuit part 110_agi.

The processor 110_ap may, for example, perform at least one of processing, transferring, transmitting, receiving, and deleting various signals related to execution of various user functions or a system operation of the foldable electronic device 1116. The processor 110_ap may be the same as, or at least partially similar to, the processor 110_ap (e.g., the processor 110_ap in which the aggregator circuit part 110_agi is embedded) described above with reference to FIG. 7. Accordingly, the description of the processor 110_ap in FIG. 13 may be replaced with or supplemented with at least a part of the description of the processor 110_ap described above with reference to FIGS. 1 to 7 or the processor described in other drawings.

According to an embodiment, the aggregator circuit part 110_agi may be embedded in the processor 110_ap. A structure of the aggregator circuit part 110_agi may include at least some components of the first aggregator circuit 110_ag described above with reference to FIG. 5 or FIG. 6. Accordingly, the description of the aggregator circuit part 110_agi in FIG. 13 may be replaced with or supplemented with at least a part of the description of the aggregator circuits 110_ag, 121_ag, and 130_ag in the preceding drawings or the description of the first aggregator circuit 110_ag.

While the first flexible board 100_fb1 connects the first printed circuit board 110_p and the second printed circuit board 121_p, at least a portion of the first hinge housing 151 or the first hinge device 140 may be received therein or coupled thereto. The first flexible board 100_fb1 may include the same or a similar configuration as the first flexible board 100_fb1 described above with reference to FIG. 8. According to an embodiment, a detailed description of the first flexible board 100_fb1 may be replaced with or supplemented with at least a part of the description of the first flexible board 100_fb1 described with reference to FIG. 8.

The second flexible board 100_fb2 may be disposed to electrically connect the third aggregator circuit 130_ag and the second printed circuit board 121_p. The second flexible board 100_fb2 may include the same or a similar configuration as the second flexible board 100_fb2 described above with reference to FIG. 8. According to an embodiment, a detailed description of the second flexible board 100_fb2 may be replaced with or supplemented with at least a part of the description of the second flexible board 100_fb2 described with reference to FIG. 8. The second flexible board 100_fb2 may include the fourth connector 100_co4 that is coupled to the fourth board connector 130_co disposed on the third printed circuit board 130_p, the third connector 100_co3 that is coupled to the third board connector 121_co2 disposed on the second printed circuit board 121_p, and a flexible body, in which a circuit line that transmits a serialized signal while connecting the third connector 100_co3 and the fourth connector 100_co4 is disposed (or formed).

According to an embodiment, the second printed circuit board 121_p may be disposed on one surface of the second housing 120. The second printed circuit board 121_p may have the same or a similar configuration as the second printed circuit board 121_p described above with reference to FIG. 8. Accordingly, a detailed description of the second printed circuit board 121_p may be replaced with or supplemented with at least a part of the description of the second printed circuit board 121_p described with reference to FIG. 8. According to an embodiment, the second printed circuit board 121_p may include the second board connector 121_co1 (or a first board connector of the second printed circuit board 121_p) that is connected to the second connector 100_co2 formed on the first flexible board 100_fb1, and the third board connector 121_co2 (or a second board connector of the second printed circuit board 121_p) that is connected to the third connector 100_co3 formed on the second flexible board 100_fb2. The second printed circuit board 121_p may include a second circuit line 121_se that connects a first part of the second board connector 121_co1 and a first part of the third board connector 121_co2, a third board line 121_s1 that connects a second part of the second board connector 121_co1 and a second part of the third board connector 121_co2, and a fourth board line 121_s2 that connects a third part of the second board connector 121_co1 and a third part of the third board connector 121_co2.

According to an embodiment, a plurality of electronic components 130_pe1, 130_pe2, 130_pe3, 130_pe4, 130_pe5, and 130_pe6, the third aggregator circuit 130_ag, the fourth board connector 130_co that is connected to the fourth connector 100_co4 provided at one side of the second flexible board 100_fb2, a third circuit line 130_se, a fifth board line 130_s1, a sixth board line 130_s2, and the third signal line 130_sg may be disposed on the third printed circuit board 130_p. The third printed circuit board 130_p and components included in the third printed circuit board 130_p, for example, the third aggregator circuit 130_ag, board lines 130_s1 and 130_s2, the third signal line 130_sg, and a plurality of electronic components 130_pe1, 130_pe2, 130_pe3, 130_pe4, 130_pe5, and 130_pe6, may have the same or a similar configuration as the third aggregator circuit 130_ag, the board lines 130_s1 and 130_s2, the third signal line 130_sg, and the plurality of electronic components 130_pe1, 130_pe2, 130_pe3, 130_pe4, 130_pe5, and 130_pe6 described above with reference to FIG. 8. Correspondingly, a detailed description of the third aggregator circuit 130_ag, the board lines 130_s1 and 130_s2, the third signal line 130_sg, and the plurality of electronic components 130_pe1, 130_pe2, 130_pe3, 130_pe4, 130_pe5, and 130_pe6 illustrated in FIG. 13 may be replaced with or supplemented with at least a part of the description of the corresponding components described above with reference to FIG. 8. According to an embodiment, the aggregator circuit part 110_agi and the third aggregator circuit 130_ag may include at least a portion of a structure of the aggregator circuit described above with reference to FIG. 5 or FIG. 6.

As described above, in the structure of ~, 110_ap[may embed ~ so that ~ may be removed on ~, whereby ~ may be secured, and thus, ~ may be supported. As described above, in the structure of the multi-foldable electronic device 1116 according to an embodiment, the processor 110_ap may embed an aggregator circuit (e.g., the aggregator circuit part 110_agi) so that the aggregator circuit may be removed on the first printed circuit board 110_p, whereby a space for disposing the aggregator circuit may be secured, and thus, design of a more diverse structure and a compact printed circuit board may be supported.

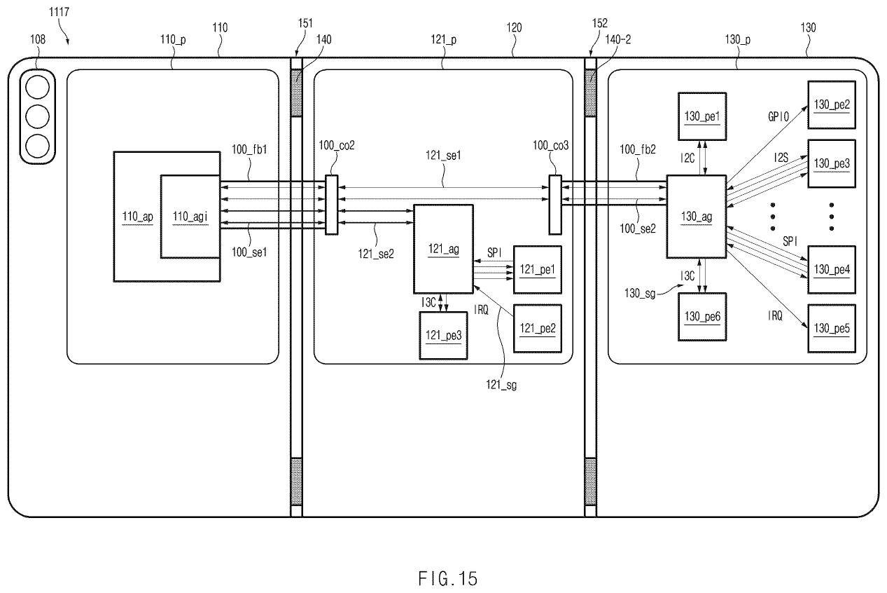

FIG. 15 is a view illustrating a sixth example of a disposition form of internal components of a foldable electronic device according to an embodiment of the disclosure.

Referring to FIGS. 1 to 15, a foldable electronic device 1117 illustrated in FIG. 15 may include a first housing, 110 in which the second camera module 108 is disposed, the second housing 120, the third housing 130, the first hinge housing 151, the second hinge housing 152, the first hinge device 140, the third hinge device 140-2, the first printed circuit board 110_p, the second printed circuit board 121_p, the third printed circuit board 130_p, the first flexible board 100_fb1, and the second flexible board 100_fb2. According to an embodiment, in FIG. 15, the processor 110_ap is illustrated as embedding the first aggregator circuit and having the first aggregator circuit part 110_agi, and some lines of the first flexible board 100_fb1 may have a structure, to which the first aggregator circuit part 110_agi is directly connected. In this case, one side (e.g., a left portion of the illustrated drawing) of the first flexible board 100_fb1 may be disposed in an interior of the processor 110_ap or an interior of the first aggregator circuit part 110_agi to be directly connected to the first aggregator circuit part 110_agi embedded in the processor 110_ap, and another portion of the first flexible board 100_fb1 may extend from the one side of the first flexible board 100_fb1. According to an embodiment, the processor 110_ap that embeds the first aggregator circuit part 110_agi may be disposed at a first portion (or a first point) of the first printed circuit board 110_p, and the first flexible board 100_fb1 may be connected to the first aggregator circuit part 110_agi through a line formed on a certain layer of the first printed circuit board 110_p. In this regard, the first flexible board 100_fb1, as described with reference to FIG. 9, may include a first connector (e.g., the first connector 100_co1 of FIG. 9) and the second connector 100_co2 at left and right peripheries with reference to the illustrated drawing, and the first printed circuit board 110_p may include a board connector (e.g., the first board connector 110_co of FIG. 9) connected to the first connector (e.g., the first connector 100_co1 of FIG. 9), and the first aggregator circuit part 110_agi embedded in the processor 110_ap may be connected to the first flexible board 100_fb1 through a board line formed on the first printed circuit board 110_p and the board connector (e.g., the board connector 110_co of FIG. 9).

According to an embodiment, in the illustrated drawing, the second flexible board 100_fb2 is illustrated as including only the third connector 100_co3, but embodiments of the disclosure are not limited thereto. For example, the second flexible board 100_fb2 may include a fourth connector described with reference to FIG. 9, and correspondingly, the third printed circuit board 130_p may further include a board connector that is connected to the fourth connector of the second flexible board 100_fb2.

Among the components of the foldable electronic device 1117, the second housing 120, the third housing 130, the first hinge housing 151, the second hinge housing 152, the first hinge device 140, the third hinge device 140-2, the first printed circuit board 110_p, the second printed circuit board 121_p, the third printed circuit board 130_p, the first flexible board 100_fb1, and the second flexible board 100_fb2 may be the same as or similar to the corresponding components described above with reference to FIG. 10. Accordingly, a description of the second housing 120, the third housing 130, the first hinge housing 151, the second hinge housing 152, the first hinge device 140, the third hinge device 140-2, the first printed circuit board 110_p, the second printed circuit board 121_p, the third printed circuit board 130_p, the first flexible board 100_fb1, and the second flexible board 100_fb2, among the components of the foldable electronic device 1117, may be supplemented with or replaced with at least a part of the description described in FIG. 10.

According to an embodiment, the first printed circuit board 110_p may be disposed in the first housing 110. The processor 110_ap, in which the aggregator circuit part 110_agi is embedded, may be disposed (or mounted) on the first printed circuit board 110_p. The processor 110_ap may be connected to the second printed circuit board 121_p (or a second board connector (e.g., the second board connector 121_co1 of FIG. 14) of the second printed circuit board 121_p) through the first flexible board 100_fb1. In this regard, the first flexible board 100_fb1 may include a connector (e.g., the second connector 100_co2 of FIG. 14) that is coupled to a second board connector (e.g., the second board connector 121_co1 of FIG. 14). The configuration of the first housing 110 described above may be the same as or similar to the first housing 110 described above with reference to FIG. 10. A configuration of the processor 110_ap, in which the aggregator circuit part 110_agi is embedded, may be the same as or similar to the configuration of the processor 110_ap, in which the aggregator circuit part 110_agi is embedded, described above with reference to FIG. 7 or FIG. 13.

The second printed circuit board 121_p may be disposed in the second housing 120, and the second printed circuit board 121_p may include a second aggregator circuit 121_ag, the plurality of first electronic components 121_pe1, 121_pe2, and 121_pe3, the (2-1)-th circuit line 121_se1 that electrically connects the second connector 100_co2 (or the second board connector 121_co1 of FIG. 14, or a first board connector formed on the second printed circuit board 121_p) and the third connector 100_co3 (or the third board connector 121_co2 of FIG. 14, or a second board connector formed on the second printed circuit board 121_p), a (2-2)-th circuit line 121_se2 that connects the second board connector (e.g., the second board connector 121_co1 of FIG. 14) and the second aggregator circuit 121_ag, and a (2-3)-th signal line 121_sg that connects the second aggregator circuit 121_ag and the plurality of first electronic components 121_pe1, 121_pe2, and 121_pe3. The second printed circuit board 121_p may include a first group of signal lines 121_se1 (or a plurality of first signal lines) that connect a second board connector (e.g., the second board connector 121_co1 of FIG. 14) and a third board connector (e.g., the third board connector 121_co2 of FIG. 14), and a second group of signal lines 121_se2 (or a plurality of second signal lines) that connect the second board connector (e.g., the second board connector 121_co1 of FIG. 14) and the second aggregator circuit 121_ag.

The above-described second housing 120, the second printed circuit board 121_p, and the components (e.g., the second aggregator circuit 121_ag, the plurality of first electronic components 121_pe1, 121_pe2, and 121_pe3, and lines) positioned on the second printed circuit board 121_p may be the same as or similar to the second printed circuit board 121_p described above with reference to FIG. 10 and the components (e.g., the second aggregator circuit 121_ag, the plurality of first electronic components 121_pe1, 121_pe2, and 121_pe3, and lines) disposed on the second printed circuit board 121_p. Correspondingly, a detailed description of the second housing 120, the second printed circuit board 121_p, and the components related to the second printed circuit board 121_p may be replaced with or supplemented with at least a part of the contents described in FIG. 10.

According to an embodiment, the third printed circuit board 130_p may be disposed in the third housing 130, and the third printed circuit board 130_p may include the third aggregator circuit 130_ag, the plurality of second electronic components 130_pe1, 130_pe2, 130_pe3, 130_pe4, 130_pe5, and 130_pe6, and the third signal line 130_sg that connects the third aggregator circuit 130_ag and the plurality of second electronic components 130_pe1, 130_pe2, 130_pe3, 130_pe4, 130_pe5, and 130_pe6. The above-described third housing 130, the third printed circuit board 130_p, and the components (e.g., the third aggregator circuit 130_ag, the plurality of second electronic components 130_pe1, 130_pe2, 130_pe3, 130_pe4, 130_pe5, and 130_pe6, and lines) positioned on the third printed circuit board 130_p may be the same as or similar to the third printed circuit board 130_p described above with reference to FIG. 10 and the components (e.g., the third aggregator circuit 130_ag, the plurality of second electronic components 130_pe1, 130_pe2, 130_pe3, 130_pe4, 130_pe5, and 130_pe6, and lines) disposed on the third printed circuit board 130_p. Correspondingly, a detailed description of the third housing 130, the third printed circuit board 130_p, and the components related to the third printed circuit board 130_p may be replaced with or supplemented with at least a part of the contents described in FIG. 10.

As described above, the foldable electronic device 1117 according to an embodiment may serialize and connect specific port portions of the aggregator circuit part 110_agi and port portions of the second aggregator circuit 121_ag in relation to an operation of the plurality of first electronic components 121_pe1, 121_pe2, and 121_pe3 disposed in the second housing 120, while the processor 110_ap, in which the aggregator circuit part 110_agi is embedded is operated. The second aggregator circuit 121_ag may process transmission or reception of a serialized signal to and from a specific port portion of the aggregator circuit part 110_agi embedded in the processor 110_ap through a (2-2)-th circuit line 121_se2.

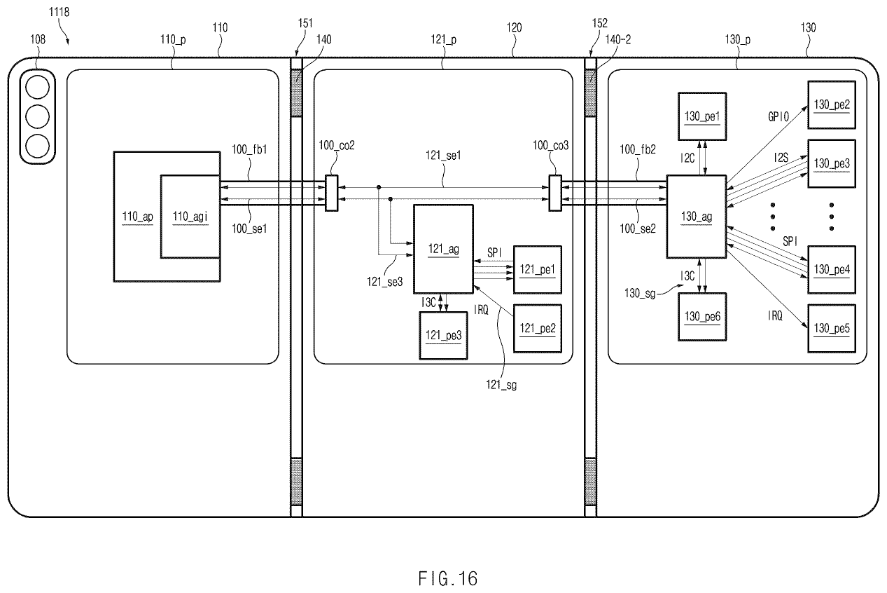

FIG. 16 is a view illustrating a seventh example of a disposition form of internal components of a foldable electronic device according to an embodiment of the disclosure.

Referring to FIGS. 1 to 16, a foldable electronic device 1118 illustrated in FIG. 16 may include a first housing 110, in which the second camera module 108 is disposed, the second housing 120, the third housing 130, the first hinge housing 151, the second hinge housing 152, the first hinge device 140, the third hinge device 140-2, the first printed circuit board 110_p, the second printed circuit board 121_p, the third printed circuit board 130_p, the first flexible board 100_fb1 including the second connector 100_co2, the second flexible board 100_fb2 including the third connector 100_co3, the plurality of first electronic components 121_pe1, 121_pe2, and 121_pe3, the plurality of second electronic components 130_pe1, 130_pe2, 130_pe3, 130_pe4, 130_pe5, and 130_pe6, and lines 100_se1, 121_se1, 121_se3, 121_sg, 100_se2, and 130_sg. The first flexible board 100_fb1 may include a first connector, as described in another embodiment, and the second flexible board 100_fb2 may include a fourth connector.

The foldable electronic device 1118 illustrated in FIG. 16 may include the same configuration as the foldable electronic device 1114 described above with reference to FIG. 11, except that the aggregator circuit part 110_agi is embedded in the processor 110_ap. Furthermore, the processor 110_ap disposed on the first printed circuit board 110_p of the foldable electronic device 1118 may include the same or a similar configuration as the processor 110_ap, in which the aggregator circuit part 110_agi is embedded, described above with reference to FIG. 13. Accordingly, a detailed description of the second housing 120, the third housing 130, the first hinge housing 151, the second hinge housing 152, the first hinge device 140, the third hinge device 140-2, the first printed circuit board 110_p, the second printed circuit board 121_p, the third printed circuit board 130_p, the first flexible board 100_fb1 including the second connector 100_co2, the second flexible board 100_fb2 including the third connector 100_co3, the plurality of first electronic components 121_pe1, 121_pe2, and 121_pe3, the plurality of second electronic components 130_pe1, 130_pe2, 130_pe3, 130_pe4, 130_pe5, and 130_pe6, and the lines 110_sg, 121_se1, 121_se3, 121_sg, and 130_sg, among the components of the foldable electronic device 1118, may be replaced with or supplemented with at least a part of the description of the corresponding components described in FIG. 11. A description of the processor 110_ap disposed on the first printed circuit board 110_p and, in which the aggregator circuit part 110_agi is embedded, among the components of the foldable electronic device 1118 may be replaced with or supplemented with the description of the processor 110_ap described with reference to FIG. 7 or FIG. 13.

According to an embodiment, the second printed circuit board 121_p may include a plurality of first signal lines 121_se1 that connect a second board connector (e.g., the second board connector 121_co1 of FIG. 14) and a third board connector (e.g., the third board connector 121_co2 of FIG. 14), and a plurality of second signal lines 121_se3 that connect the second board connector (e.g., the second board connector 121_co1 of FIG. 14) and the second aggregator circuit 121_ag. Alternatively, the second printed circuit board 121_p may include a plurality of first signal lines 121_se1 that connect a second board connector (e.g., the second board connector 121_co1 of FIG. 14) and a third board connector (e.g., the third board connector 121_co2 of FIG. 14), and a plurality of second signal lines 121_se3 that connect each of the plurality of first signal lines 121_se1 and the second aggregator circuit 121_ag. The plurality of second signal lines 121_se3 may be branched from the first plurality of first signal lines 121_se1 at points (e.g., leads or pins of the second board connector) of the second board connector (e.g., the second board connector 121_co1 of FIG. 14) of the second printed circuit board 121_p. According to an embodiment, the plurality of first signal lines 121_se1 and the plurality of second signal lines 121_se3 may correspond to the (2-1)-th circuit line 121_se1 and a (2-3)-th circuit line 121_se3 described above with reference to FIG. 11, respectively.

As described above, the foldable electronic device 1118 according to an embodiment may connect the second aggregator circuit 121_ag and the aggregator circuit part 110_agi through a (2-3)-th circuit line 121_se 3 that overlaps the (2-1)-th circuit line 121_se1 in relation to an operation of the plurality of first electronic components 121_pe1, 121_pe2, and 121_pe3 disposed in the second housing 120 while the processor 110_ap, in which the aggregator circuit part 110_agi is embedded, is operated, so that signal conversion (e.g., serialization of signals or parallelization of signals) and transmission of signals (e.g., control signals or input/output control signals) that are necessary for the operation of the plurality of first electronic components 121_pe1, 121_pe2, and 121_pe3 may be processed.

FIG. 17 is a view illustrating an example of a bus connection between electronic components of a foldable electronic device according to an embodiment of the disclosure.

Referring to FIGS. 1 to 17, a foldable electronic device according to an embodiment (e.g., at least one of the foldable electronic devices described above with reference to FIGS. 1 to 16) may include a main block 110_agi_M, a first auxiliary block 121_ag_M, a second auxiliary block 130_ag_M, a first secondary block 110_pe1, a second secondary block 122_pe1, a third secondary block 122_pe2, and a fourth secondary block 131_pe1. The foldable electronic device illustrated in FIG. 17 exemplifies the use of I3C as a serial interface, and a plurality of secondary blocks or auxiliary blocks may be connected to one main block. As the secondary blocks may be distinguished by addresses, the signal transmission structure illustrated in FIG. 17 may perform transmission and reception of signals while sharing one I3C bus, and the aggregator circuit 110_ag may add device information to a header of serial data.

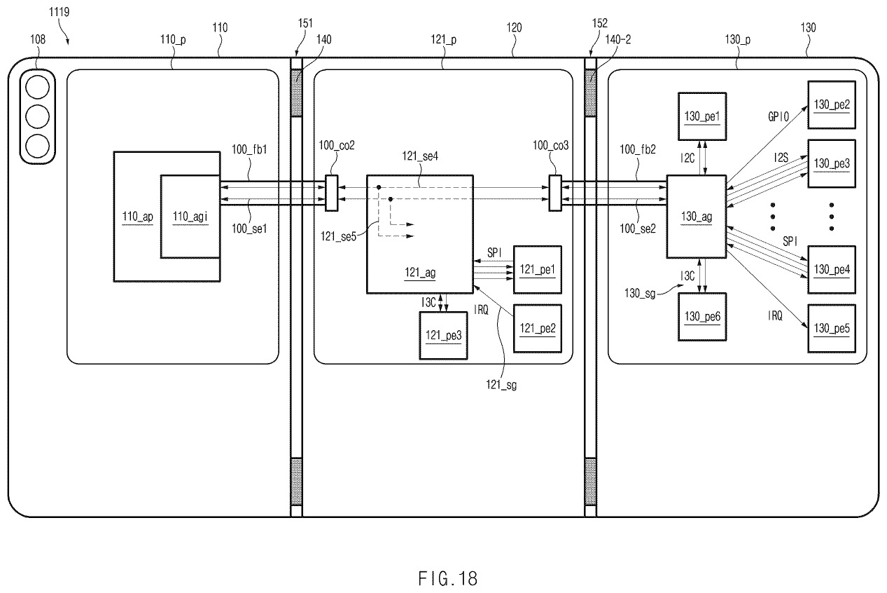

The main block 110_agi_M may include, for example, the first aggregator circuit 110_ag described above with reference to FIGS. 1 to 16, or an aggregator circuit part (e.g., the aggregator circuit part 110_agi of FIG. 7, the aggregator circuit part 110_agi of FIGS. 13 to 16, or the aggregator circuit part 110_agi of FIG. 18 to be described later) embedded in the processor 110_ap. The main block 110_agi_M may transmit signals to at least one of the first auxiliary block 121_ag_M, the second auxiliary block 130_ag_M, the first secondary block 110_pe1, the second secondary block 122_pe1, the third secondary block 122_pe2, and the fourth secondary block 131_pe1 through a bus, or may receive signals from at least one of the first auxiliary block 121_ag_M, the second auxiliary block 130_ag_M, the first secondary block 110_pe1, the second secondary block 122_pe1, the third secondary block 122_pe2, and the fourth secondary block 131_pe1. As an example, the main block 110_agi_M may transmit and receive signals to and from at least one of the first auxiliary block 121_ag_M, the second auxiliary block 130_ag_M, the first secondary block 110_pe1, the second secondary block 122_pe1, the third secondary block 122_pe2, and the fourth secondary block 131_pe1, based on an I3C communication scheme.

The bus may include a first bus line (serial data SDA) and a second bus line (serial clock SCL). The first bus line SDA may transmit serialized signals between the main block 110_agi_M and at least one of the first auxiliary block 121_ag_M, the second auxiliary block 130_ag_M, the first secondary block 110_pe1, the second secondary block 122_pe1, the third secondary block 122_pe2, and the fourth secondary block 131_pe1. The second bus line SCL may transmit clock signals for transmitting or receiving signals between the main block 110_agi_M and at least one of the first auxiliary block 121_ag_M, the second auxiliary block 130_ag_M, the first secondary block 110_pe1, the second secondary block 122_pe1, the third secondary block 122_pe2, and the fourth secondary block 131_pe1.

The first auxiliary block 121_ag_M may include, for example, the second aggregator circuit 121_ag. The first auxiliary block 121_ag_M may be connected to the main block 110_agi_M through the first bus line SDA and the second bus line SCL, and may transmit and receive serialized data to and from the main block 110_agi_M depending on a clock signal provided by the main block 110_agi_M. As an example, the first auxiliary block 121_ag_M may transmit and receive serialized data related to operations of the plurality of first electronic components 121_pe1, 121_pe2, and 121_pe3 that are connected to each other through a signal line (e.g., 121_sg) to and from the main block 110_agi_M through a bus. According to an embodiment, the first auxiliary block 121_ag_M may transmit and receive signals to and from the main block 110_agi_M based on an I3C scheme.

The second auxiliary block 130_ag_M may include, for example, the third aggregator circuit 130_ag. The second auxiliary block 130_ag_M may be connected to the main block 110_agi_M through the first bus line SDA and the second bus line SCL, and may transmit and receive serialized data to and from the main block 110_agi_M depending on a clock signal provided by the main block 110_agi_M. As an example, the second auxiliary block 130_ag_M may transmit and receive serialized data related to operations of the plurality of second electronic components 130_pe1, 130_pe2, 130_pe3, 130_pe4, 130_pe5, and 130_pe6 that are connected through a signal line (e.g., 130_sg) to and from the main block 110_agi_M through a bus. According to an embodiment, the second auxiliary block 130_ag_M may transmit and receive signals to and from the main block 110_agi_M based on an I3C scheme.

The first secondary block 110_pe1 may include, for example, an electronic component that may be disposed in the first housing 110. The first secondary block 110_pe1 may be connected to the main block 110_agi_M through a bus, and may transmit serialized data to and from the main block 110_agi_M through the bus. According to an embodiment, the first secondary block 110_pe1 may transmit and receive signals to and from the main block 110_agi_M based on an I3C scheme.

The second secondary block 122_pe1 may include, for example, an electronic component that may be disposed in the second housing 120. The second secondary block 122_pe1 may be connected to the main block 110_agi_M through a bus, and may transmit serialized data to and from the main block 110_agi_M through the bus. According to an embodiment, the second secondary block 122_pe1 may transmit and receive signals to and from the main block 110_agi_M based on an I3C scheme.

The third secondary block 122_pe2 may include, for example, an electronic component that may be disposed in the second housing 120. The third secondary block 122_pe2 may be connected to the main block 110_agi_M through a bus, and may transmit serialized data to and from the main block 110_agi_M through the bus. According to an embodiment, the third secondary block 122_pe2 may transmit and receive signals to and from the main block 110_agi_M based on an I2C scheme.

The fourth secondary block 121_pe1 may include, for example, an electronic component that may be disposed in the third housing 130. The fourth secondary block 131_pe1 may be connected to the main block 110_agi_M through a bus, and may transmit serialized data to and from the main block 110_agi_M through the bus. According to an embodiment, the fourth secondary block 131_pe1 may transmit and receive signals to and from the main block 110_agi_M based on an I2C scheme. Meanwhile, the first to fourth secondary blocks 110_pe1, 122_pe1, 122_pe2, and 131_pe1 may be a plurality of electronic components disposed in the second housing 120 or a plurality of electronic components disposed in the third housing 130.

A signal transmission and reception scheme between the above-described blocks may be applied to a communication scheme between respective components (e.g., aggregator circuits, a plurality of electronic components, or an aggregator circuit and a plurality of electronic components) of the electronic devices illustrated in FIGS. 1 to 16 described above or FIGS. 18 to 20 to be described later.

FIG. 18 is a view illustrating an eighth example of a disposition form of internal components of a foldable electronic device according to an embodiment of the disclosure.

Referring to FIGS. 1 to 18, a foldable electronic device 1119 illustrated in FIG. 18 may include a first housing 110, in which the second camera module 108 is disposed, the second housing 120, the third housing 130, the first hinge housing 151, the second hinge housing 152, the first hinge device 140, the third hinge device 140-2, the first printed circuit board 110_p, the second printed circuit board 121_p, the third printed circuit board 130_p, the first flexible board 100_fb1 including the second connector 100_co2, the second flexible board 100_fb2 including the third connector 100_co3, the plurality of first electronic components 121_pe1, 121_pe2, and 121_pe3, the plurality of second electronic components 130_pe1, 130_pe2, 130_pe3, 130_pe4, 130_pe5, and 130_pe6, and lines 100_se1, 121_se4, 121_se5, 121_sg, and 130_sg. The first flexible board 100_fb1 may include a first connector (e.g., the first connector 100_co1 of FIG. 9) described in another embodiment (e.g., FIG. 9), and the second flexible board 100_fb2 may include a fourth connector (e.g., the fourth connector 100_co4 of FIG. 9).

The foldable electronic device 1119 illustrated in FIG. 18 may include the same configuration as the foldable electronic device 1115 described above with reference to FIG. 12, except that the aggregator circuit part 110_agi is embedded in the processor 110_ap. Furthermore, the processor 110_ap disposed on the first printed circuit board 110_p of the foldable electronic device 1119 may include the same or a similar configuration as the processor 110_ap, in which the aggregator circuit part 110_agi is embedded, described above with reference to FIG. 13. Accordingly, a detailed description of the second housing 120, the third housing 130, the first hinge housing 151, the second hinge housing 152, the first hinge device 140, the third hinge device 140-2, the first printed circuit board 110_p, the second printed circuit board 121_p, the third printed circuit board 130_p, the first flexible board 100_fb1 including the second connector 100_co2, the second flexible board 100_fb2 including the third connector 100_co3, the plurality of first electronic components 121_pe1, 121_pe2, and 121_pe3, the plurality of second electronic components 130_pe1, 130_pe2, 130_pe3, 130_pe4, 130_pe5, and 130_pe6, and the lines 100_se1, 121_se4, 121_se5, 121_sg, and 130_sg, among the components of the foldable electronic device 1119, may be replaced with or supplemented with at least a part of the description of the corresponding components described in FIG. 12. A description of the processor 110_ap disposed on the first printed circuit board 110_p and, in which the aggregator circuit part 110_agi is embedded, among the components of the foldable electronic device 1119 may be replaced with or supplemented with the description of the processor 110_ap described with reference to FIG. 7 or FIG. 13.

According to an embodiment, a second aggregator circuit 121_ag that is disposed on the second printed circuit board 121_p may include a portion of a (2-4)-th circuit line 121_se4 that passes through an inside (e.g., a third line part 121_se43 of FIG. 12), and a (2-5)-th circuit line 121_se5 that is connected to a portion of the (2-4)-th circuit line 121_se4 identically or similarly to the second aggregator circuit 121_ag described above with reference to FIG. 12. The (2-5)-th circuit line 121_se5 may be connected to a signal converter that is disposed in the second aggregator circuit 121_ag.

According to an embodiment, the second printed circuit board 121_p may include signal lines 121_se4 that are connected to the third board connector 121_co2 (e.g., the third board connector 121_co2 of FIG. 14) while passing through the second aggregator circuit 121_ag from the second board connector 121_co1 (e.g., the second board connector 121_co1 of FIG. 14), and the second aggregator circuit 121_ag may be configured to, when all of second control signals output from the first aggregator circuit 110_ag (or an aggregator circuit part 110_agi) are related to at least one electronic component accommodated in the third housing 130, transmit the second control signals to the third board connector 121_co2 (e.g., the third board connector 121_co2 of FIG. 14) while not transmitting the second control signals to other electronic components accommodated in the second housing 120.

As described above, the foldable electronic device 1119 according to an embodiment may process signal conversion (e.g., serialization of signals or parallelization of signals) and transmission of signals (e.g., control signals or input/output control signals) that are necessary for the operation of the plurality of first electronic components 121_pe1, 121_pe2, and 121_pe3 connected to the second aggregator circuit 121_ag, in relation to an operation of the plurality of first electronic components 121_pe1, 121_pe2, and 121_pe3 disposed in the second housing 120 while the processor 110_ap, in which the aggregator circuit part 110_agi is embedded, is operated, with at least a portion of a (2-4)-th circuit line 121_se4 formed inside the second aggregator circuit 121_ag.

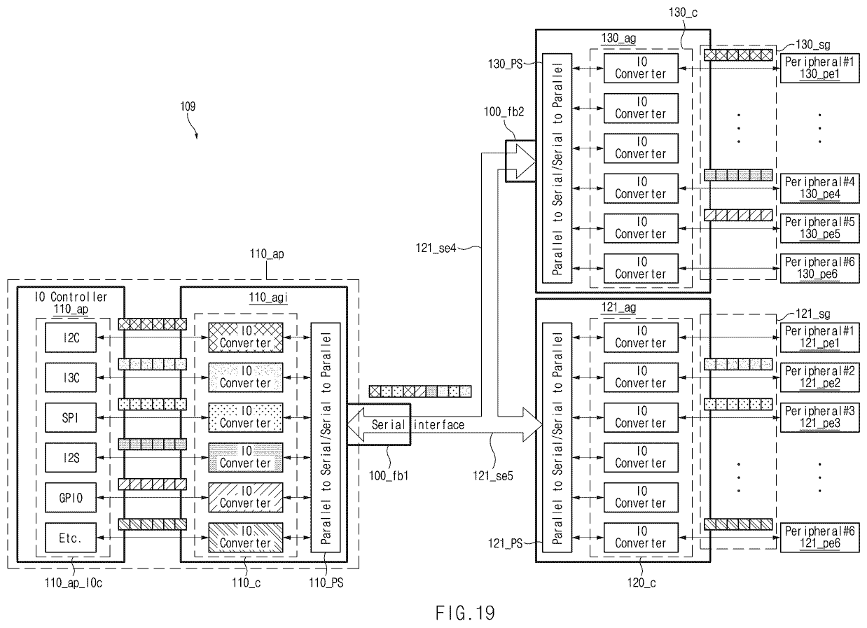

FIG. 19 is a view illustrating an example of a connection relationship of a processor, an aggregator circuit part, and aggregator circuits of a foldable electronic device according to an embodiment of the disclosure.

Referring to FIGS. 1 to 19, a circuit disposition relationship of the processor 110_ap, the aggregator circuit part 110_agi, and the aggregators 121_ag and 130_ag illustrated in FIG. 19 may include a circuit disposition relationship in foldable electronic devices illustrated in FIGS. 11, 12, 16, and 18. According to an embodiment, while the aggregator circuit part 110_agi is embedded in the processor 110_ap, a plurality of input/output controllers 110_ap_10c designed in the processor 110_ap may be connected to a plurality of input/output converters 110_c formed in the aggregator circuit part 110_agi through multiple input/output (I/O) lines, respectively. The plurality of input/output converters 110_c of the aggregator circuit part 110_agi may be connected to a first signal converter 110_PS, respectively. The aggregator circuit part 110_agi may add a secondary address bit to serial data to support a bypass mode, so that the aggregators 121_ag and 130_ag may be distinguished. For example, in transmitting serialized signals, the aggregator circuit part 110_agi may write a specific bit value (e.g., 0 or 1) in a secondary address or in a header of serial data to distinguish aggregators 121_ag and 130_ag that are to receive the signals. Furthermore, the aggregator circuit part 110_agi may distinguish input/output (I/O) ports of a plurality of electronic components connected to a specific aggregator circuit by using different bits of the secondary address. An operation of the aggregator circuit part 110_agi may also be performed by the aggregators described above with reference to FIGS. 4 to 18.

One side of the aggregator circuit part 110_agi may be connected to one side of the first flexible board 100_fb1, and the first flexible board 100_fb1 may connect the aggregator circuit part 110_agi and one side (e.g., a second signal converter 121_PS) of the second aggregator circuit 121_ag. According to an embodiment, the second aggregator circuit 121_ag may be disposed on the second printed circuit board, and thus, the second aggregator circuit 121_ag may be connected to the first flexible board 100_fb1 through a (2-5)-th circuit line 121_se5. The second aggregator circuit 121_ag may be connected to a plurality of electronic components 121_pe1, 121_pe2, 121_pe3, . . . , and 121_pe6 through a second signal line 121_sg. The second signal line 121_sg may be connected to a plurality of input/output converters 120_c disposed in the second aggregator circuit 121_ag, and the plurality of input/output converters 120_c disposed in the second aggregator circuit 121_ag may be connected to a second signal converter 121_PS.

Meanwhile, the (2-5)-th circuit line 121_se5 may be connected to the (2-4)-th circuit line 121_se4, and a signal transmitted from the aggregator circuit part 110_agi may be transmitted to the third aggregator circuit 130_ag through the (2-4)-th circuit line 121_se4. Alternatively, the (2-4)-th circuit line 121_se4 may be connected to the third board connector 121_co2 (e.g., the third board connector 121_co2 of FIG. 14) of the second printed circuit board 121_p, one side of the second flexible board 100_fb2 may be coupled to the third board connector 121_co2, and an opposite side of the second flexible board 100_fb2 may be coupled to the fourth board connector 130_co (e.g., the fourth board connector 130_co of FIG. 14) of the third printed circuit board 130_p. Correspondingly, the aggregator circuit part 110_agi may be connected to the third aggregator circuit 130_ag via the first flexible board 100_fb1, the (2-4)-th circuit line 121_se4, and the second flexible board 100_fb2. The third aggregator circuit 130_ag may be connected to a plurality of electronic components 130_pe1, . . . , 130_pe4, 130_pe5, and 130_pe6 through the third signal line 130_sg. The third signal line 130_sg may be connected to a plurality of input/output converters 130_c disposed in the third aggregator circuit 130_ag, and the plurality of input/output converters 130_c disposed in the third aggregator circuit 130_ag may be connected to a third signal converter 130_PS.

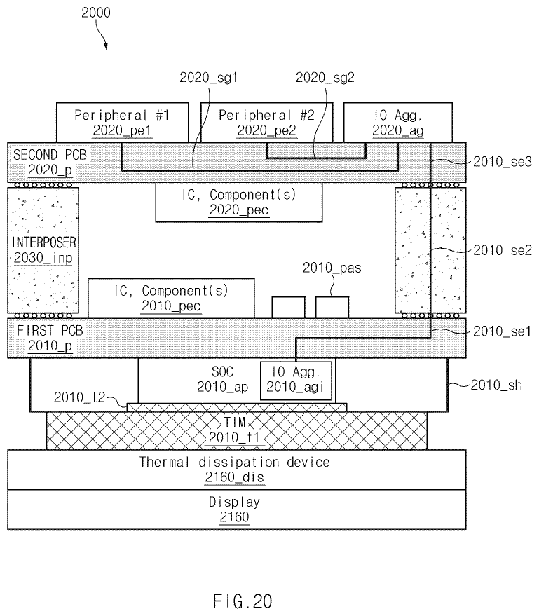

FIG. 20 is a view illustrating an example of a printed circuit board of an interposer structure, to which aggregator circuits are applied, according to an embodiment of the disclosure.

Referring to FIGS. 1 to 20, an electronic device 2000 according to an embodiment may include a display 2160, a heat dissipation device 2160_dis, a first adhesive member 2010_t1 (or a first thermal interface material (TIM)), a shielding member 2010_sh, a second adhesive member 2010_t2 (or a second TIM), a processor 2010_ap, a first printed circuit board 2010_p on which the processor 2010_ap is disposed, a second printed circuit board 2020_p that is stacked substantially in parallel with the first printed circuit board 2010_p, and an interposer 2030_inp that is disposed between the first printed circuit board 2010_p and the second printed circuit board 2020_p. A stack structure of printed circuit boards including the interposer of the electronic device 2000 described with reference to FIG. 20 may be applied to at least one of the foldable electronic devices described above with reference to FIGS. 1 to 19, or may be applied to various types of electronic devices, such as a bar-type electronic device, a rollable electronic device, or a foldable (multi-foldable) electronic device.

According to an embodiment, the display 2160 may output at least one screen related to an operation of the electronic device 2000. The display 2160 may be foldable or rollable. Alternatively, the display 2160 may have a rigid structure and may be formed in a bar type. The heat dissipation device 2160_dis may be configured to receive heat generated from the processor 2010_ap through the first adhesive member 2010_t1, the shielding member 2010_sh, and the second adhesive member 2010_t2, and dissipate it. As an example, the heat dissipation device 2160_dis may dissipate at least a portion of heat generated from the processor 2010_ap, or may dissipate the heat through a metal layer (e.g., a copper layer or an aluminum layer) formed on one side of a rear surface of the display 2160. The first adhesive member 2010_t1 may be disposed between the shielding member 2010_sh and the heat dissipation device 2160_dis, and the heat dissipation device 2160_dis may be formed of a material that may transfer heat of the shielding member 2010_sh to the heat dissipation device 2160_dis while being fixed to the shielding member 2010_sh. The shielding member 2010_sh may be disposed to surround the processor 2010_ap. At least a portion of the shielding member 2010_sh may be formed of a metal material. The shielding member 2010_sh may be connected to a portion of the processor 2010_ap through the second adhesive member 2010_t2. The second adhesive member 2010_t2 may serve to transfer heat generated from the processor 2010_ap to the shielding member 2010_sh while being disposed to fill an empty space between the shielding member 2010_sh and the processor 2010_ap. The second adhesive member 2010_t2 may be formed of a material that is the same as or similar to that of the first adhesive member 2010_t1.

The processor 2010_ap may be disposed on one side (e.g., a lower surface with reference to the illustrated drawing) of the first printed circuit board 2010_p. Another electronic component 2010_pec or at least one passive element 2010_pas may be disposed on an opposite side of the first printed circuit board 2010_p. An interposer 2030_inp may be disposed at a periphery of the first printed circuit board 2010_p. According to an embodiment, the first printed circuit board 2010_p may be spaced apart from the second printed circuit board 2020_p through the interposer 2030_inp. At least one electronic component or at least one passive element may be disposed at a portion of front and rear surfaces of the first printed circuit board 2010_p.

One surface of the second printed circuit board 2020_p may include various electronic components 2020_pe1 and 2020_pe2 that are necessary for an operation of the electronic device 2000. Another electronic component 2020_pec that is necessary for an operation of the electronic device 2000 may be disposed on an opposite surface of the second printed circuit board 2020_p. According to an embodiment, at least one electronic component or at least one passive element may be disposed at a portion of front and rear surfaces of the second printed circuit board 2020_p. A second aggregator circuit 2020_ag may be disposed on one side of the second printed circuit board 2020_p. The second aggregator circuit 2020_ag may be connected to a first electronic component 2020_pe1 through a first signal line 2020_sg1, and may be connected to a second electronic component 2020_pe2 through a second signal line 2020_sg2.

The processor 2010_ap may be the same as or similar to the processor 110_ap described above with reference to FIGS. 1 to 18. According to an embodiment, the processor 2010_ap may include an aggregator circuit part 2010_agi.

The aggregator circuit part 2010_agi and the second aggregator circuit 2020_ag may be connected to each other through lines 2010_se1, 2010_se2, and 2010_se3. For example, the lines may include a first circuit line part 2010_se1 that is connected to one side of the aggregator circuit part 2010_agi and is disposed on the first printed circuit board 2010_p, a second circuit line part 2010_se2 that is connected to the first circuit line part 2010_se1 and is disposed through a portion of the interposer 2030_inp (e.g., at least one via hole of the interposer 2030_inp), and a third circuit line part 2010_se3 that is connected to the second circuit line part 2010_se2, is disposed on the second printed circuit board 2020_p, and is connected to the second aggregator circuit 2020_ag.

According to an embodiment, the processor 2010_ap may also be disposed on an upper surface (or a second surface) of the first printed circuit board 2010_p. The second aggregator circuit 2020_ag may also be disposed on a lower surface (or a first surface) of the second printed circuit board 2020_p.

Meanwhile, numbering for describing respective components of the foldable electronic device or the electronic device described above with reference to FIGS. 1 to 20 is set based on a specific first component, and when numbering is performed based on a second component of the foldable electronic device or the electronic device described with reference to FIGS. 1 to 20, the numbering may be different. As an example, in FIGS. 8 to 20, a printed circuit board accommodated in the second housing 120 is defined as the second printed circuit board 121_p, but a printed circuit board accommodated in the third housing 130 may be defined as a second printed circuit board 130_p, and in this case, the printed circuit board accommodated in the second housing 120 may be defined as a third printed circuit board.

The technical problems to be solved by various embodiments of the disclosure are not limited to the aforementioned problem, and other technical problems that are not mentioned will be clearly understood by those skilled in the art, to which the disclosure pertains, from the following description.

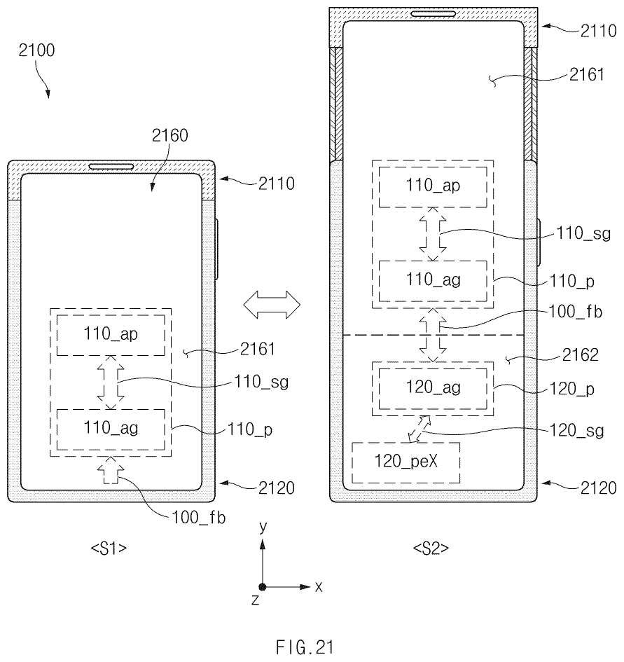

FIG. 21 is a view illustrating an example of a rollable electronic device structure, to which aggregator circuits are applied, according to an embodiment of the disclosure.

Referring to FIGS. 1 to 21, according to an embodiment, a rollable electronic device 2100 (or a slidable electronic device) may include a first housing 2110, a second housing 2120, and a display 2160. The first housing 2110 may be disposed to be slidable in the y-axis direction with respect to the second housing 2120. Alternatively, the second housing 2120 may be disposed to be slidable in the −y-axis direction with respect to the first housing 2110. In the rollable electronic device 2100, an aligned length of the first housing 2110 and the second housing 2120 may have a contracted state S1 having a first length, and an extended state S2 having a second length that is greater than the first length of the aligned length of the first housing 2110 and the second housing 2120.

In a first state (e.g., a contracted state S1), the rollable electronic device 2100 may be disposed such that a first display area 2161 is visually exposed to the outside. In a second state (e.g., an extended state S2), the rollable electronic device 2100 may be disposed such that a first display area 2161 and a second display area 2162 are visually exposed to the outside. One end (e.g., a −y-axis periphery) of ~ and one end (e.g., a y-axis periphery) of ~ may be connected to each other. Correspondingly, in the first state, the second display area 2162 may be disposed below the first display area 2161 (e.g., a lower side in a −z-axis direction with respect to the first display area 2161).

According to an embodiment, in the first state, the first printed circuit board 110_p may be disposed below the first display area 2161, and the processor 110_ap, the first aggregator circuit 110_ag, the first signal line 110_sg, and a portion of the flexible board 100_fb may be disposed on the first printed circuit board 110_p. In the second state, while the second display area 2162 is disposed to be visually exposed to the outside, the second printed circuit board 120_p and at least one electronic component 120_peX may be disposed below the second display area 2162, and a second aggregator circuit 120_ag and another portion of the flexible board 100_fb may be disposed on the second printed circuit board 120_p. According to various embodiments, at least a portion of the at least one electronic component 120_peX may also be disposed on the second printed circuit board 120_p. A second signal line 120_sg that connects the second aggregator circuit 120_ag and the at least one electronic component 120_peX may be formed (or disposed) on the second printed circuit board 120_p, or may be configured in a form of a flexible board, so that one side of the second signal line 120_sg may be connected to the second printed circuit board 120_p and an opposite side thereof may be connected to the at least one electronic component 120_peX.

According to various embodiments, the first printed circuit board 110_p and the second printed circuit board 120_p may be disposed below the first display area 2161. Correspondingly, when observed from the z-axis in the −z-axis direction, the first printed circuit board 110_p and the second printed circuit board 120_p may be disposed to at least partially overlap the first display area 2161. According to an embodiment, at least a portion of the first printed circuit board 110_p and the second printed circuit board 120_p may be disposed to overlap with each other with respect to the z-axis direction.

The rollable electronic device 2100 described above with reference to FIG. 21 is illustrated to exemplify that the aggregators of the disclosure described above with reference to FIGS. 1 to 20 may also be applied identically or similarly to electronic devices of a rollable type or a slidable type, and is not limited to an internal structure or an external shape of the rollable electronic device 2100.

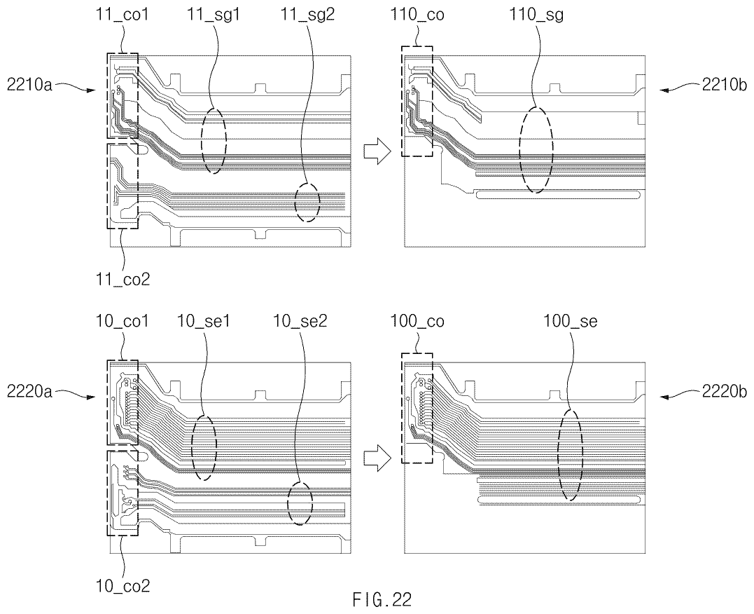

FIG. 22 is a view illustrating an example of a structure, which is improved according to application of an aggregator circuit, according to an embodiment of the disclosure.

Referring to FIGS. 1 to 22, electronic devices according to various embodiments, to which the aggregators described above with reference to FIGS. 1 to 21 are applied, may provide an effect of reducing at least a portion of a number of lines and a thickness of the lines, as illustrated in FIG. 22.

According to an embodiment, in a structure, in which an aggregator circuit (e.g., the first aggregator circuit 110_ag or the aggregator circuit part 110_agi described in FIGS. 4 to 21, the second aggregator circuits 120_ag and 121_ag, or the third aggregator circuit 130_ag) is not used, as in state 2210a, two board connectors 11_co1 and 11_co2 and lines 11_sg1 and 11_sg2 that are connected to the two board connectors 11_co1 and 11_co2 may be required to transmit and receive signals between a processor (e.g., the processor 110_ap of FIG. 4) disposed on a first printed circuit board (e.g., the first printed circuit board 110_p of FIG. 4) and a second printed circuit board (e.g., the second printed circuit board 120_p of FIG. 4 and/or the third printed circuit board 130_p of FIG. 8). According to an embodiment, in a structure,1 in which an aggregator circuit (e.g., the first aggregator circuit 110_ag or the aggregator circuit part 110_agi described in FIGS. 4 to 21, the second aggregator circuits 120_ag and 121_ag, or the third aggregator circuit 130_ag) is used, as in state 2210b, one board connector 110_co and lines 110_sg that are connected to the one board connector 110_co may be required.

According to an embodiment, in a structure, in which an aggregator circuit (e.g., the first aggregator circuit 110_ag or the aggregator circuit part 110_agi described in FIGS. 4 to 21, the second aggregator circuits 120_ag and 121_ag, or the third aggregator circuit 130_ag) is not used, as in state 2220a, a flexible board (e.g., the first flexible board 100_fb of FIG. 4) disposed between printed circuit boards (e.g., the first printed circuit board 110_p and the second printed circuit board 120_p of FIG. 4) may require two connectors 10_co1 and 10_co2 and flexible board lines 10_se1 and 10_se2 that are connected to the two connectors 10_co1 and 10_co2 for transmission and reception of signals of the printed circuit boards (e.g., 110_p and 120_p). According to an embodiment, in a structure, in which aggregator circuits (e.g., the aggregator circuits 110_ag, 110_agi, 120_ag, 121_ag, or 130_ag described in FIGS. 4 to 21) are used, as in state 2220b, a flexible board (e.g., the first flexible board 100_fb of FIG. 4, or the flexible boards 100_fb1 and 100_fb2 of FIG. 8) disposed between printed circuit boards (e.g., the first printed circuit board 110_p and the second printed circuit board 120_p of FIG. 4, and/or the third printed circuit board 130_p of FIG. 8) may require one connector 100_co and flexible board lines 100_se that are connected to the one connector 100_co for transmission and reception of signals of the printed circuit boards (e.g., 110_p, 120_p (or 121_p), and 130_p). In the case of the flexible board, a portion (or a portion that overlaps a hinge housing) that overlaps a hinge structure may be formed as two layers, and other portions (e.g., portions that overlap printed circuit boards) may be formed as one layer or two layers.

In relation to the above-described structure, when the flexible board in state 2220a and the flexible board in state 2220b are compared, a width of the flexible board may be reduced by approximately 3 to 4.54 mm, and when considering that a width required for adding an aggregator circuit is 1.78 mm, a space for built-in components in the electronic device may be secured. According to an embodiment, when an aggregator circuit is applied, 46 signal lines in various communication methods (e.g., GPIO, I2C, SPI) may be reduced to 10 lines of the aggregator circuit. As described above, when the aggregator circuits of the disclosure are applied, a width of the flexible board may be reduced by approximately 3.4 mm compared to before, and two 64-pin connectors required for connection between the printed circuit board and the flexible board may be replaced with one 78-pin connector. In this way, by removing one connector, it is possible to reduce a size of a main PCB (e.g., the first printed circuit board), secure a space, in which other electronic components may be additionally disposed, or support space utilization that may reduce signal interference.

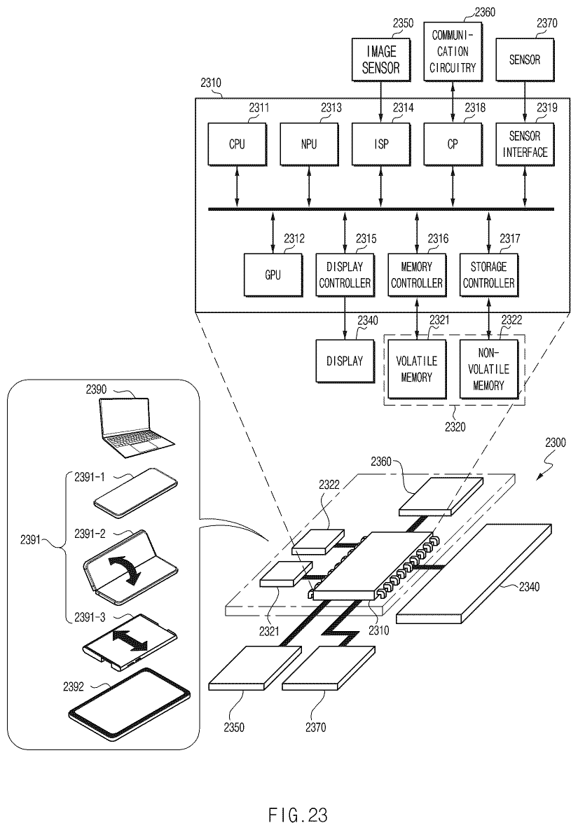

FIG. 23 illustrates a block diagram of an electronic device 2300 capable of performing the operations described herein according to an embodiment of the disclosure.

Referring to FIG. 23, the electronic device 2300 may be one of various types of electronic devices, such as a notebook computer 2390, smartphones 2391 having various form factors (e.g., a bar-type smartphone 2391-1, a foldable smartphone 2391-2, or a slidable (or rollable) smartphone 2391-3), a tablet PC 2392, a cellular telephone (not shown), and any other similar computing devices (not shown). The components illustrated in FIG. 23, the relationships thereof, and the functions thereof are merely for illustration, and are not intended to limit the implementations described or claimed in the disclosure thereto. The electronic device 2300 may be referred to as a mobile device, a user equipment, a multifunctional device, a portable device, or a server.

The electronic device 2300 may comprise various components including at least one processor 2310 (hereinafter, the processor 2310), memory 2320 (hereinafter, the memory 2320), at least one display 2340 (hereinafter, the display 2340), at least one image sensor 2350 (hereinafter, the image sensor 2350), at least one communication circuitry 2360 (hereinafter, the communication circuitry 2360), and/or at least one sensor 2370 (hereinafter, the sensor 2370). The aforementioned components are merely of an example. For example, the electronic device 2300 may comprise other components (e.g., a power management integrated circuitry (PMIC), an audio processing circuitry, an antenna, a rechargeable battery, or an input/output interface). For example, some components may be omitted from the electronic device (2300). For example, some components may be integrated into one component.

The processor 2310 may be implemented as one or more integrated circuit (or circuitry) (IC) chips and may perform various data processing. The processor 2310 may include at least one electrical circuitry and may process instructions (or program, data, and so on) stored in the memory 2320 individually or collectively in a distributed manner. The processor 2310 may include a processor assembly that includes one or more processing circuitries. The processor may include any processing circuitry that may be operative for controlling operations and performance of one or more components (e.g., the memory 2320, a display 2340, the image sensor 2350, the communication circuitry 2360, and/or the sensor 2370) of the electronic device. For example, the processor 2310 (e.g., an application processor (AP)) may be implemented as a system on chip (SoC) (e.g., one chip or chipset). For example, the processor 2310 may be implemented as a plurality of cores (or at least one core circuitry), a plurality of chips, or a plurality of chipsets. For example, the processor 2310 may comprise one or more processing circuitry. For example, the processor 2310 may comprise one or more processing circuitry which are individually and/or collectively configured to perform various functions of the disclosure. As a non-limiting example, at least a portion of the processor 2310 may be included in a first chip of the electronic device 2300 and at least another portion of the processor 2310 may be included in a second chip of the electronic device 2300 different from the first chip of the electronic device 2300.

For example, the processor 2310 may comprise a central processing unit (CPU) 2311, a graphics processing unit (GPU) 2312, a neural processing unit (NPU) 2313, an image signal processor (ISP) 2314, a display controller 2315, a memory controller 2316, a storage controller 2317, a communication processor (CP) 2318, and/or a sensor interface 2319. These components of the processor 2310 are merely of an example. For example, the processor 2310 may further comprise other components. For example, some components of the processor 2310 may be omitted from the processor 2310. For example, some components of the processor 2310 may be included as separate components of the electronic device 2300 outside the processor 2310. For example, some components of the processor 2310 (e.g., the memory controller 2316) may be included in other components of the electronic device 2300 (e.g., at least a portion of the memory 2320, an interface (e.g., usable for connecting to at least one component of the electronic device 2300), the display 2340, and/or the image sensor 2350).

The processor 2310 may cause other components of the electronic device 2300 to perform various operations by executing instructions stored in the memory 2320. The CPU 2311 (or a central processing circuitry) may be configured to control the components of the processor 2310 based on execution of instructions stored in the memory 2320 (e.g., the volatile memory 2321 and/or the non-volatile memory 2322). The GPU 2312 (or a graphic processing circuitry) may be configured to execute parallel computations (e.g., rendering). The NPU 2313 (or a neural processing circuitry, or an artificial intelligence (AI) chip) may be configured to execute operations (e.g., convolution computations) for an artificial intelligence model. The ISP 2314 (or an image signal processing circuitry) may be configured to process a raw image obtained from the image sensor 2350 in a format suitable for a component in the electronic device 2300 or a component of the processor 2310. The display controller 2315 (or a display control circuitry, or a display processing unit (DPU)) may be configured to process an image obtained from the CPU 2311, the GPU 2312, the ISP 2314, or the memory 2320 (e.g., the volatile memory 2321) in a format suitable for the display 2340. The memory controller 2316 (or a memory control circuitry) may be configured to control reading data from the volatile memory 2321 and writing data to the volatile memory 2321. The storage controller 2317 (or a storage control circuitry) may be configured to control reading data from the non-volatile memory 2322 and writing data to the non-volatile memory 2322. The CP 2318 (or a communication processing circuitry) may be configured to process data obtained from a component of the processor 2310 in a format suitable for transmission to another electronic device via the communication circuitry 2360, or to process data obtained from another electronic device via the communication circuitry 2360 in a format suitable for processing of the component of the processor 2310. For example, the communication circuitry 2360 may comprise one or more communication circuitry. The sensor interface 2319 (or a sensing data processing circuitry, a sensor hub) may be configured to process data on a state of the electronic device 2300 and/or a state around the electronic device 2300, obtained through the sensor 2370, in a format suitable for a component of the processor 2310.

The memory 2320 may comprise one or more storage mediums (or one or more storage devices). For example, the memory 2320 may include a memory assembly that includes one or more storage mediums. For example, the one or more storage mediums may comprise permanent memory (e.g., the non-volatile memory 2322) such as a hard drive, flash memory, read-only memory (ROM), semi-permanent memory (e.g., the volatile memory 2321) such as random access memory (RAM), a storage (or a storage assembly) of any other suitable type, or any combination thereof. The memory 2320 may comprise cache memory which is memory of one or more different types used to store data for performing a function or feature of the electronic device 2300 at least temporarily. As a non-limiting example, the cache memory may be included in the processor 2310. The memory 2320 may be fixedly embedded within the electronic device 2300, or may be incorporated onto one or more suitable types of components that may be repeatedly inserted into the electronic device 2300, and removed from the electronic device 2300 (e.g., a subscriber identity module (SIM) card, and/or a secure digital (SD) card).

For example, the memory 2320 may store one or more software applications such as an operating system (or a system) software application, a firmware software application, a driver software application, a plug-in (e.g., add-in, add-on, and/or applet) software application, and/or any other suitable software application. For example, the one or more software applications may include instructions executable by the processor 2310. For example, the memory 2320 may store instructions callable by an application programming interface (API). For example, the memory 2320 may store instructions in a library.

As described above, according to an embodiment of the disclosure, a foldable electronic device 100 according to an embodiment may include a housing that includes a first housing part (or a first housing 110), a second housing part (or a second housing 120), and a hinge housing part (e.g., a hinge housing 150) that is disposed at least partially between the first housing part and the second housing part, a hinge assembly (or the first hinge device 140 or a second hinge device 140-1) that is accommodated at least partially in the hinge housing part and that rotatably connects the first housing part and the second housing part, a flexible display (e.g., the first display 160 of FIGS. 1 to 3) that is accommodated in the first housing part and the second housing part and that is folded or unfolded in response to folding or unfolding of the housing, and a processor (e.g., the processor 110_ap) that is accommodated in the first housing part, The foldable electronic device 100 may include the first aggregator circuit 110_ag that is accommodated in the first housing part and that converts a first control signal input from the processor through a first number of ports into a second control signal that is output through a second number of ports smaller than the first number of ports, a second aggregator circuit 120_ag that is accommodated in the second housing part and that receives the second control signal through the second number of ports and that converts the second control signal into a third control signal that is output through a third number of ports greater than the second number of ports, and a flexible printed circuit board (FPCB) (e.g., the flexible board 100_fb or a flexible printed circuit board) that is connected to the first aggregator circuit and the second aggregator circuit, a portion of the FPCB may be coupled at least partially to the hinge assembly or accommodated at least partially in the hinge housing part and may be configured to transmit the second control signal.

According to an embodiment, the foldable electronic device 100 may further include a first printed circuit board (PCB) (e.g., the first printed circuit board 110_p of FIG. 4) that is accommodated in the first housing part (e.g., the first housing 110) and that is connected to a first connector (e.g., a first connector 100_co1 of FIG. 4 or FIG. 9) that is disposed at a first end of the FPCB (e.g., the FPCB 100_fb of FIG. 4), and a second PCB (e.g., the second printed circuit board 120_p of FIG. 4 or the second printed circuit board 121_p of FIG. 8) that is accommodated in the second housing part and that is connected to a second connector (e.g., a second connector 100_co1 of FIG. 4 or FIG. 9) that is disposed at a second end of the FPCB, the processor 110_ap and the first aggregator circuit 110_ag are disposed on the first PCB 110_p, and the second aggregator circuit 120_ag may be disposed on the second PCB 120_p or 121_p.

According to an embodiment, the processor 110_ap and the first aggregator circuit (e.g., the aggregator circuit 110_ag of FIG. 4 or the aggregator circuit part 110_agi of FIG. 7) may constitute a single chipset.

According to an embodiment, the second aggregator circuit (e.g., the aggregator circuit 120_ag of FIG. 4) is electrically connected to a plurality of components (e.g., a plurality of electronic components 120_pe1, 120_pe2, 120_pe3, 120_pe4, 120_pe5, and 120_pe6 of FIG. 4) that are accommodated in the second housing part and that transmit the third control signal, each of the plurality of components may include a sensor module, a PMIC, an audio module, a display control circuit, or a touch control module.

According to an embodiment, the foldable electronic device may further include another FPCB that is electrically connected between the processor 110_ap and at least one of the plurality of components (e.g., the components 120_pe1, 120_pe2, 120_pe3, 120_pe4, 120_pe5, and 120_pe6 of FIG. 4), and that is coupled at least partially to the hinge assembly (e.g., the first hinge device 140) or that is accommodated at least partially in the hinge housing part (e.g., the hinge housing 150), the processor 110_ap of FIG. 8 may be configured to transmit a payload related to the at least one component to the at least one component through the other FPCB.

According to an embodiment, the processor 110_ap may be configured to disable, at least temporarily, a portion of the second aggregator circuit 120_ag that is connected to a touch control module that processes a touch input to the flexible display while the housing is fully folded.

According to an embodiment, the first control signal may include a first control signal part that corresponds to a first serial communication having a first speed and a second control signal part that corresponds to a second serial communication having a second speed different from the first speed, and the third control signal may include a third control signal part that corresponds to the first serial communication and a fourth control signal part that corresponds to the second serial communication, the first aggregator circuit 110_ag or the second aggregator circuit 120_ag may be configured to transmit the second control signal through the portion of the FPCB (e.g., the FPCB 100_fb of FIG. 4) at a third speed faster than the first speed and the second speed.

According to an embodiment, each of the first serial communication and the second serial communication may include an inter-integrated circuit (I2C), an improved inter-integrated circuit (I3C), an inter-IC sound (I2S), a serial peripheral interface (SPI), or a general purpose input/output (GPIO).

According to an embodiment of the disclosure as described above, a foldable electronic device (e.g., 1112 to 1119) may include a housing that includes a first housing part (e.g., a first housing 110), a second housing part (e.g., a second housing 120), a third housing part (e.g., a third housing 130), a first hinge housing part (e.g., the first hinge housing 151) that is disposed at least partially between the first housing part and the second housing part, and a second hinge housing part (e.g., the second hinge housing 152) that is disposed at least partially between the second housing part and the third housing part, a first hinge assembly (e.g., the first hinge device 140) that is accommodated at least partially in the first hinge housing part and that rotatably connects the first housing part and the second housing part, a second hinge assembly (e.g., a second hinge device or the third hinge device 140-2 of FIG. 8) that is accommodated at least partially in the second hinge housing part and that rotatably connects the second housing part and the third housing part, a flexible display (e.g., the first display 160 of FIG. 3) that is accommodated in the first housing part, the second housing part, and the third housing part and that is folded or unfolded in response to folding or unfolding of the housing, the processor 110_ap that is accommodated in the first housing part, the first aggregator circuit 110_ag that is accommodated in the first housing part and that converts a first control signal input from the processor through a first number of ports into a second control signal that is output through a second number of ports smaller than the first number of ports, a second aggregator circuit (e.g., the aggregator circuit 130_ag of FIG. 8) that is accommodated in the third housing part and that receives the second control signal through a third number of ports and that converts the second control signal into a third control signal that is output through a fourth number of ports greater than the third number of ports, and a connection structure that is connected to the first aggregator circuit and the second aggregator circuit, the connection structure may include a first flexible printed circuit board (FPCB) part (e.g., the first flexible board 100_fb1) that is coupled at least partially to the first hinge assembly or that is accommodated at least partially in the first hinge housing part, and a second FPCB part (e.g., the second flexible board 100_fb2) that is coupled at least partially to the second hinge assembly or that is accommodated at least partially in the second hinge housing part and that transmits the second control signal.

According to an embodiment, the foldable electronic device (at least one of 1111 to 1119) may further include a first printed circuit board (PCB) 110_p that is accommodated in the first housing part and that is connected to a first connector (e.g., the connector 110_co1 of FIG. 9 or FIG. 14) that is disposed at a first end of the first FPCB part, and a second PCB (e.g., the PCB 130_p of FIG. 9 or FIG. 14) that is accommodated in the third housing part and that is connected to a second connector (e.g., the connector 110_co4 of FIG. 9 or FIG. 14) that is disposed at a second end of the second FPCB part, the processor 110_ap and the first aggregator circuit 110_ag are disposed on the first PCB 110_p, and the second aggregator circuit (e.g., the aggregator circuit 130_ag of FIG. 9) may be disposed on the second PCB (e.g., the PCB 130_p of FIG. 9).

According to an embodiment, the foldable electronic device (at least one of 1111 to 1119) may further include a third aggregator circuit (e.g., the aggregator circuit 121_ag of FIG. 10) that is accommodated in the second housing part 120 and that receives at least a portion of the second control signal through a fifth number of ports and that converts the at least portion of the second control signal into a fourth control signal that is output through a sixth number of ports greater than the fifth number of ports.

According to an embodiment, the foldable electronic device (at least one of 1111 to 1119) may further include a third PCB 121_p that is accommodated in the second housing part 120 and that is connected to a third connector (e.g., the connector 100_co2 of FIG. 9 or FIG. 14) that is disposed at a third end opposite to the first end of the first FPCB part 100_fb1 and to a fourth connector (e.g., the connector 100_co3 of FIG. 9 or FIG. 14) that is disposed at a fourth end opposite to the second end of the second FPCB part 100_fb2, the third aggregator circuit 121_ag of FIG. 10 may be disposed on the third PCB (e.g., the PCB 121_p of FIG. 10).

According to an embodiment, the third aggregator circuit (e.g., the aggregator circuit 121_ag of FIG. 10) is electrically connected to at least one component (or electronic component) that is accommodated in the second housing part and that transmits the fourth control signal, each at least one component may include a sensor module, a PMIC, an audio module, a display control circuit, or a touch control module.

According to an embodiment, the third PCB (e.g., the PCB 121_p of FIG. 10) may include a first group of signal lines that is connected between the third connector (e.g., the connector 100_co2 of FIG. 9) and the fourth connector (e.g., the connector 100_co3 of FIG. 9), and a second group of signal lines that is connected between the third connector (e.g., the connector 100_co2 of FIG. 9) and the third aggregator circuit (e.g., the aggregator circuit 121_ag of FIG. 10).

According to an embodiment, the third PCB (e.g., the PCB 121_p of FIG. 10) may include a plurality of signal lines that connect the third connector (e.g., the connector 100_co2 of FIG. 9) and the fourth connector (e.g., the connector 100_co3 of FIG. 9), and a plurality of signal lines that connect the third connector (e.g., the connector 100_co2 of FIG. 9) and the third aggregator circuit (e.g., the aggregator circuit 121_ag of FIG. 10).

According to an embodiment, the third PCB (e.g., the PCB 121_p of FIG. 12) may include signal lines that are connected from the third connector (e.g., the connector 100_co2 of FIG. 9) through the third aggregator circuit (e.g., the aggregator circuit 121_ag of FIG. 12) to the fourth connector (e.g., the connector 100_co3 of FIG. 9), and the third aggregator circuit (e.g., the aggregator circuit 121_ag of FIG. 12) may be configured to, when all of the second control signal is related to at least one component (e.g., at least one of the electronic components 130_pe1, 130_pe2, 130_pe3, 130_pe4, 130_pe5, and 130_pe6 of FIG. 12) that is accommodated in the third housing part 130, transmit the second control signal to the fourth connector (e.g., the connector 100_co3 of FIG. 9) without transmitting the second control signal to another component (e.g., at least one of the electronic components 121_pe1, 121_pe2, and 121_pe3 of FIG. 12) that is accommodated in the second housing part 120.

According to an embodiment, the processor 110_ap may be configured to disable or operate, in a low power mode, at least one of the second aggregator circuit (e.g., the aggregator circuit 130_ag of FIG. 12) or the third aggregator circuit (e.g., the aggregator circuit 121_ag of FIG. 12) at least temporarily while the housing is fully folded.

According to an embodiment, the processor 110_ap may be configured to disable, at least temporarily, a portion of the second aggregator circuit (e.g., the aggregator circuit 130_ag of FIG. 12) or the third aggregator circuit (e.g., the aggregator circuit 121_ag of FIG. 12) that is connected to a touch control module that processes a touch input to the flexible display while the housing is fully folded.

According to an embodiment, the first FPCB part (e.g., the FPCB part 100_fb1 of FIG. 8) and the second FPCB part (e.g., the FPCB part 100_fb2 of FIG. 8) may constitute a single FPCB.

According to an embodiment, the first control signal may include a first control signal part that corresponds to a first serial communication having a first speed and a second control signal part that corresponds to a second serial communication having a second speed different from the first speed, and the third control signal may include a third control signal part that corresponds to the first serial communication and a fourth control signal part that corresponds to the second serial communication, the first aggregator circuit (e.g., the aggregator circuit 110_ag of FIG. 8) or the second aggregator circuit (e.g., the aggregator circuit 130_ag of FIG. 8) may be configured to transmit the second control signal through the portion of the FPCB at a third speed faster than the first speed and the second speed.

According to the above-described embodiment, the foldable electronic device 100 may include a first housing 110, a second housing 120, a hinge device 140 that connects the housings, a first printed circuit board (PCB) 110_p that is disposed in the first housing, a second PCB 120_p or 121_p that is disposed in the second housing, a flexible board 100_bf that connects the PCBs 110_p and 120_p, the processor 110_ap and the first aggregator circuit 110_ag that are disposed on the first PCB 110_p, a second aggregator circuit 120_ag that is disposed on the second PCB 120_p, and a plurality of electronic components 120_pe1 to 120_pe6, the first PCB 110_p may include a first circuit line 110_se that connects the processor and the first aggregator circuit (or the first aggregator), and a first board line 110_s1 that connects the processor and the flexible board, and the processor 110_ap may be configured to transmit N multiple input/output control signals related to operations of the plurality of electronic components to the first aggregator circuit through the first circuit line 110_se, and the first aggregator circuit may be configured to convert the signals into M serialized signals and to transmit the serialized signals to the second aggregator circuit (or the second aggregator) through the flexible board, a speed of a signal that is transmitted through the first board line may be faster than a speed of a signal that is transmitted through the circuit line.

According to an embodiment, the flexible board may include a first line part that is connected to the first board line and a second line part that is connected to the first circuit line, and a speed of a signal that is transmitted through the first line part may be faster than a speed of a signal that is transmitted through the second line part.

According to an embodiment, a number of signal lines of the first board line and a number of signal lines of the first line part may be the same, and a number of signal lines of the first circuit line may be smaller than a number of signal lines of the second line part.

According to an embodiment, the multiple input/output control signals may include input/output control signals of different communication methods (or different types).

Effects obtained in the disclosure are not limited to the above-mentioned effects, and other effects that are not mentioned will be clearly understood by those skilled in the art, to which the disclosure belongs, from the following description.

The electronic device according to various embodiments disclosed in the disclosure may be various types of devices. The electronic device may include, for example, a portable communication device (e.g., a smartphone), a computer device, a portable multimedia device, a mobile medical appliance, a camera, a wearable device, or a home appliance. An electronic device according to an embodiment of the disclosure may not be limited to the above-described electronic devices.

Various embodiments of the disclosure and terms used herein are not intended to limit the technical features described in the disclosure to specific embodiments, and it should be understood that the embodiments and the terms include modification, equivalent, or alternative on the corresponding embodiments described herein. With regard to description of drawings, similar or related components may be marked by similar reference marks/numerals. In the disclosure, the expressions “A or B”, “at least one of A and B”, “at least one of A or B”, “A, B, or C”, “at least one of A, B, and C”, and “at least one of A, B, or C” may include any and all combinations of one or more of the associated listed items. The terms, such as “first” or “second” may be used to simply distinguish the corresponding component from the other component, but do not limit the corresponding components in other aspects (e.g., importance or order). When a component (e.g., a first component) is referred to as being “coupled with/to” or “connected to” another component (e.g., a second component) with or without the term of “operatively” or “communicatively”, it may mean that a component is connectable to the other component, directly (e.g., by wire), wirelessly, or through the third component.

In various embodiments of the disclosure, the term “module” used herein may include a unit, which is implemented with hardware, software, or firmware, and may be interchangeably used with the terms “logic”, “logical block”, “part”, or “circuit”. The “module” may be a minimum unit of an integrated part or may be a minimum unit of the part for performing one or more functions or a part thereof. For example, according to an embodiment, the module may be implemented in the form of an application-specific integrated circuit (ASIC).

According to various embodiments, each component (e.g., a module or a program) of the above-described components may include a single entity or a plurality of entities, and some of the plurality of objects may be separately arranged on other components. According to various embodiments, one or more components of the above-described components or operations may be omitted, or one or more other components or operations may be added. Alternatively or additionally, a plurality of components (e.g., a module or a program) may be integrated into one component. In this case, the integrated component may perform one or more functions of each component of the plurality of components in the manner same as or similar to being performed by the corresponding component of the plurality of components prior to the integration. According to various embodiments, operations executed by modules, programs, or other components may be executed by a successive method, a parallel method, a repeated method, or a heuristic method. Alternatively, at least one or more of the operations may be executed in another order or may be omitted, or one or more operations may be added.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A foldable electronic device comprising:
a housing including a first housing part, a second housing part, and a hinge housing part disposed at least partially between the first housing part and the second housing part;
a hinge assembly accommodated at least partially in the hinge housing part and rotatably connecting the first housing part and the second housing part;
a flexible display accommodated in the first housing part and the second housing part and configured to be folded or unfolded in response to folding or unfolding of the housing;
a processor accommodated in the first housing part;
a first aggregator circuit accommodated in the first housing part and configured to convert a first control signal input from the processor through a first number of ports into a second control signal output through a second number of ports smaller than the first number of ports;
a second aggregator circuit accommodated in the second housing part and configured to receive the second control signal through the second number of ports and convert the second control signal into a third control signal output through a third number of ports greater than the second number of ports; and
a flexible printed circuit board (FPCB) connected to the first aggregator circuit and the second aggregator circuit, wherein a portion of the FPCB is coupled at least partially to the hinge assembly or accommodated at least partially in the hinge housing part and configured to transmit the second control signal.

2. The foldable electronic device of claim 1, further comprising:
a first printed circuit board (PCB) accommodated in the first housing part and connected to a first connector disposed at a first end of the FPCB; and
a second PCB accommodated in the second housing part and connected to a second connector disposed at a second end of the FPCB,
wherein the processor and the first aggregator circuit are disposed on the first PCB, and
wherein the second aggregator circuit is disposed on the second PCB.

3. The foldable electronic device of claim 2, wherein the processor and the first aggregator circuit constitute a single chipset.

4. The foldable electronic device of claim 1,
wherein the second aggregator circuit is electrically connected to a plurality of components accommodated in the second housing part and configured to transmit the third control signal, and
wherein each of the plurality of components includes a sensor module, a power management integrated circuitry (PMIC), an audio module, a display control circuit, or a touch control module.

5. The foldable electronic device of claim 4, further comprising:
another FPCB electrically connected between the processor and at least one of the plurality of components, and coupled at least partially to the hinge assembly or accommodated at least partially in the hinge housing part,
wherein the processor is configured to transmit a payload related to at least one component to the at least one component through the other FPCB.

6. The foldable electronic device of claim 1, wherein the processor is configured to disable, at least temporarily, a portion of the second aggregator circuit connected to a touch control module configured to process a touch input to the flexible display while the housing is fully folded.

7. The foldable electronic device of claim 1,
wherein the first control signal includes a first control signal part corresponding to a first serial communication having a first speed and a second control signal part corresponding to a second serial communication having a second speed different from the first speed,
wherein the third control signal includes a third control signal part corresponding to the first serial communication and a fourth control signal part corresponding to the second serial communication, and
wherein the first aggregator circuit or the second aggregator circuit is configured to transmit the second control signal through the portion of the FPCB at a third speed faster than the first speed and the second speed.

8. The foldable electronic device of claim 7, wherein each of the first serial communication and the second serial communication includes an inter-integrated circuit, an improved inter-integrated circuit, an inter-IC sound, a serial peripheral interface, or a general purpose input/output.

9. A foldable electronic device comprising:
a housing including a first housing part, a second housing part, a third housing part, a first hinge housing part disposed at least partially between the first housing part and the second housing part, and a second hinge housing part disposed at least partially between the second housing part and the third housing part;
a first hinge assembly accommodated at least partially in the first hinge housing part and rotatably connecting the first housing part and the second housing part;
a second hinge assembly accommodated at least partially in the second hinge housing part and rotatably connecting the second housing part and the third housing part;
a flexible display accommodated in the first housing part, the second housing part, and the third housing part and configured to be folded or unfolded in response to folding or unfolding of the housing;
a processor accommodated in the first housing part;
a first aggregator circuit accommodated in the first housing part and configured to convert a first control signal input from the processor through a first number of ports into a second control signal output through a second number of ports smaller than the first number of ports;
a second aggregator circuit accommodated in the third housing part and configured to receive the second control signal through a third number of ports and convert the second control signal into a third control signal output through a fourth number of ports greater than the third number of ports; and
a connection structure connected to the first aggregator circuit and the second aggregator circuit, wherein the connection structure includes a first flexible printed circuit board (FPCB) part coupled at least partially to the first hinge assembly or accommodated at least partially in the first hinge housing part, and a second FPCB part coupled at least partially to the second hinge assembly or accommodated at least partially in the second hinge housing part and configured to transmit the second control signal.

10. The foldable electronic device of claim 9, further comprising:
a first printed circuit board (PCB) accommodated in the first housing part and connected to a first connector disposed at a first end of the first FPCB part; and
a second PCB accommodated in the third housing part and connected to a second connector disposed at a second end of the second FPCB part,
wherein the processor and the first aggregator circuit are disposed on the first PCB, and
wherein the second aggregator circuit is disposed on the second PCB.

11. The foldable electronic device of claim 9, further comprising:
a third aggregator circuit accommodated in the second housing part and configured to receive at least a portion of the second control signal through a fifth number of ports and convert the at least the portion of the second control signal into a fourth control signal output through a sixth number of ports greater than the fifth number of ports.

12. The foldable electronic device of claim 11, further comprising:
a third PCB accommodated in the second housing part and connected to a third connector disposed at a third end opposite to the first end of the first FPCB part and a fourth connector disposed at a fourth end opposite to the second end of the second FPCB part,
wherein the third aggregator circuit is disposed on the third PCB.

13. The foldable electronic device of claim 12,
wherein the third aggregator circuit is electrically connected to at least one component accommodated in the second housing part and configured to transmit the fourth control signal, and
wherein the at least one component includes a sensor module, a power management integrated circuitry (PMIC), an audio module, a display control circuit, or a touch control module.

14. The foldable electronic device of claim 12, wherein the third PCB includes a first group of signal lines connected between the third connector and the fourth connector, and a second group of signal lines connected between the third connector and the third aggregator circuit.

15. The foldable electronic device of claim 12, wherein the third PCB includes a plurality of signal lines connecting the third connector and the fourth connector, and a plurality of signal lines connecting the third connector and the third aggregator circuit.

16. The foldable electronic device of claim 12,
wherein the third PCB includes signal lines connected from the third connector through the third aggregator circuit to the fourth connector, and
wherein the third aggregator circuit is configured to, when all of the second control signal is related to at least one component accommodated in the third housing part, transmit the second control signal to the fourth connector without transmitting the second control signal to another component accommodated in the second housing part.

17. The foldable electronic device of claim 12, wherein the processor is configured to disable or operate, in a low power mode, at least one of the second aggregator circuit or the third aggregator circuit at least temporarily while the housing is fully folded.

18. The foldable electronic device of claim 12, wherein the processor is configured to disable, at least temporarily, a portion of the second aggregator circuit or the third aggregator circuit connected to a touch control module configured to process a touch input to the flexible display while the housing is fully folded.

19. The foldable electronic device of claim 9, wherein the first FPCB part and the second FPCB part constitute a single FPCB.

20. The foldable electronic device of claim 9,
wherein the first control signal includes a first control signal part corresponding to a first serial communication having a first speed and a second control signal part corresponding to a second serial communication having a second speed different from the first speed,
wherein the third control signal includes a third control signal part corresponding to the first serial communication and a fourth control signal part corresponding to the second serial communication, and
wherein the first aggregator circuit or the second aggregator circuit is configured to transmit the second control signal through a portion of the FPCB at a third speed faster than the first speed and the second speed.
